(19) United States
(12) Patent Application Publication
(10) Pub. No.: US 2011/0029440 A1
(43) Pub. Date: Feb. 3, 2011

(54) Approach for Managing Project Schedule Data in a Project Management System

(76) Inventors: Tetsuro Motoyama, Cupertino, CA (US); Avery Fong, Castro Valley, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/534,820

(22) Filed: Aug. 3, 2009

(51) Int. Cl. G06Q 10/00

(52) U.S. Cl. 705/301

(57) ABSTRACT

A project management system manages project schedule data using project task state data. The project task state data indicates the current state of project tasks and is used to determine which project tasks are to be included in a member schedule editor, member schedule reports and inspection reports. The project management system also provides support for various inspection functionality. The project management system also provides for the use of cache files to improve system performance. Cache files are used to store information for incomplete project tasks that is retrieved when member editor sessions are initiated. The project management system also uses “to do list” tasks to conspicuously identify assigned, but unscheduled, tasks to users and also provides for the restoration of meeting information in the event of database failures or file write failures.

### CROSS REFERENCE TO RELATED APPLICATIONS

This application is related to co-pending U.S. patent application Ser. No. 12/122,392, filed May 16, 2008, Attorney Docket No. 49986-0654, entitled “Managing Project Schedule Data Using Separate Current And Historical Task Schedule Data”; U.S. patent application Ser. No. 12/122,442, filed May 16, 2008, Attorney Docket No. 49986-0655, entitled “Managing Project Schedule Data Using Separate Current And Historical Task Schedule Data And Revision Numbers”; co-pending U.S. patent application Ser. No. 12/122,497 filed May 16, 2008, Attorney Docket No. 49986-0656, entitled “To-Do List Representation In The Database Of A Project Management System”; co-pending U.S. patent application Ser. No. 12/122,514 filed May 16, 2008, Attorney Docket No. 49986-0657, entitled “Managing To-Do Lists In Task Schedules In A Project Management System”; co-pending U.S. patent application Ser. No. 12/122,533 filed May 16, 2008, Attorney Docket No. 49986-0658, entitled “Managing To-Do Lists In A Schedule Editor In A Project Management System”; U.S. patent application Ser. No. 12/211,286, filed Sep. 16, 2008, Attorney Docket No. 49986-0674, entitled “Managing Project Schedule Data Using Project Task State Data”, the contents of all of which are hereby incorporated by reference for all purposes as if fully set forth herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present application relates generally to project management. The application relates more specifically to managing project schedule data in a project management system.

### BACKGROUND

Computer-implemented project management tools have evolved into sophisticated systems that allow very large projects with many tasks to be managed effectively. Some tools allow designation of a so called “critical path” that identifies a task or set of tasks that must be completed before other tasks can be started. Knowing which tasks must be completed before other tasks can be started helps business organizations allocate resources on a project. When dates are changed in the project, the schedules are automatically updated based upon dependencies between tasks. For example, suppose that task A is on the critical path and tasks B and C cannot be started until task A is completed. If the projected end date of task A is changed, then the projected start dates of tasks B and C are automatically updated by the project management tool to reflect the change made to the projected end date of task A. One of the problems with conventional project management systems is that they tend to accumulate a large amount of historical data. For example, in some situations, changing a single date on a task can cause changes in a large number of dates for other tasks. This is particularly true in situations where, because of dependencies, changes in dates cause a large number of other dates to change because of cascade effects. Conventional project management systems store both current and historical date information. One consequence of this is that as the amount of historical data grows, queries against the schedule data become more complex and computationally expensive to process. Another issue with conventional project management systems is that the user interfaces are often focused on project tasks that have been scheduled and little attention is given to tasks that have not yet been scheduled.

### SUMMARY

A project management system manages project schedule data using project task state data. The project task state data indicates the current state of project tasks and is used to determine which project tasks are to be included in a member schedule editor, member schedule reports and inspection reports. The project management system also provides support for various inspection functionality. This includes, for example, identifying and naming inspection material for use in inspection meeting forms and inspection meeting documents. The inspection functionality also includes generating an inspection index and an inspection statistics report.

According to one aspect of the invention, an approach is provided for managing project schedule data. According to the approach, schedule data is generated and stored in a project schedule database for a plurality of project tasks in a project. State data is generated and stored in association with the schedule data in the project schedule database. The state data is separate from the schedule data and indicates a current state of each of the plurality of project tasks. A current state of a project task may include one of the project task is completed, the project task has been started but is not completed, the project task is planned but not started, only a start date is specified for the project task and the project task is unscheduled. The state data may be used, for example, to retrieve particular schedule data from the database, i.e., schedule data for project tasks having a particular state. The state data may also be used to arrange schedule data in editors, forms and reports to improve the user experience.

According to another aspect of the invention, another approach is provided for managing project schedule data. According to this approach, schedule data is generated and stored in a project schedule database for a plurality of project tasks in a project. State data is generated and stored in association with the schedule data in the project schedule database. The state data is separate from the schedule data and indicates a current state of each of the plurality of project tasks. A current state of a project task may include one of the project task is completed, the project task has been started but is not completed, the project task is planned but not started, only a start date is specified for the project task and the project task is unscheduled. In response to a request to perform an inspection, inspection material is retrieved from the project schedule database. The inspection material includes schedule data for one or more project tasks that both, based upon the corresponding state data, have a state of started but not completed, planned but not started or have only a start date specified and do not have any child project tasks. According to another aspect of the invention, the inspection material further includes schedule data for a particular project task that, based upon the corresponding state data, has a state of started but not completed, planned but not started or has only a start date specified and has at least one child project task that is a review, test or inspection project task. Identification data may also be generated and included in the inspection material in association with the schedule data for the particular project task. The identification data identifies the particular project task and the child project task for the particular project task.

According to another aspect of the invention, an approach is provided for managing inspections in a project management system. According to this approach, schedule data is generated and stored in a project schedule database for a plurality of project tasks in a project. State data is generated and stored in association with the schedule data in the project schedule database. The state data is separate from the schedule data and indicates a current state of each of the plurality of project tasks. A current state of a project task may include one of the project task is completed, the project task has been started but is not completed, the project task is planned but not started, only a start date is specified for the project task and the project task is unscheduled. In response to a request to perform an inspection, one or more project tasks are identified that qualify for inspection based upon the state data associated with the one or more project tasks indicating that each of the one or more projects tasks has been scheduled but not yet completed. A plurality of inspection materials associated with the one or more project tasks are identified and an inspection meeting form is generated. The inspection meeting form identifies the plurality of inspection materials and allows a user to enter information about defects in the plurality of inspection materials. The approach may also include generating inspection meeting documents, an inspection index and an inspection statistics Web page.

According to one embodiment of the invention, cache files are used to improve the performance of the project management system. When a user concludes a member schedule editor session, information specified for one or more incomplete project tasks is stored in one or more cache files, in addition to being stored in the regular database. When a subsequent member schedule editor session is initiated, the information specified for the one or more incomplete project tasks is retrieved from the one or more cache files and displayed in the member schedule editor. Cache files may also be used with a task assignment editor. When a user concludes a task assignment editor session, information specified for one or more incomplete project tasks and one or more newly added tasks is stored in one or more cache files, in addition to being stored in the regular database. When a subsequent member schedule editor session is initiated, the information specified for the one or more incomplete project tasks is retrieved from the one or more cache files and displayed in the member schedule editor.

According to another aspect of the invention, new tasks assigned to a member during a task assignment editor session are identified as “to do list” tasks. During subsequent member schedule editor sessions, the “to do list” tasks are identified by the member schedule editor as “to do list” tasks. According to another aspect of the invention, the member schedule editor is configured to now allow “to do list” tasks to be deleted and the task assignment editor is configured to allow “to do list” tasks to be deleted.

According to another aspect of the invention, inspection information entered via an inspection meeting form is maintained separate from a database that stores inspection information by emailing the inspection information to a specified address. This allows restoration of the inspection information in the event of a failure of the database.

### BRIEF DESCRIPTION OF THE DRAWINGS

In the drawings:

FIG. 1A is a screenshot of a task assignment editor.

FIG. 1B is a screenshot of a sample of a task assignment Web page.

FIG. 2A is a screenshot of a project schedule editor.

FIG. 2B is a screenshot of a sample of a project schedule Web page.

FIG. 3A is a screenshot of a member schedule editor.

FIG. 3B is a screenshot of a sample of a member's schedule Web page.

FIG. 4 is a screenshot of a login Web page for a project member to log on to one of the editors (task assignment, project schedule, member schedule).

FIG. 5 is a diagram illustrating an operating environment in which an embodiment of the invention may be implemented.

FIG. 6 is a diagram illustrating a communications architecture in which an embodiment of the invention may be implemented, including software components of an automated scheduling and meeting system.

FIG. 7 is a diagram illustrating interfaces between the client processor and the server processor of the system.

FIG. 8 depicts a sequence diagram for a project member or manager to use the login Web page to log onto one of the task editors or one of the meeting forms (inspection and other forms). FIG. 8 also depicts the sequences involved in displaying the Web page for the task editor or meeting form, interacting with the task editor or meeting form by a user and completing the session, posting the information in the task editor or meeting form into the database and generating the appropriate web pages for the task editor or meeting form.

FIG. 9 depicts a schema of database tables used to store and manage task assignment and task schedule information for projects and project members.

FIG. 10 depicts an example schema of database tables used to store and manage information about a project and the members of the project.

FIG. 11 depicts an example schema of database tables used to store information about the inspection meetings of a project.

FIG. 12 is a diagram depicting a programming package diagram of the server processor of FIG. 6.

FIG. 13 is a diagram depicting a programming package diagram of the processor packages.

FIG. 14 is a block diagram that depicts a computer system upon which embodiments of the invention can be implemented.

FIGS. 15A-15D depict example entries in the Level1MemberTask, Level3MemberTask, Level3MemberTask, and Level4MemberTask tables of the schedule database depicted in FIG. 9.

FIGS. 16A and 16B depict example entries in the ProjectInformation and MemberInformation tables of the ProjectTeam database depicted in FIG. 10.

FIGS. 17A through 17D depict sample entries in InspectionInformation, InspectorList, DocumentList, and DefectList tables of the inspection database depicted in FIG. 11.

FIGS. 18A through 18C depict example meeting login web pages.

FIG. 19 depicts an example Inspection Meeting Form.

FIG. 20 depicts an example Inspection Meeting document generated after an inspection meeting session.

FIG. 21 depicts an example Inspection Index document generated after an inspection meeting session.

FIG. 22 depicts an example Inspection Statistic Report generated after an inspection meeting session.

FIG. 23 is an example package diagram of the InspectionMeetingProcessor package.

FIG. 24 depicts an example Discussion Meeting Form.

FIG. 25 depicts an example discussion form document.

FIG. 26 depicts an example discussion index.

FIG. 27 depicts an example directory/file structure of the discussion meetings corresponding to the discussion index of FIG. 26.

FIG. 28 depicts an example directory/file structure of one of the material directories in a discussion meeting.

FIG. 29 depicts an example package diagram of the DiscussionMeetingProcessor package.

FIG. 30 depicts an example General Meeting Form.

FIG. 31 depicts an example of the general form document.

FIG. 32 depicts an example of the general yearly index.

FIG. 33 depicts an example of the general index for the year 2008.

FIG. 34 depicts the directory/file structure of the general meetings that correspond to the yearly index.

FIG. 35 depicts the directory/file structure of the general meetings corresponding to the index of year 2008.

FIG. 36 depicts an example directory/file structure of one of the material directories in the general meeting.

FIG. 37 is the package diagram of the GeneralMeetingProcessor package.

FIG. 38 depicts an example class diagram of the MeetingLoginProcessor package.

FIG. 39 depicts the New Project Setup Form that allows a user to setup the new project.

FIG. 40 depicts example components of the ProjectSetupProcessor package.

FIG. 41 is a package diagram that depicts the server package providing more detail for generating the cache file used for the member schedule editor.

FIG. 42 depicts an example algorithm executed in the web page by the web server when posting information from the task assignment editor.

FIG. 43 is a flowchart that depicts the posting of information from the task assignment editor and the project tasks being added to the schedule database.

FIG. 44 depicts an example algorithm implemented by a script executed on the web server by the system( ) function to generate the cache file containing member task information for display in the member schedule editor.

FIG. 45 is a flowchart that depicts generating the cache files when information from the task assignment editor is submitted.

FIG. 46 depicts an example package diagram for the server package that provides more detail for generating the cache file used for the member schedule editor and the member schedule web page.

FIG. 47 depicts an example algorithm that is executed in the web page by the web server when posting information from the member schedule editor.

FIG. 48 depicts an example algorithm for the script executed on the web server by the system( ) function to generate the member schedule web page.

FIG. 49 is a flowchart that depicts generating the member schedule web page and cache file when information from the member schedule editor is submitted.

FIG. 50 depicts an example algorithm for the function fglo_WriteLinesToFileWithStatusReportAndBackup( ) for generating writing lines to a file.

FIG. 51 depicts an example algorithm for the function fglo_MakeDirectoryWithNewPrefixForDuplicate( ) for generating a new directory.

FIG. 52 is a flow diagram that depicts adding inspection information into the database and generating the inspection web page when the inspection meeting form is submitted.

FIG. 53 is a flow diagram that depicts the overall generation of the inspection index.

FIG. 54 is a flow diagram that depicts the process of generating the inspection index from the existing index in more detail.

FIG. 55 is a flow diagram that depicts the process of generating the inspection index from inspection information in the database in more detail.

FIG. 56 is a flow diagram that depicts the generation and storing of an inspection meeting document.

FIG. 57 is a flow diagram that depicts the process of generating the inspection report using the database to obtain statistical information for all the inspections of a project up to the current inspection session.

FIG. 58 depicts an example display in the web browser when an inspection meeting session fails after the user submits the inspection meeting form.

FIG. 59 depicts an example email message that is sent to the document controller and administrator responsible for the web server.

FIG. 60 depicts an example email attachment, InspectionStatus.txt, that was sent to the document controller and administrator.

FIG. 61 depicts an example email attachment, InspectionForm.htm that was sent to the document controller and administrator.

FIG. 62 depicts an example class diagram for the DiscussionMeetingJavaScript package to display and manage a discussion meeting form.

FIG. 63 depicts an example class diagram of the DiscussionMeetingWebPageGenerator package to generate discussion web pages.

FIG. 64 is a flow diagram that depicts generating the discussion web page when the discussion meeting form is submitted.

FIG. 65 is a flow diagram that depicts the process of generating the discussion index from the existing index.

FIG. 66 is a flow diagram that depicts the generation and storing of the discussion form document.

FIG. 67 is a flow diagram that depicts uploading discussion material files and storing the files within the file system, where the discussion index and discussion form document can link to them.

FIG. 68 is the class diagram of the GeneralMeetingJavaScript package to display and manage a general meeting form.

FIG. 69 is the class diagram of the GeneralMeetingWebPageGenerator package to generate discussion web pages.

FIG. 70 is a flow diagram that depicts generating the general web pages when the general meeting form is submitted.

FIG. 71 is a flow diagram that depicts the process of generating the general indexes from the existing indexes.

FIG. 72 is a flow diagram that depicts the generation and storing of the general form document.

FIG. 73 is a flow diagram that depicts uploading all the general material files and storing the files within the file system where the general form document can link to them.

FIG. 74 is a flow diagram that depicts the process to log on to one of the meeting forms.

### DETAILED DESCRIPTION

A project management system manages project schedule data using project task state data. The project task state data indicates the current state of project tasks and is used to determine which project tasks are to be included in a member schedule editor and member schedule reports. The project management system also provides support for various inspection functionality. This includes, for example, identifying and naming inspection material for use in inspection meeting forms and inspection meeting documents. The inspection functionality also includes generating an inspection index and an inspection statistics report. Example embodiments of the invention are depicted in the figures and described herein in the context of a client-server based project management system. However, the approaches described herein are applicable to other types of systems and arrangements.

### Task Assignment Editor

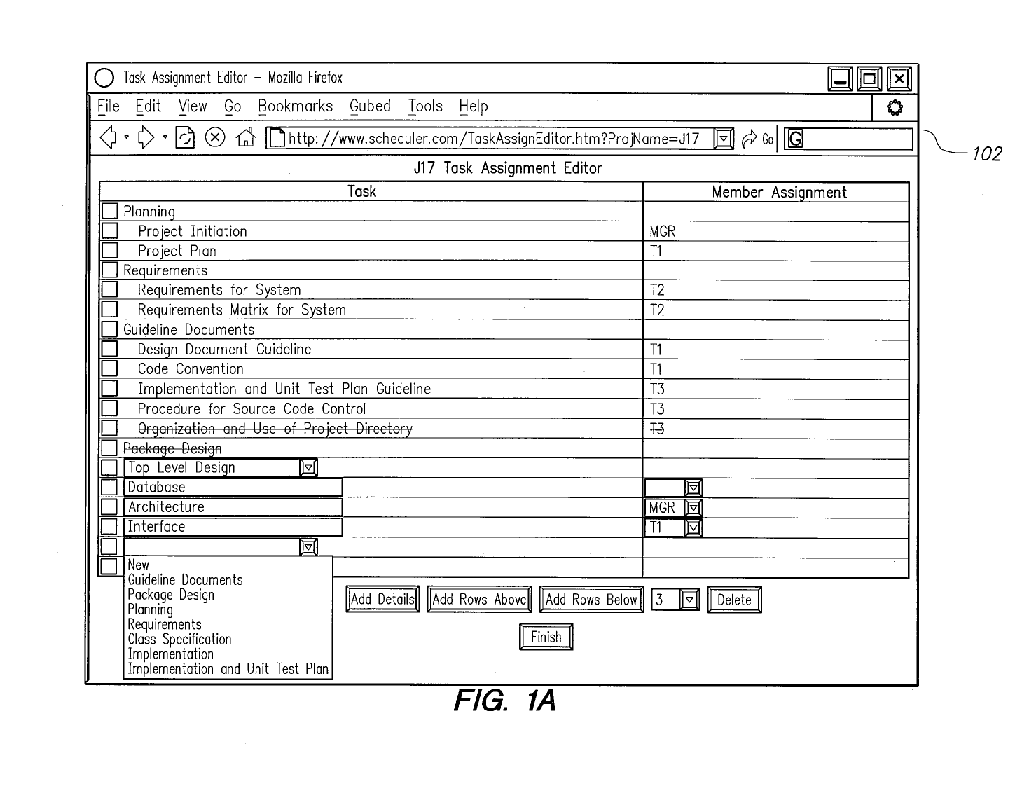

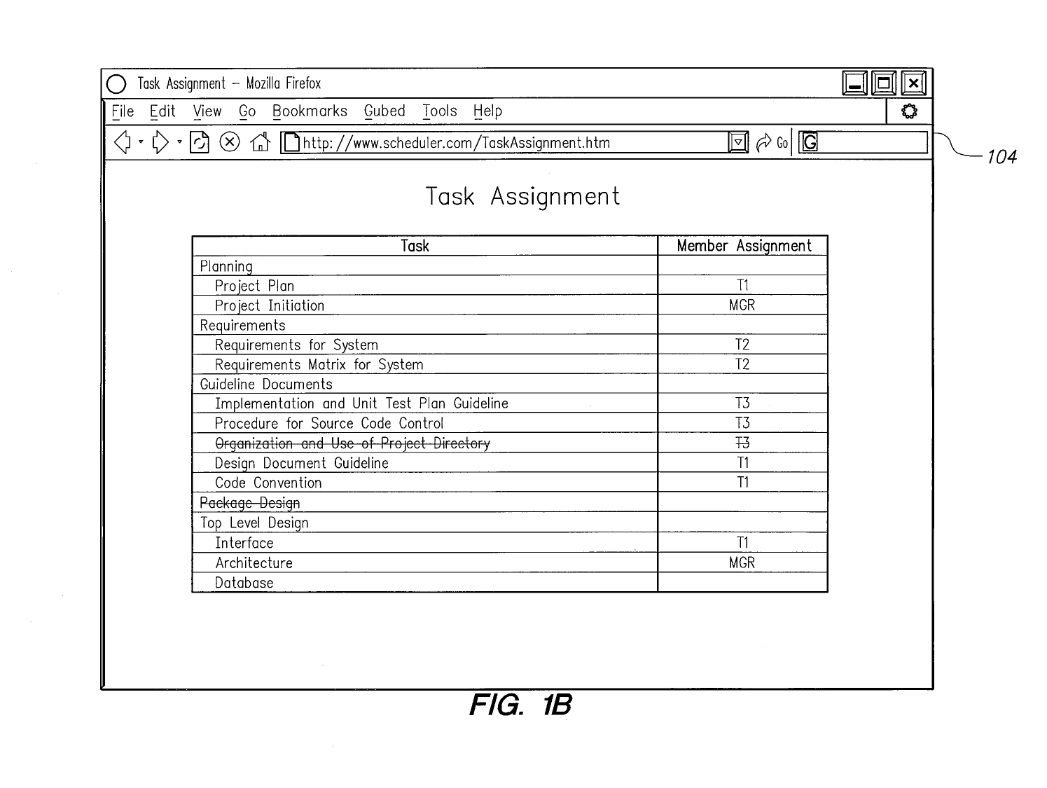

FIG. 1A is a screenshot of a task assignment editor. The task assignment editor 102 assists users in creating the project tasks that are to be completed in a project. With some organizations, there are default project tasks that are common to all projects that will be performed in association with the organization. Associated with the project tasks are subtasks which are assigned to project members. Typically, a project manager sets and assigns tasks to project members. The project manager can use this task assignment editor 102 to set up the project tasks for a project, create the subtasks for each project task, and assign the subtasks to the members. Information about the task assignment is stored and maintained in the task assignment editor 102 while the project manager is adding and assigning tasks. Upon the manager completing a session with the task assignment editor 102, the task assignment information is passed to, stored in, and maintained in a database.

In response to completion of a task assignment session, such as in response to a user selecting the “Finish” button on the task assignment editor 102 of FIG. 1A, a task assignment Web page 104 is automatically created, at the Web server, for displaying the tasks that are assigned to various project members. FIG. 1B is a screenshot of a sample of a task assignment Web page. Task and task assignment information entered and edited via the task assignment editor 102 is displayed in a form in a Web page when displayed in a Web browser. All the tasks and the assignment of tasks are stored within one or more database tables, where each row preferably corresponds to a task, and displayed in the task assignment editor 102 and the task assignment Web page 104.

According to one embodiment, the task assignment editor 102 (FIG. 1A) includes buttons (e.g., Add Details, Add Rows Above, Add Rows Below, Delete, and Finish) usable to perform various operations. The “Finish” button completes the editor session and submits the task assignment information to be stored and maintained in the database. The other buttons perform a respective operation on a task that must be selected by selecting the checkbox in the row corresponding to the task. An “Add Details” button adds rows beneath a project task so the manager can add and assign subtasks to project members. “Add Rows Above” and “Add Rows Below” buttons add rows above and below the row corresponding to the selected task (either project task or subtask) so the manager can add more project tasks or add and assign more subtasks. The number of rows added is set by a “number of rows” menu selection that is next to the “Add Rows Below” button. The “Delete” button deletes the selected task, and removes a project task from the project or removes the assignment of subtasks to a project member.

### Project Schedule Editor

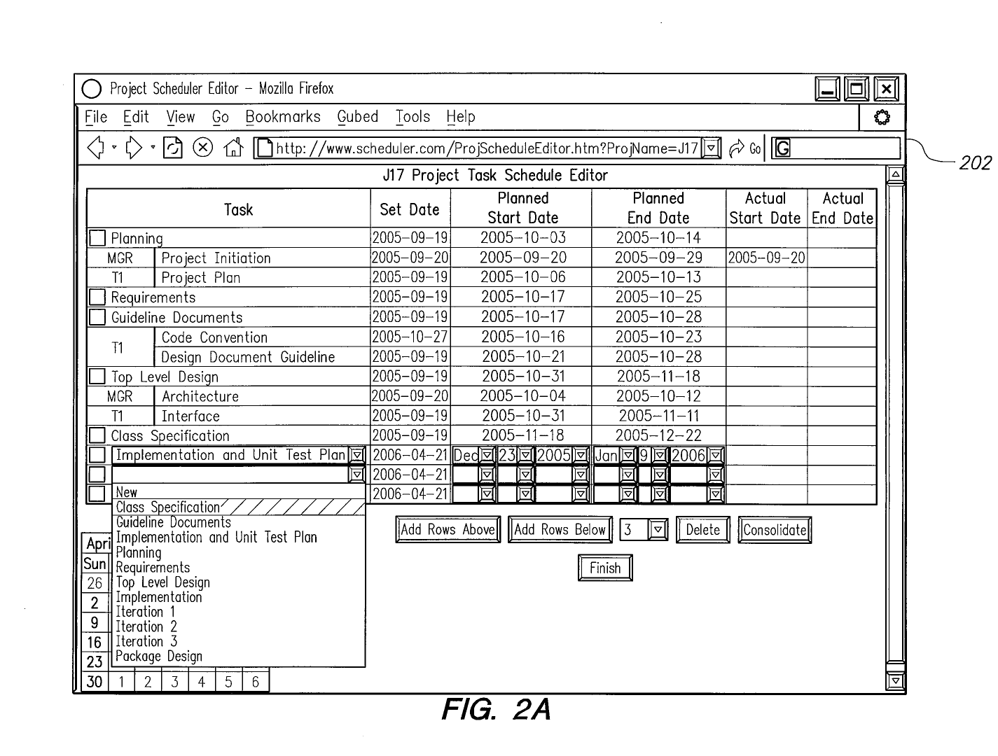

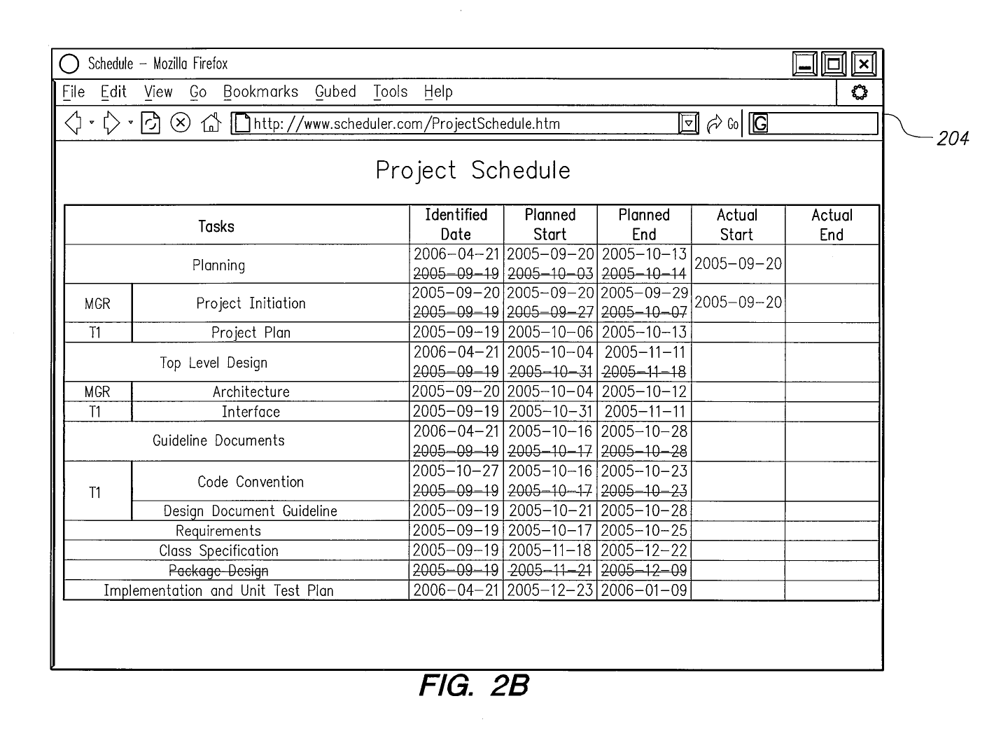

FIG. 2A is a screenshot of a project schedule editor. The project schedule editor 202 is used to set the schedule for the project tasks that are created in the task assignment editor 102 (FIG. 1A). A project task may be created and scheduled in the project schedule editor 202. However, in one embodiment, subtasks cannot be added to the project tasks to assign them to project members using the project schedule editor 202. Most likely, the project manager will use the project schedule editor 202 after the task assignment editor 102. The manager can use the project schedule editor 202 to set the initial project schedule for the major project tasks added in the task assignment editor 102. Information about the scheduling of project tasks is stored and maintained in the project schedule editor 202 while the project manager is adding and scheduling tasks. Upon the manager completing a project schedule editor session, the schedule information for the project tasks is passed, stored, and maintained in the database.

In response to completion of a project schedule session, such as in response to a user selecting the “Finish” button on the project schedule editor 202 of FIG. 2A, a project schedule Web page 204 is automatically created, at the Web server, for displaying a table for the project schedule. If the individual project members' schedules are created and/or updated for the project subtasks, the project schedule editor 202 displays each project task schedule along with all the subtask schedules. The project schedule editor 202 depicts the subtasks with the project member to whom it was assigned. By completing the editor session or by selecting “Consolidate” on the project schedule editor 202 of FIG. 2A, all the subtask schedules for each project task are automatically consolidated or aggregated to update the schedule for the project task, and the project task schedule is updated in the database.

FIG. 2B is a screenshot of a sample of a project schedule Web page. The project schedule Web page 204 is created for displaying the schedule of the project tasks and its subtasks along with the member to whom a task or subtask is assigned. The project schedule Web page 204 depicts all the previous schedules (e.g., with strikethrough of previous dates) of each project task and subtask so that the project team can see the changes that occur in the schedule of a task. Project schedule information entered and edited via the project schedule editor 202 is displayed in a form in a Web page when displayed in a Web browser. All the project tasks' schedules and the subtasks' schedules are stored within one or more database tables, where each row preferably corresponds to a task, and displayed in the project schedule editor 202 and the project schedule Web page 204.

According to one embodiment, the project schedule editor 202 (FIG. 2A) includes buttons (Add Rows Above, Add Rows Below, Delete, Consolidate, and Finish) which perform various operations. The “Finish” and “Consolidate” buttons complete the project schedule editor session and submit the project task schedule information to be stored and maintained in the database. The “Consolidate” button causes the members' schedules to be consolidated with the project schedule so that the project schedule is updated in the database. The “Consolidate” button causes the project schedule editor to be redisplayed in the project schedule Web page with updated task schedules. The other buttons perform a respective operation on a task that is selected by selecting the checkbox in the row corresponding to the task. The operations can only be performed on project tasks and not the subtasks which are assigned to members. “Add Rows Above” and “Add Rows Below” buttons add rows above and below the row corresponding to the selected project so the manager can add more project tasks and set the schedules for the tasks. The number of rows added is set by the “number of rows” menu selection that is next to the “Add Rows Below” button. The “Delete” button deletes the selected project task.

### Member Schedule Editor

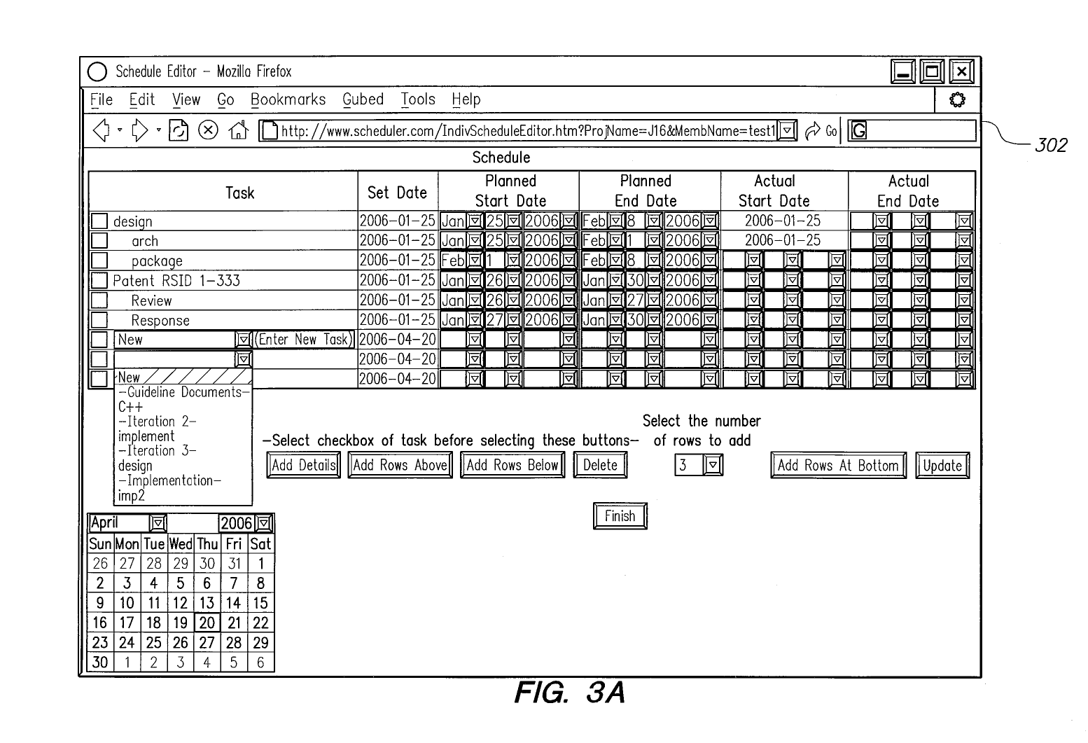

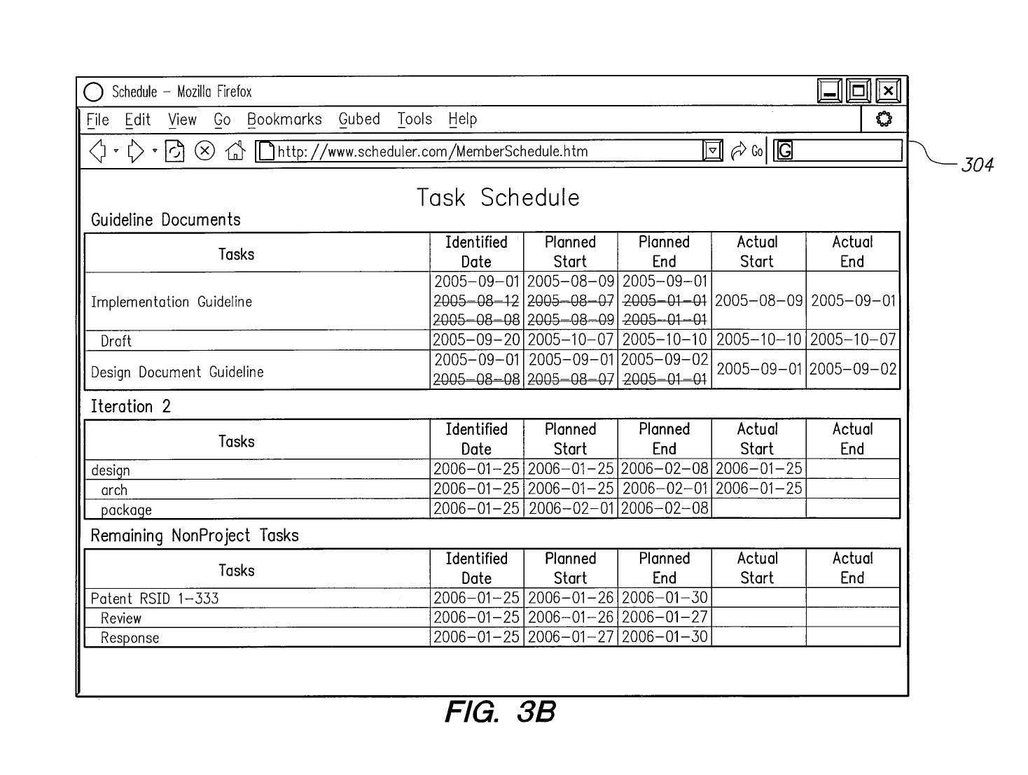

FIG. 3A is a screenshot of a member schedule editor. The member schedule editor 302 (also referred to as “individual schedule editor”) is used to create a schedule for an individual project member. According to one embodiment, the member schedule editor 302 displays only uncompleted tasks if the member schedule was previously created. The tasks of a member can be project subtasks and/or tasks unrelated to the project. The member can set the schedule, change the schedule, and update the results for a task via the member schedule editor 302. Each of the tasks of a member can be broken down into lower level tasks to schedule the minute details of the task. The addition or modification of lower level tasks may affect the schedule of the upper level task. Therefore, the upper level tasks schedules are updated when the “Update” button is selected. Information about the scheduling of tasks is stored and maintained in the member schedule editor 302 while the member is adding or modifying task schedules. Upon a member finishing a member schedule editor 302 session, the task schedule information is passed, stored, and maintained in the database. FIG. 3A depicts the assigned tasks in the drop down list.

In response to completion of a member schedule session, such as in response to a user selecting the “Finish” button on the member schedule editor 302 of FIG. 3A, a member schedule Web page 304 (labeled “Task Schedule” in the screen shot of FIG. 3B) is automatically created, at the Web server, for displaying a table for the member schedule. FIG. 3B is a screenshot of a sample of a member's schedule Web page. Individual schedule information entered and edited via the member schedule editor 302 is displayed in a form in a Web page when displayed in a Web browser. All the tasks' schedules are displayed within a table where each row corresponds to a task. The member schedule Web page 304 depicts the previous schedules (e.g., with strikethrough of previous dates) of each project task and subtask so that the project team can see the changes that occur in the schedule of a task.

In member schedule editor 302, buttons (Add Details, Add Rows At Bottom, Add Rows Above, Add Rows Below, Delete, Update, and Finish) are positioned near the table, which are used to perform various respective operations. The “Finish” button completes the member schedule editor session and submits the task schedule information to be stored and maintained in the database. Except for the “Update” button and the “Add Rows At Bottom” button, the other buttons perform an operation on a task that is selected by selecting the checkbox in the row corresponding to the task. The “Add Details” button adds rows beneath a task so the member can add subtasks (a task one level lower) to a task to give more details of the task. “Add Rows Above” and “Add Rows Below” buttons add rows above and below the row corresponding to the selected task so the member can add more tasks to the schedule at the same level. The number of rows added is set by the “number of rows” menu selection that is next to the “Add Rows Below” button. The “Delete” button deletes the selected task. The “Delete” button also removes a task, all lower level tasks associated with the task, from the member's schedule. The “Add Rows At Bottom” button adds one or more highest level rows to the bottom of the schedule where the number of rows added is set in the “number of rows” menu selection. The “Update” button updates all the upper level task schedules with the lower level task schedules and updates the display of the member schedule editor 302 to depict the new dates.

The schedule information for a task includes the plan start and end dates and the actual start and end dates. The plan and actual dates can be set and modified for tasks in the member schedule editor 302. However, only the plan dates can be set for the project tasks in the project schedule editor 202 (FIG. 2A) when the task is scheduled for the first time. The plan dates are automatically updated and the actual dates are automatically set based on the information in the members' schedule for the plan and actual dates of the project subtask, when consolidated. Though not shown, the project schedule editor 202 can be modified so that the planned dates can be changed. However, whatever changes are made in the planned dates of the project task will be overridden by the consolidation of the planned dates of the members' schedule of the project subtasks. Information in the database is used to update the actual dates of the project task when the project manager either completes a project editor session or via the “Consolidate” button of the project schedule editor 202.

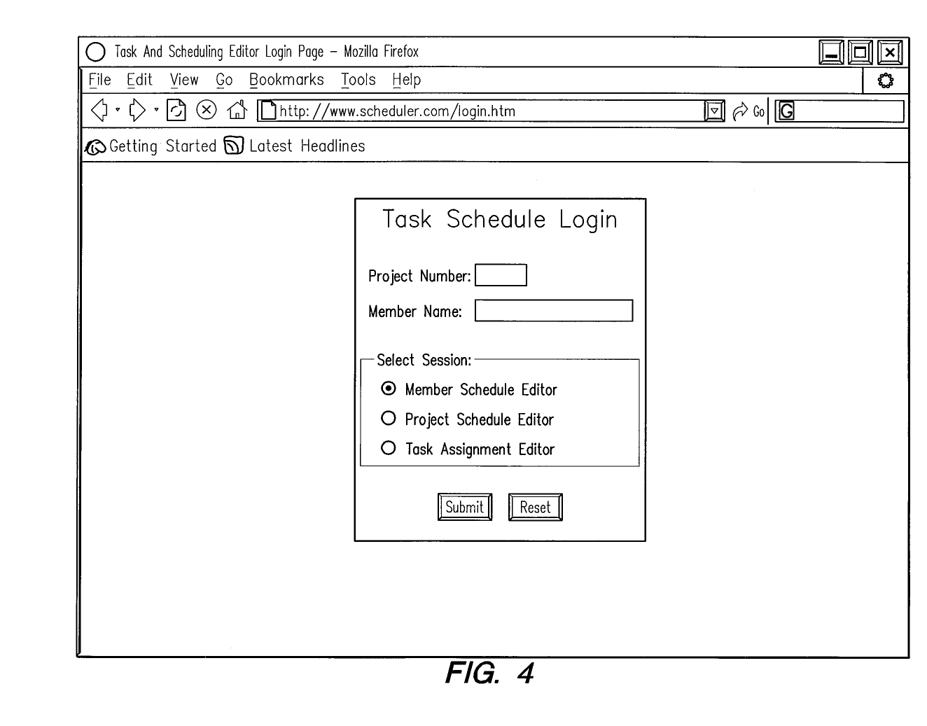

FIG. 4 is a screenshot of a login Web page for a project member to log on to one of the editors (task assignment, project schedule, member schedule). The member enters the project number, member name, and selects the appropriate editor, and then submits the information to access the editor. The project schedule management system validates the input and determines if the member is a valid member of the project and has an access right for the selected editor. If not, the member will be denied access to the editor. For tighter security, the login Web page and editors can occur over secure HTTP (e.g., HTTPS) and the login page can require a password before logging in.

### Project Schedule Management System

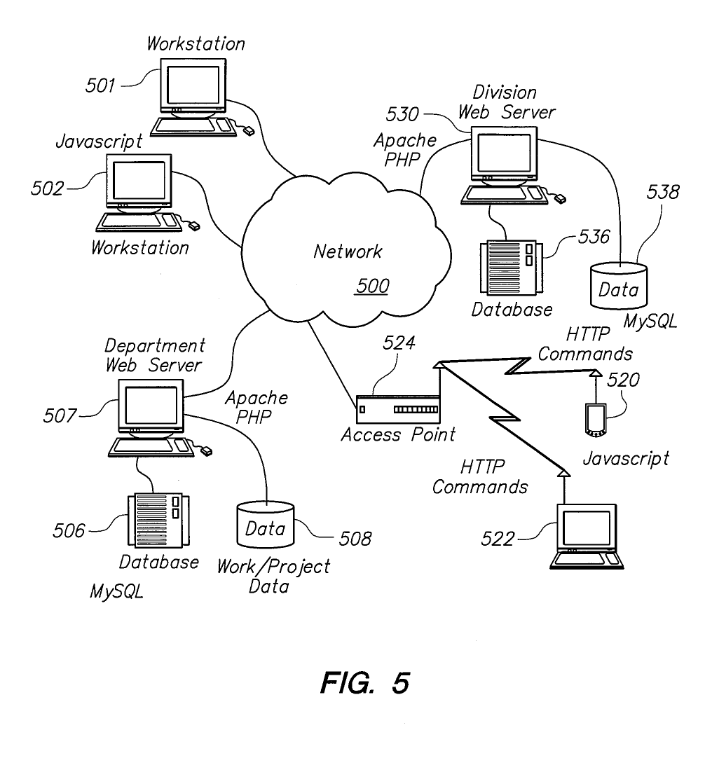

FIG. 5 is a diagram illustrating an operating environment in which an embodiment of the invention may be implemented. The illustrated operating environment is illustrative of an overall system configuration for the project schedule management system described herein. The example operating environment comprises a plurality of workstations, one or more Web servers, and one or more associated databases, which are all connected directly or indirectly to a software development network for communication.

Generally, Web servers 507 and 530 comprise the resources for the display and management of the editors and meeting forms. The Web servers 507, 530 interact with databases 506, 536, respectively, to store, maintain, and manage task assignment, task schedule information, inspection meeting information, e.g., data 508, 538. The depiction of two Web servers and two databases is for purposes of example. Thus, the number of Web servers and databases used in a project management system as described herein may vary from implementation to implementation. Web browsers on computer workstations 501, 502 access the resources on the Web servers 507, 530 to display the editors. Project members or managers can access the editors over the network 500 (LAN or WAN). The project management system can be used to manage projects at different levels within an organization, e.g., at project, department, division, and organization levels.

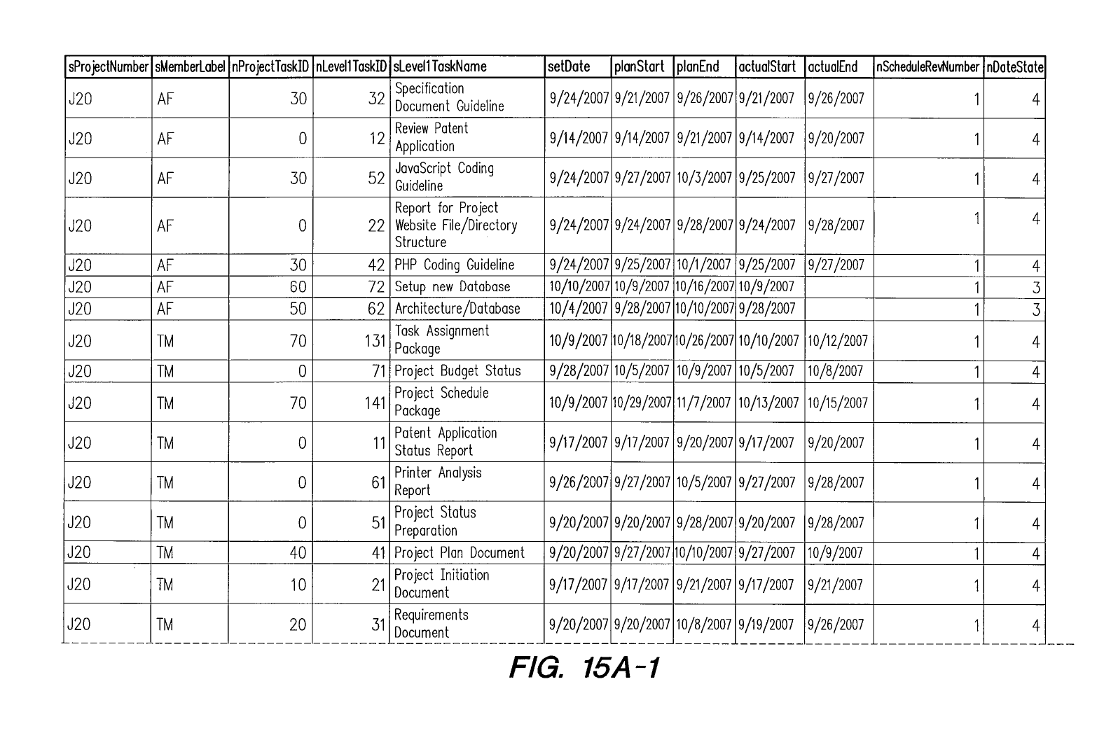

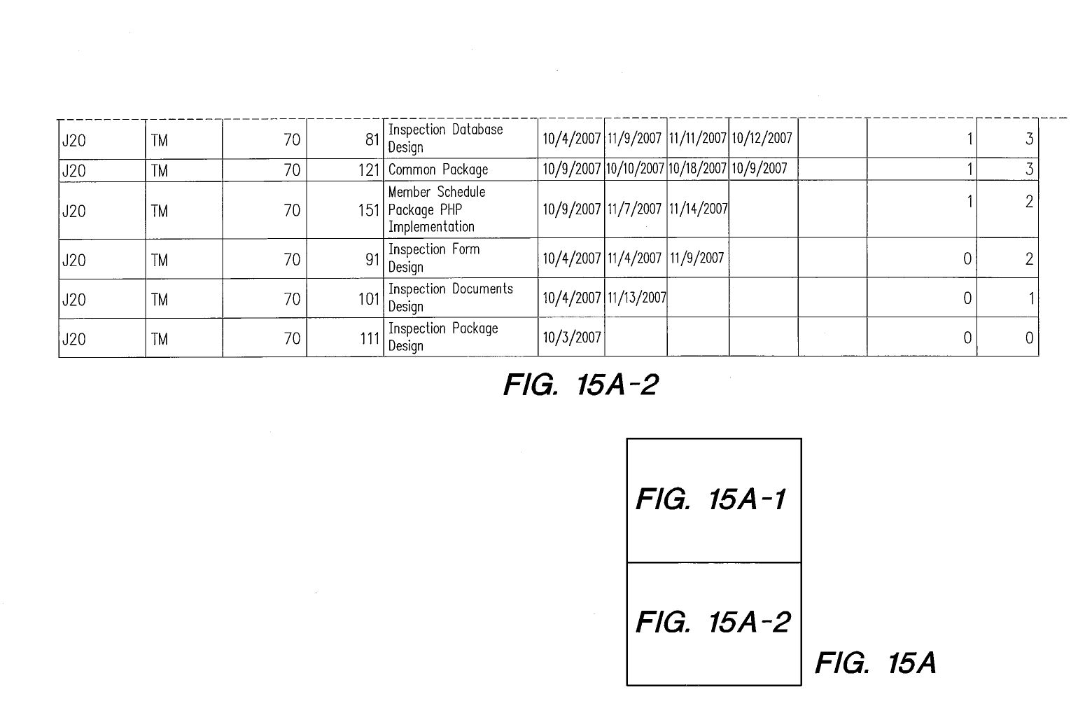

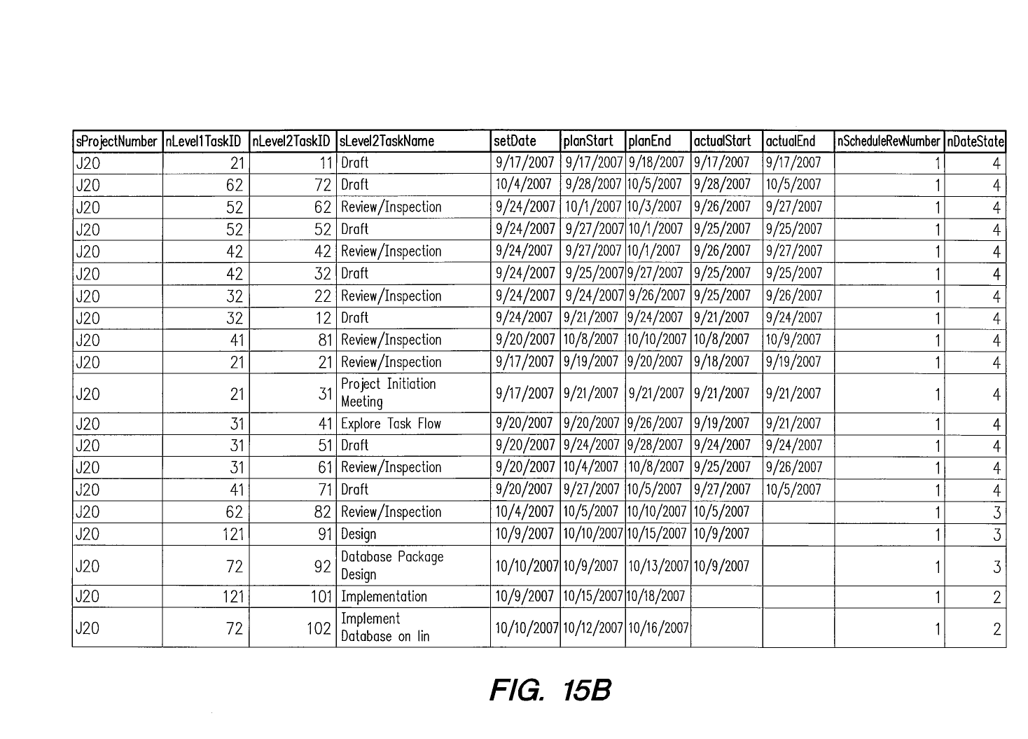

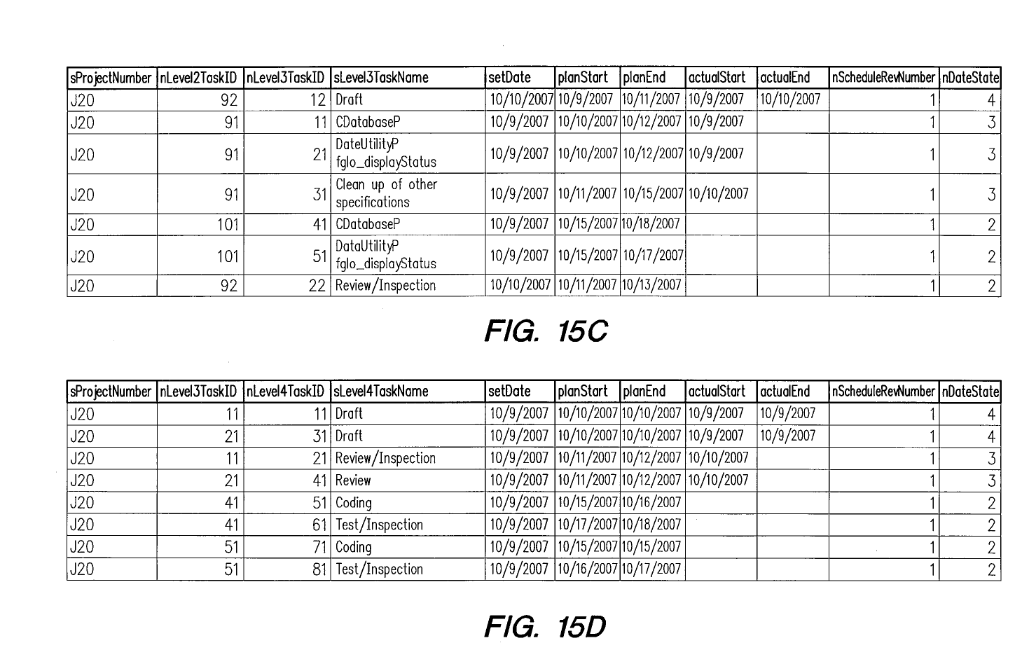

Workstations 501, 502 are typically computer systems configured as illustrated by the computer system 1800 of FIG. 15, with one or more browsers, and are utilized, for example, by the engineers/developers to complete tasks associated with a product development project. Pertinent non-limiting examples of such tasks include initiating projects, preparing and maintaining task schedules, designing software architecture, creating specifications, creating software code, implementing and testing software code, inspecting various task products, etc. In addition, project managers utilize workstations 501, 502 for accessing information to review and manage the progress of the project. The developers and managers transmit communications through the network 500 to the other connected components, e.g., Web servers 507, 530; databases 506, 536; and handheld device 520 and laptop 522, via access point(s) 524. The workstations 501 and 502, handheld devices 520, and laptop 522, which can access the Web pages from the Web servers 507 and 530, can process the JavaScript that the Web page contains to manage the editors in the browser. The browsers can process the JavaScript.

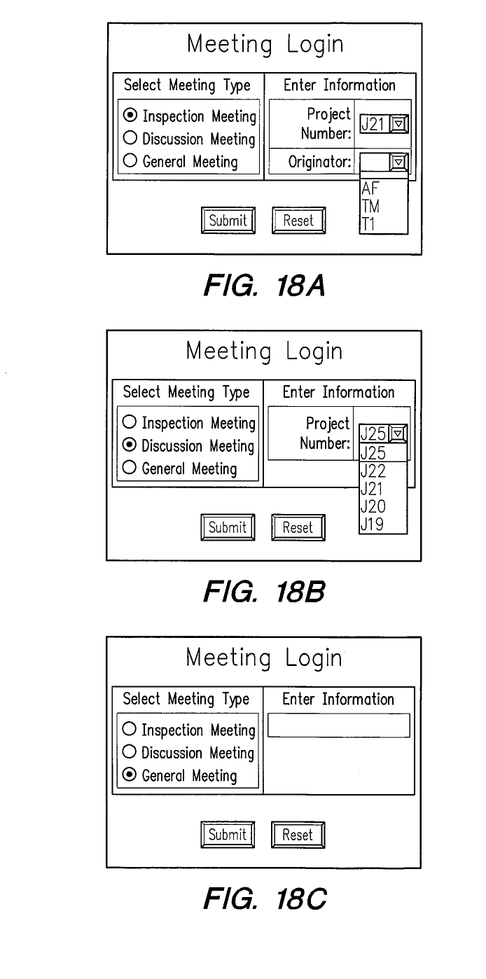

Web servers 507, 530 depict a typical Web server, which is a combination of computer hardware and software that, using the appropriate protocols (e.g., Hypertext Transfer Protocol [HTTP] and Transmission Control Protocol/Internet Protocol [TCP/IP]), serves the files that form Web pages (e.g., Hypertext Markup Language [HTML] or Extensible Markup Language [XML] files), to users, such as developers or managers at a workstation 501, 502. For a non-limiting example, an Apache Web server, which contains modules for the execution of PHP scripts, may be used as the Web server application for the Web server 507 and 530. In general, the majority of information exchanged and managed during the development project life cycle is served by the Web servers 507, 530 over the network 500. Furthermore, aspects of the techniques described herein may be implemented and executed on the Web servers 507, 530, although practice of the invention is not limited to such an implementation. The techniques could also be implemented on any other processing system, such as workstations 501, 502 or a similarly configured computer system as illustrated in FIG. 18.

Databases 506, 536 depict typical databases for storing data 508, 538 related to the development project, thus providing access to the information by authorized individuals at workstations 501, 502, through queries transmitted over the network 500. The type of data stored on databases 506, 536 is effectively limitless, wherein non-limiting examples include project initiation forms, member and project task schedules, specifications, software code, inspection reports, Web page files, and document directories and indexes.

Network 500 depicts a conventional network, e.g., a packet-switched network, for facilitating the exchange of information between and among various connected components, such as workstations 501,502, Web servers 507, 530, and databases 506, 536. The network 500 may be a Local Area Network (LAN), such as a conventional Ethernet, Fast Ethernet, a token ring, or a wireless LAN such as specified in 802.11a and 802.11b (developed by a working group of the Institute of Electrical and Electronics Engineers [IEEE]), which may be implemented within an enterprise. In addition, network 500 may also be a Wide Area Network (WAN), such as the Internet, for facilitating communication with remote users through a Virtual Private Network (VPN), or the network 500 may represent a combination of a LAN and a WAN. In addition, network 500 can be formed using a variety of different mediums, including but not limited electrical wire or cable, optical, or wireless connections.

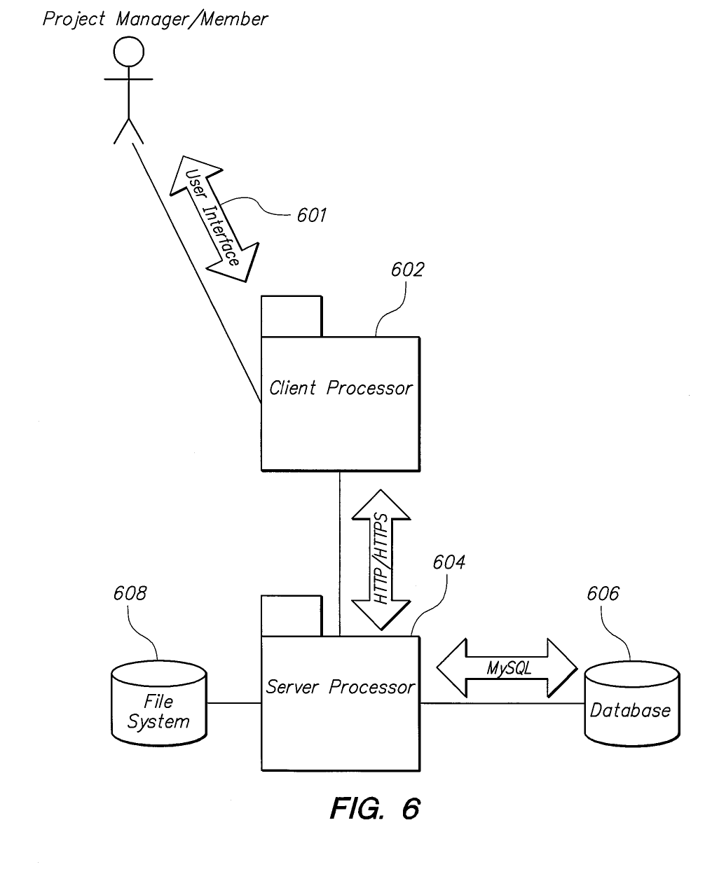

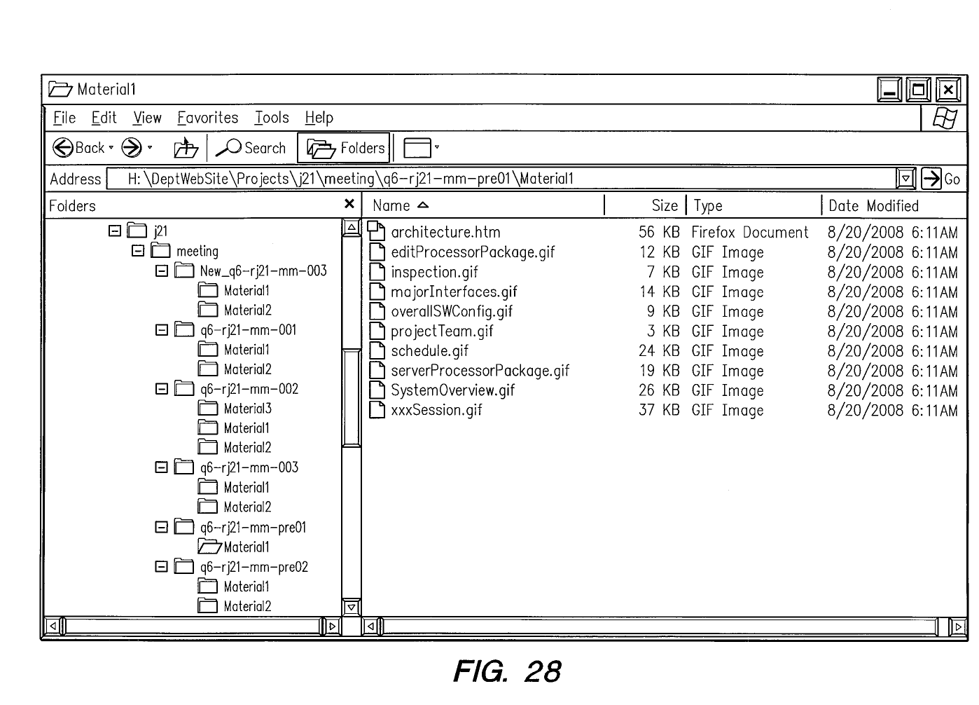

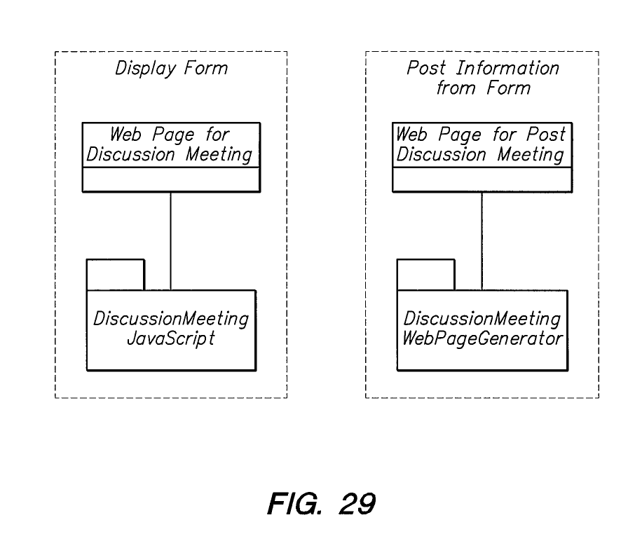

FIG. 6 is a diagram illustrating a communications architecture in which an embodiment of the invention may be implemented, including software components of an automated scheduling system or automated inspection meeting system. The client processor 602 corresponds to a Web browser and the server processor 604 corresponds to a Web server, such as Web servers 507 and 530 (FIG. 5). A project member or manager interacts with the client processor 602 through a user interface 601. The client processor 602 manages and maintains the login Web pages (FIGS. 4, 28) and the various editor or meeting form Web pages (FIGS. 1A, 2A, 3A, 29). The client processor 602 handles all events that occur in these Web pages. According to one embodiment, the client processor 602 interacts with the server processor 604 through the HTTP protocol. According to one embodiment, the client processor 602 interacts with the server processor 604 through the secure HTTPS protocol.

The server processor 604 provides information to the client processor 602 to display the login Web pages (FIGS. 4, 28) and editor or meeting form Web pages (FIGS. 1A, 2A, 3A, 29). The server processor 604 also processes the information in the login and editor or meeting form Web pages when the client processor 602 submits the information in these pages. The database 606 is a repository of project and task scheduling and inspection information. The server processor 604 interacts with the database 606 to obtain, add, or update information in the databases. According to one implementation, the server processor 604 interacts with the database 606. However, other databases and protocols can be used. For example, the server processor 604 may interact with a file system 608 to store and retrieve various Web pages, such as a member schedule Web page or an inspection meeting document.

### Client-Server Interfaces

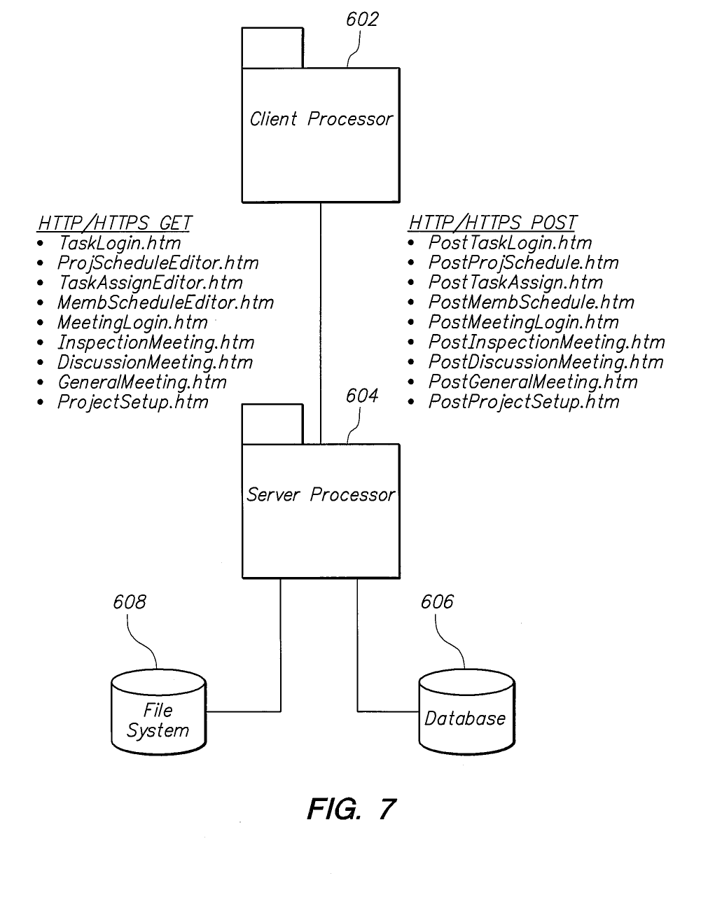

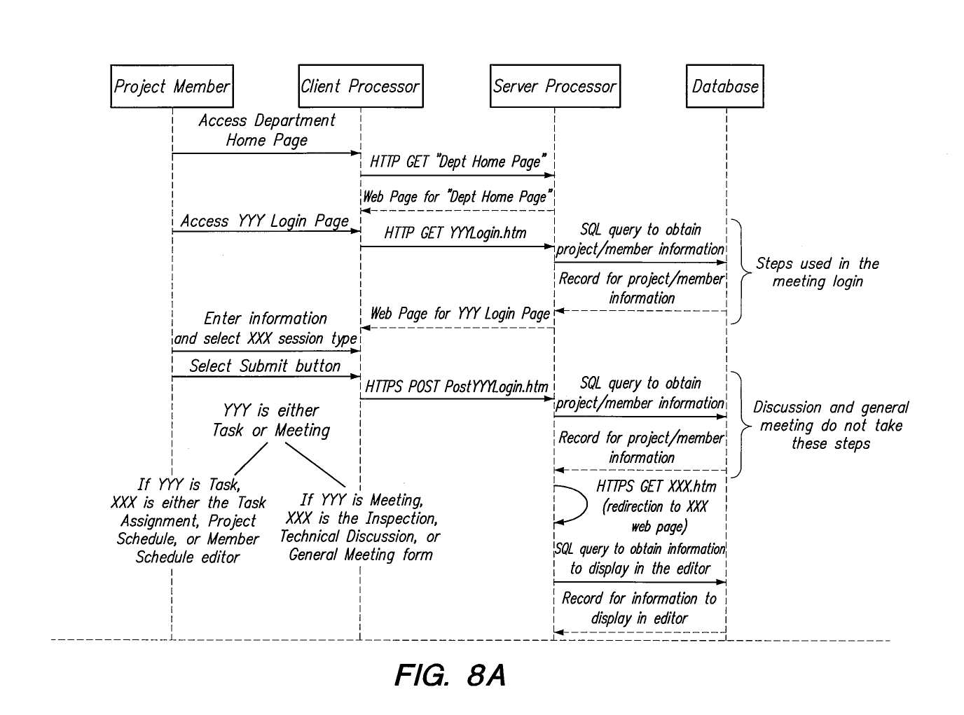

FIG. 7 is a diagram illustrating interfaces between the client processor and the server processor of the system. The HTTP/HTTPS GET requests provide for the client processor 602 obtaining the home, task login (FIG. 4), project schedule editor (FIG. 2A), member schedule editor (FIG. 3A), task assignment editor (FIG. 1A), meeting login (FIG. 28), and inspection meeting form (FIG. 29) Web pages from the server processor 604. The HTTP/HTTPS POST requests provide for the client processor 602 submitting information entered in the login (FIGS. 4, 28) and editor and meeting form Web pages (FIGS. 1A, 2A, 3A, 29) to the server processor 604 for processing. The applicable HTTP/HTTPS GET and HTTP/HTTPS POST requests are described in greater detail hereafter.

HTTP/HTTPS GET TaskLogin.htm requests cause the server processor 604 to return to the client processor 602 a Web page that allows a project member or manager to log on to one of the editors (project schedule, member schedule, task assignment). The member or manager enters information about the project, member name, and editor session type. FIG. 4 depicts a Web page for logging into to one of the editors.

HTTP/HTTPS GET ProjScheduleEditor.htm requests cause the server processor 604 to return to the client processor 602 a Web page for the project schedule editor, which is used to create or update the project schedule for the current project. A project manager must have access privileges to create the project schedule before the server processor 604 returns the project schedule editor. This privilege is verified when the manager submits the information in the login Web page (FIG. 4). According to one embodiment, ProjScheduleEditor.htm includes Javascript to display, manage, and handle events in the project schedule editor Web page. According to one embodiment, ProjScheduleEditor.htm includes PHP scripts to obtain information from the databases 506, 536 and pass the information to the JavaScript so the information is displayed in the project schedule editor, an example of which is depicted in FIG. 2A.

HTTP/HTTPS GET TaskAssignEditor.htm requests cause the server processor 604 to return to the client processor 602 a Web page for the task assignment editor, which is used to assign tasks to the project members for the current project. A project manager requires access privileges to assign tasks to the project members before the server processor 604 returns the task assignment editor Web page. This privilege is verified when the manager submits the information in the login Web page (FIG. 4). According to one embodiment, TaskAssignEditor.htm includes JavaScript to display, manage, and handle events in the task assignment editor. According to one embodiment, TaskAssignEditor.htm includes PHP scripts to obtain information from the databases 506, 536 and pass the information to the JavaScript so the information is displayed in the task assignment editor, an example of which is depicted in FIG. 1A.

HTTP/HTTPS GET MembScheduleEditor.htm requests cause the server processor 604 to return to the client processor 602 a Web page for the member schedule editor, which is used to create or update a project member's schedule for the current project. According to one embodiment, the schedule editor displays only uncompleted tasks if the project member's schedule has been previously created. A project member must have privileges to create or edit the schedule before the server processor 604 returns this Web page. This privilege is verified when the member submits the information in the login Web page (FIG. 4). According to one embodiment, MembScheduleEditor.htm includes JavaScript to display, manage, and handle events in the project member's schedule editor. According to one embodiment, MembScheduleEditor.htm includes PHP scripts to obtain information from the databases 506, 536 and pass the information to the JavaScript so the information is displayed in the member schedule editor, an example of which is depicted in FIG. 3A.

HTTP/HTTPS GET MeetingLogin.htm requests cause the server processor 604 to return to the client processor 602 a Web page for logging into a meeting, for example, an inspection meeting, a discussion meeting or a general meeting. The user enters information about the project, member name, and meeting type. FIG. 28 depicts an example Web page for logging into a meeting.

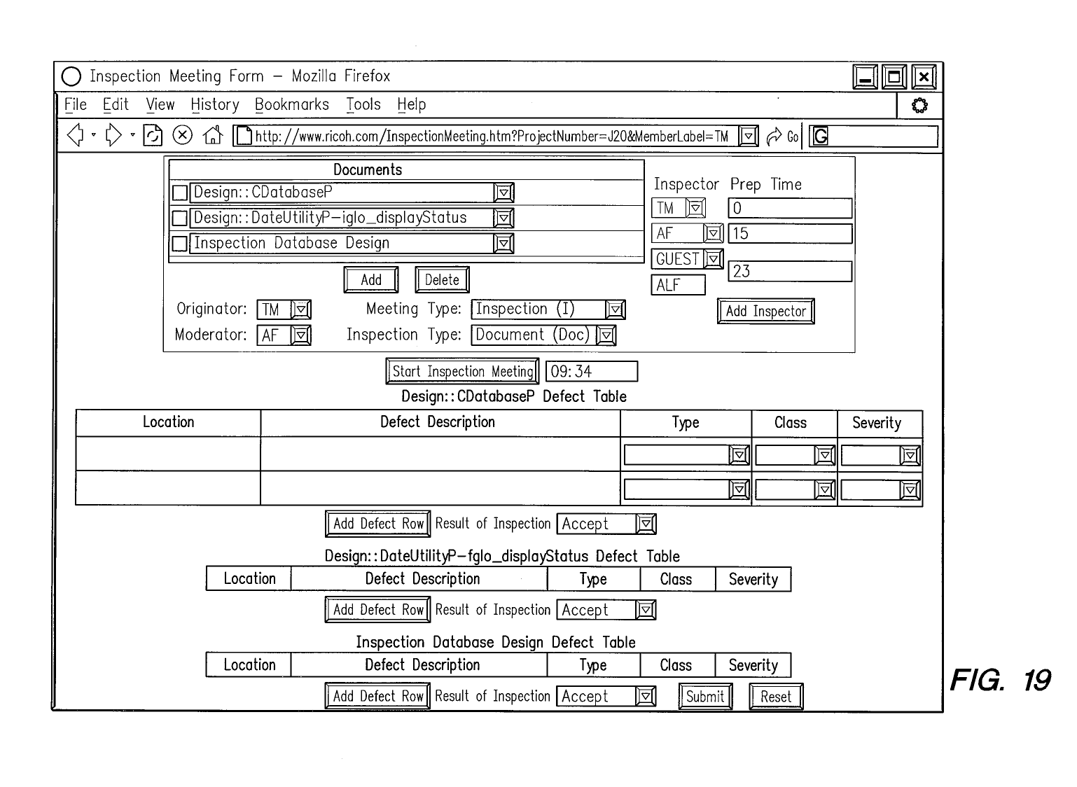

HTTP/HTTPS GET InspectionMeeting.htm request causes the server processor 604 to return to the client processor 602 a Web page for entering information pertaining to an inspection meeting. An inspection meeting is used in projects to locate/identify defects in inspection material. Inspection material may include requirement's document, guideline documents, code convention documents, design documents, code, and devices. According to one embodiment, InspectionMeeting.htm includes JavaScript to display, manage, and handle events in the inspection meeting Web page. According to one embodiment, InspectionMeeting.htm includes PHP scripts to obtain information from the databases 506, 536 and pass the information to the JavaScript so the information is displayed in the inspection meeting form, an example of which is depicted in FIG. 19.

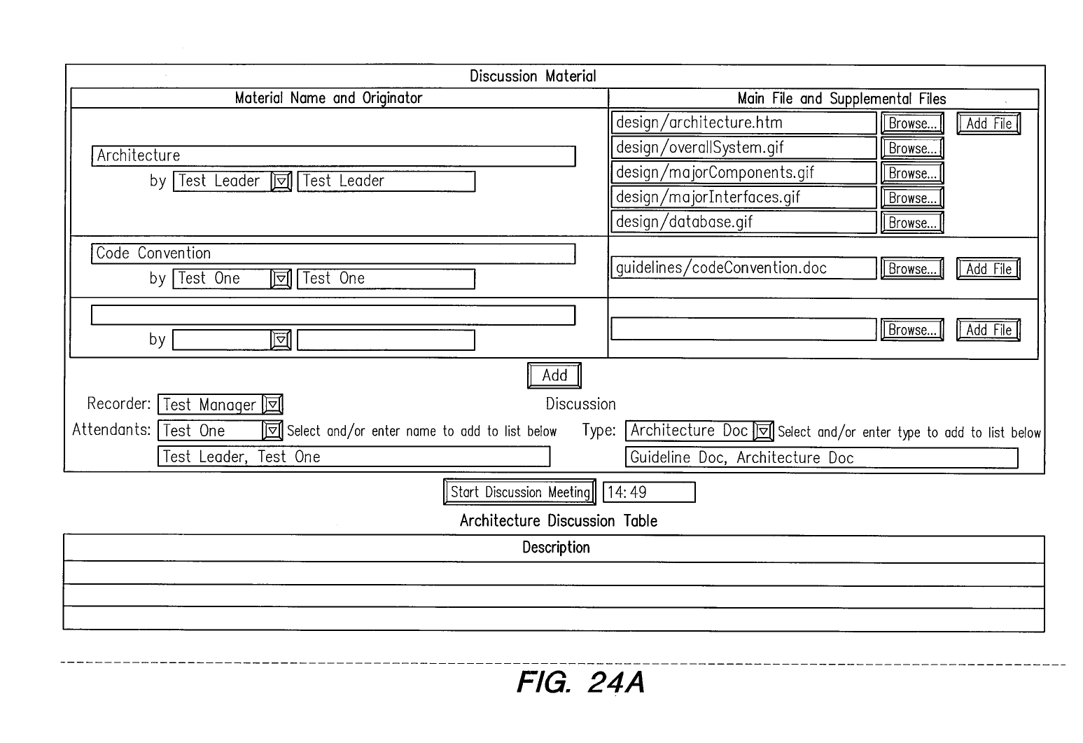

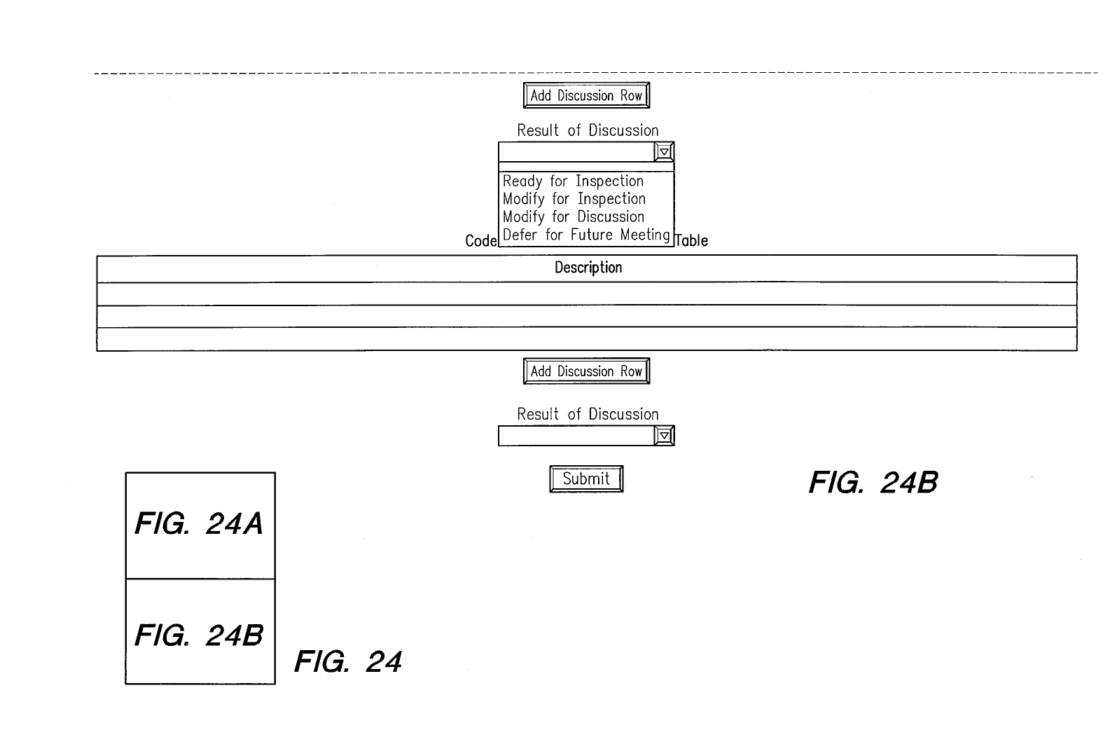

HTTP/HTTPS GET DiscussionMeeting.htm requests cause the server processor 604 to return to the client processor 602 a Web page for entering information pertaining to a discussion meeting. A discussion meeting is used in projects to discuss defects, improvements, and/or alternative solutions in discussion material. Discussion material may include documents related to a project such as requirement's document, guideline documents, code convention documents, and design documents. According to one embodiment, DiscussionMeeting.htm includes JavaScript to display, manage, and handle events in the discussion meeting Web page. According to one embodiment, DiscussionMeeting.htm includes PHP scripts to obtain information from the databases 506, 536 and pass the information to the JavaScript so the information is displayed in the discussion meeting form, an example of which is depicted in FIG. 24.

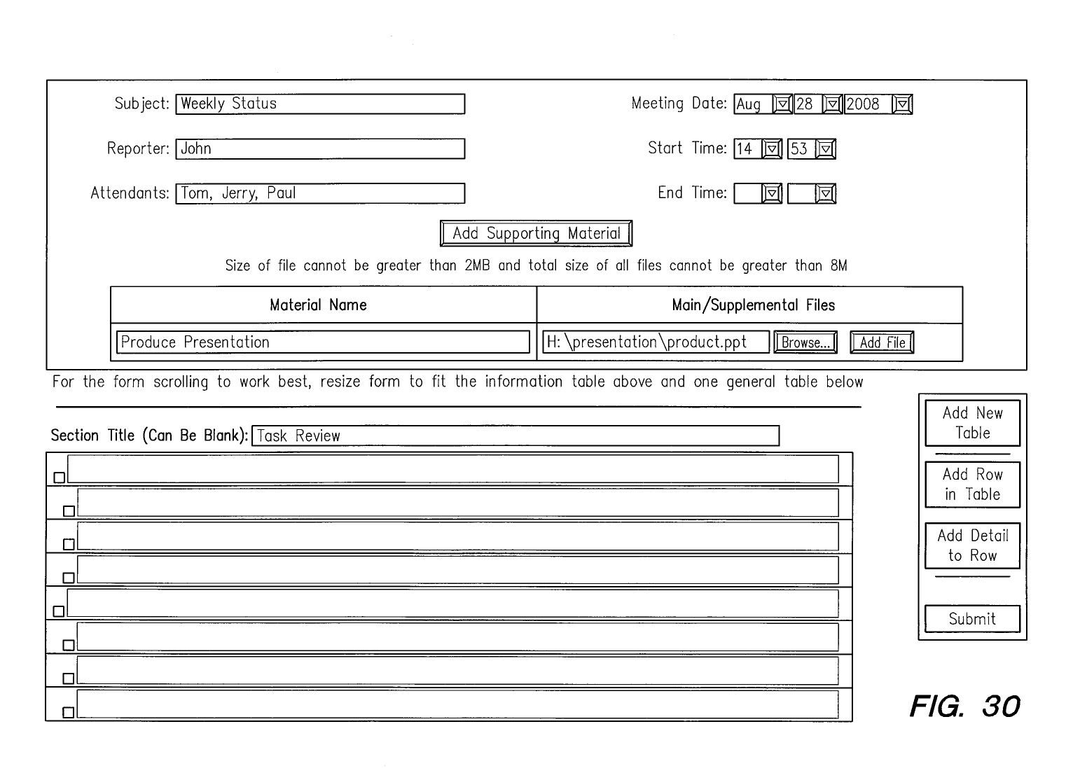

HTTP/HTTPS GET GeneralMeeting.htm requests cause the server processor 604 to return to the client processor 602 a Web page for entering information pertaining to a general meeting. A general meeting is used to discuss non project subjects or any topic where a record of such meeting is kept. Some such subject or topic may be a status meeting to discuss the status of each project member or a presentation presented by an outside source. Comments or remarks can be made on the subjects or topics in the meeting. According to one embodiment, GeneralMeeting.htm includes JavaScript to display, manage, and handle events in the general meeting Web page, an example of which is depicted in FIG. 30.

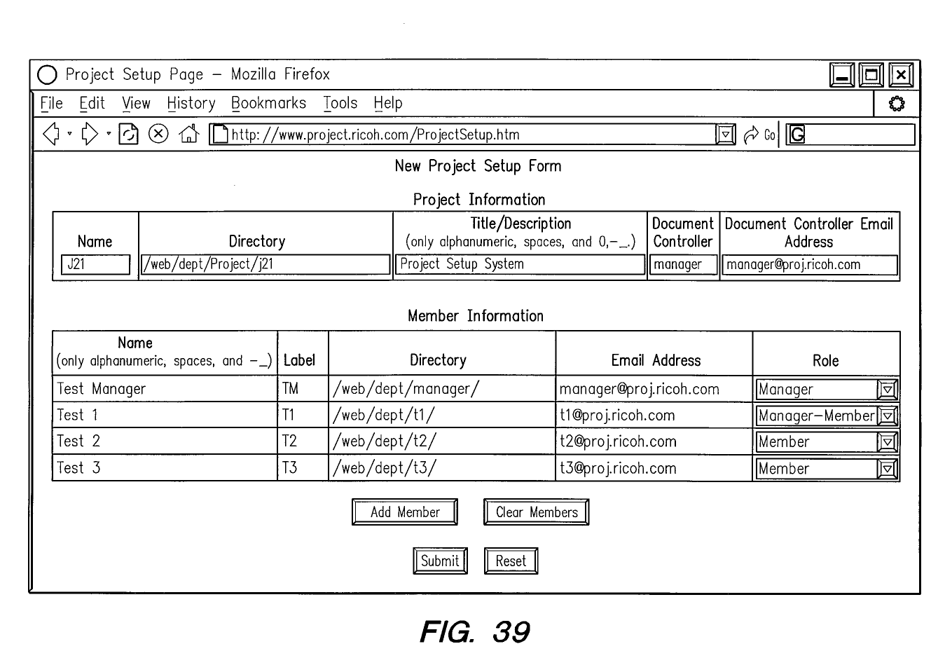

HTTP/HTTPS GET ProjectSetup.htm requests cause the server processor 604 to return to the client processor 602 a Web page for entering information pertaining to a project. The Web page allows a user to enter the information to start a new project. FIG. 39 depicts an example Web page for entering information pertaining to set up a new project.

HTTP/HTTPS POST PostTaskLogin.htm interface allow the client processor 602 to access and display the various editors (project schedule, member schedule, task assignment). This interface is called when the “Submit” button is selected from the Web page corresponding to TaskLogin.htm. The information entered in TaskLogin.htm is passed to PostTaskLogin.htm in the server processor 604. The PostTaskLogin.htm uses the information to validate the member for the project, and to determine if the member has access privileges to the requested editor. If the information is invalid or the member does not have access privilege to the editor, then PostTaskLogin.htm returns a message to the client processor 602 that the project member cannot access the requested editor. Otherwise, PostTaskLogin.htm returns the Web page corresponding to one of the editors, i.e., the Web browser is redirected to the Web page corresponding to the requested editor.

HTTP/HTTPS POST PostTaskAssign.htm allows the client processor 602 to submit to the server processor 604 all the information entered in the task assignment editor (FIG. 1A). This interface is called when the “Finish” button is selected from the Web page corresponding to TaskAssignEditor.htm. The information entered in the editor of TaskAssignEditor.htm is passed to PostTaskAssign.htm in the server processor 604. PostTaskAssign.htm adds and updates task assignment information in the appropriate database 506, 536. An appropriate message is displayed if any of the information entered is invalid or if the process fails to access or query the appropriate database. PostTaskAssign.htm also creates the task assignment Web page, an example of which is depicted in FIG. 1B.

HTTP/HTTPS POST PostProjSchedule.htm allows the client processor 602 to submit to the server processor 604 all the information entered in the project schedule editor (FIG. 2A). This interface is called when the “Finish” button is selected from the Web page corresponding to ProjScheduleEditor.htm. The information entered in the editor of ProjScheduleEditor.htm is passed to PostProjSchedule.htm in the server processor 604. PostProjSchedule.htm adds and updates task schedule information in the appropriate database 506, 536. An appropriate message is displayed if any of the information entered is invalid or if the process fails to access or query the appropriate database. PostProjSchedule.htm also creates the project schedule Web page, an example of which is depicted in FIG. 2B.

HTTP/HTTPS POST PostMembSchedule.htm allows the client processor 602 to submit to the server processor 604 all the information entered in the project member's schedule editor (FIG. 3A). This interface is called when the “Finish” button is selected from the Web page corresponding to MembScheduleEditor.htm. The information entered in the editor of MembScheduleEditor.htm is passed to PostMembSchedule.htm in the server processor 604. PostMembSchedule.htm adds and updates task schedule information in the appropriate database 506, 536. An appropriate message is displayed if any of the information entered is invalid or if the process fails to access or query the database. PostMembSchedule.htm also creates the member's schedule Web page, an example of which is depicted in FIG. 3B.

HTTP/HTTPS POST PostMeetingLogin.htm allows the client processor 602 to submit to the server processor 604 all the information entered in the Meeting Login Webpage (FIGS. 18A-18C). This information includes, for example, the type of meeting requested, such as an inspection meeting, a discussion meeting or a general meeting, a well as a project number and initials of an originator. This interface is called when the “Submit” button is selected from the Web page corresponding to MeetingLogin.htm. The information entered in MeetingLogin.htm is passed to PostMeetingLogin.htm in the server processor 604. PostMeetingLogin.htm returns the Web page corresponding to one of the meeting forms, i.e., the Web browser is redirected to the Web page corresponding to the requested meeting form.

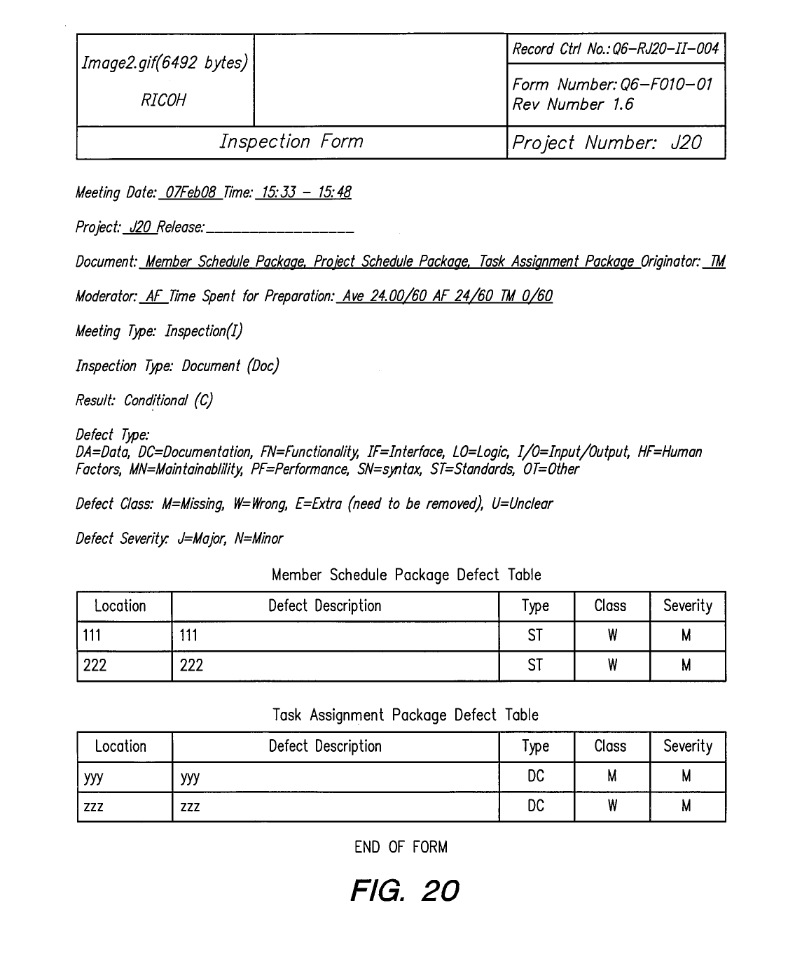

HTTP/HTTPS POST PostInspectionMeeting.htm allows the client processor 602 to submit to the server processor 604 all the information entered in the Inspection Meeting Form (FIG. 19). This information includes, for example, the documents selected for inspection and the details of the inspection, such as the inspector, originator, moderator, etc., the results of the inspection and details about defects identified during the inspection. This interface is called when the “Submit” button is selected from the Web page corresponding to InspectionMeeting.htm. PostInspectionMeeting.htm adds and updates inspection information in the appropriate database 506, 536. An appropriate message is displayed if any of the information entered is invalid or if the process fails to access or query the appropriate database. PostInspectionMeeting.htm also creates the inspection Web page, examples of which are depicted in FIGS. 20, 21, and 22.

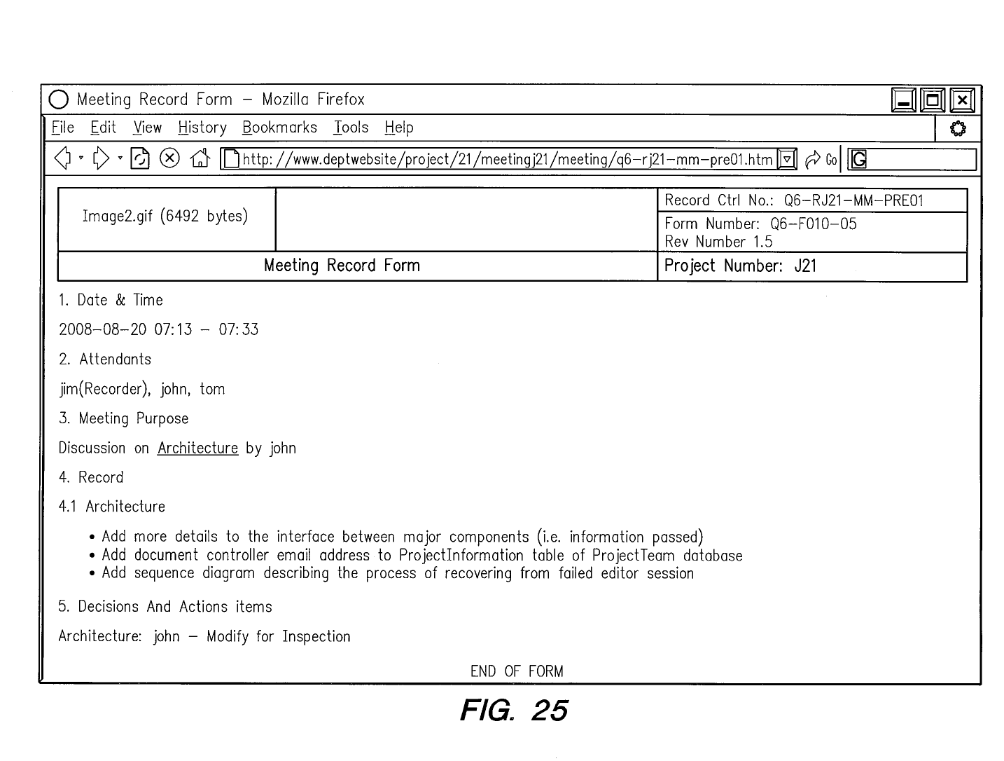

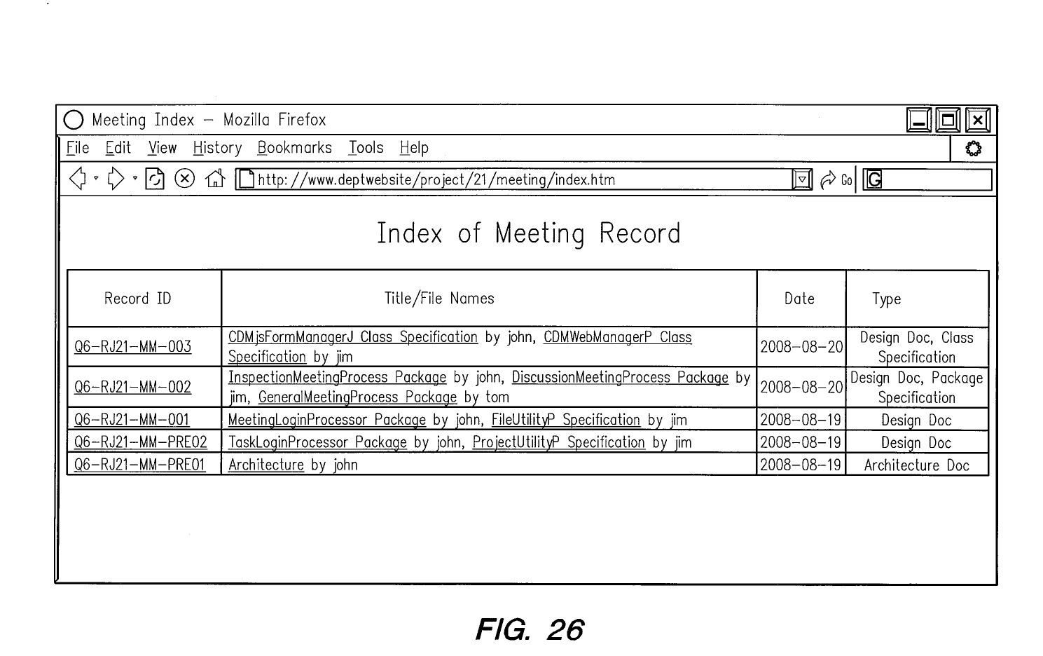

HTTP/HTTPS POST PostDiscussionMeeting.htm allows the client processor 602 to submit to the server processor 604 all the information entered in the Discussion Meeting Form (FIG. 24). This information includes, for example, the names and originators of the discussion materials, the main and supplemental files associated with the discussion materials, the recorder of the meeting, the attendants of the meeting, the meeting types, the start time of the discussion meeting, comments/remarks of the discussion materials, and results of the discussion of the discussion materials. This interface is called when the “Submit” button is selected from the Web page corresponding to DiscussionMeeting.htm. PostDiscussionMeeting.htm creates/updates the discussion Web pages, examples of which are depicted in FIGS. 25 and 26.

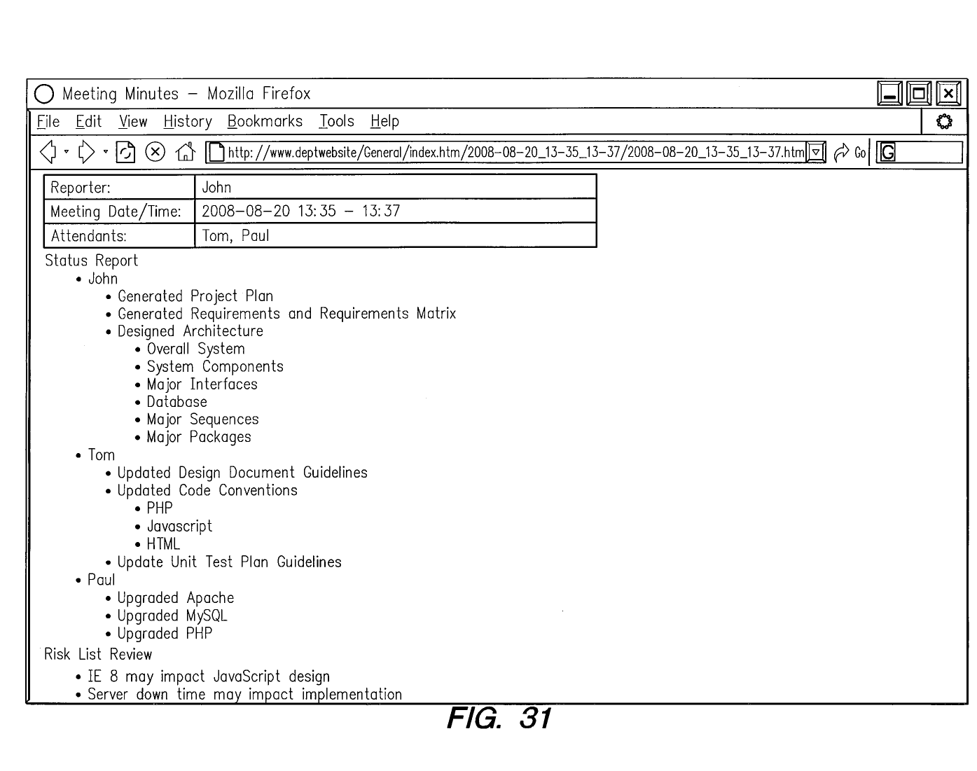

HTTP/HTTPS POST PostGeneralMeeting.htm allows the client processor 602 to submit to the server processor 604 all the information entered in the General Meeting Form (FIG. 30). This information includes, for example, the subject of the general meeting, the reporter of the meeting, the attendants of the meeting, the date and times (start and end) of the meeting, the names of materials used in the meeting and the main and supplemental files associated with the materials, and comments/remarks made in the meeting. This interface is called when the “Submit” button is selected from the Web page corresponding to GeneralMeeting.htm. PostGeneralMeeting.htm creates/updates the general Web pages, examples of which are depicted in FIGS. 31, 32, and 33.

HTTP/HTTPS POST PostProjectSetup.htm allows the client processor 602 to submit to the server processor 604 all the information entered in the New Project Setup Form (FIG. 39). This information includes, for example, a name, location and title/description of a new project, as well as member information for the new project. The member information may include, for each member, the name, label, directory location, email address and role. This interface is called when the “Submit” button is selected from the Web page corresponding to ProjectSetup.htm. PostProjectSetup.htm adds and updates project information in the appropriate database 506, 536. PostProjectSetup.htm also sets up the web server for the new project.

The Web pages for the various editors (TaskAssignEditor.htm, ProjScheduleEditor.htm, MembScheduleEditor.htm and InspectionMeeting.htm) include files that contain Javascript or PHP script, according to one non-limiting embodiment. The scripting languages used to perform the various functions described herein may vary from implementation to implementation. When a Web browser (e.g., client processor 602) requests the Web page of an editor or meeting form, the editor or meeting form Web page and all the files corresponding to Javascript are passed to the Web browser, whereby the Web browser processes the Javascript. However, the files for the PHP script are not passed to the Web browser. The PHP script are processed in the Web server, such as Web servers 507, 530 of FIG. 5, where only what the PHP script writes onto the Web page is passed to the Web browser.

### Sequence Diagrams for Editors

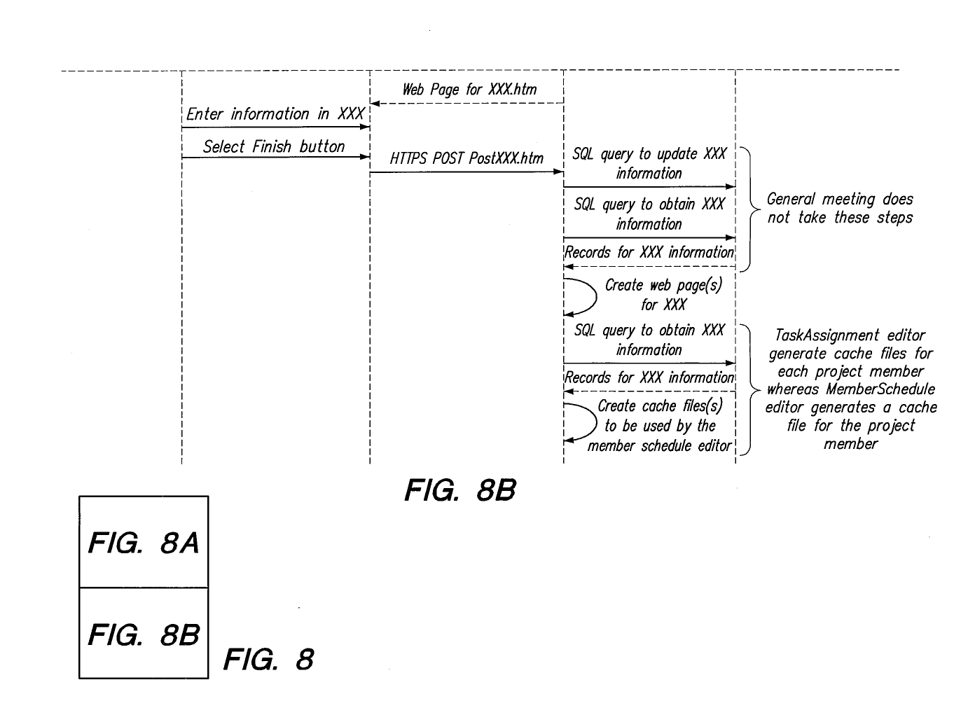

FIG. 8 depicts a sequence diagram for a project member or manager to use the login Web page to log onto one of the task editors or one of the meeting forms (inspection and other forms). FIG. 8 also depicts the sequences involved in displaying the Web page for the task editor or meeting form, interacting with the task editor or meeting form by a user and completing the session, posting the information in the task editor or meeting form into the database and generating the appropriate web pages for the task editor or meeting form. Processing occurs within the client processor 602 to handle all the events that occur on the login, editor, and meeting form Web pages (FIGS. 1A, 2A, 3A, 4, 18A-18C, 19, 24, 30). Processing occurs within the server processor 604 to validate the information entered in the login Web pages and to verify the access privilege to the editor or meeting form Web pages. The server processor 604 obtains information from the appropriate database 506 or 536 for the verification of access privileges. The server processor 604 obtains information from the appropriate database 506 or 536 that will be used in the task editor or meeting form. The server processor 604 also obtains the information entered in the task editor or meeting form by the project member or manager when the task editor or meeting form is submitted, adds or updates the information in the appropriate database 506 or 536, and generates the appropriate web pages.

### Database Schema

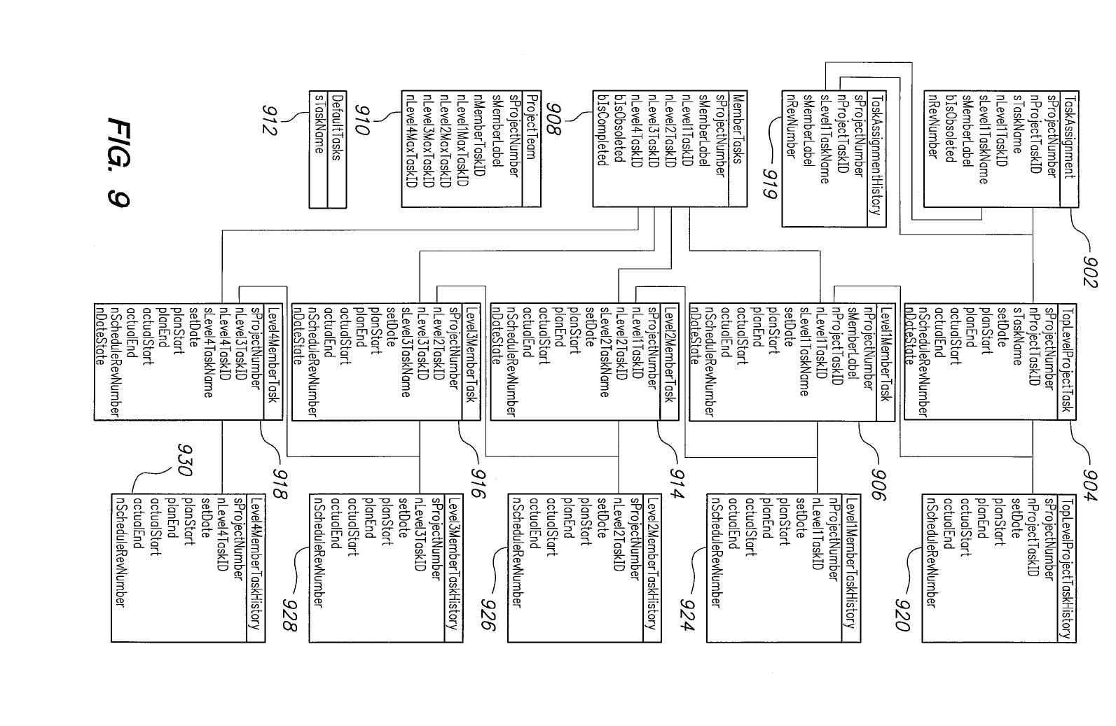

FIG. 9 depicts a schema of database tables used to store and manage task assignment and task schedule information for projects and project members. The tables maintain information about the task assignments, the schedule for the project tasks, and the schedules for each project member. The tables are organized and linked such that the task assignments, project schedule, and members' schedule are all related.

The TaskAssignment table 902 stores the project tasks and corresponding subtasks of a project along with the assignment of the subtasks to project members. The TaskAssignmentHistory table 919 stores the history of the assignment of the subtasks to project members. The TopLevelProjectTask table 904 stores the schedule of the project tasks that are in the TaskAssignment table 902. The TopLevelProjectTaskHistory table 920 stores the history of the schedule of the project tasks. The Level1MemberTask table 906 stores the schedule of the member tasks which are assigned in the TaskAssignment table 902 and links to the schedule of its corresponding project task in the TopLevelProjectTask table 904. These links between the tables enable the automatic aggregation of the member schedules with the project schedule. The Level1MemberTask table 906 also stores the schedule of the member tasks that are not related to any project task. The Level1MemberTaskHistory table 924 stores the history of the schedule of the member tasks. The LevelXMemberTask tables (where X is 1, 2, 3, and 4) and the MemberTasks table 908 store and manage links between the various levels of tasks of a member. The lower level tasks are more detailed tasks of the upper level tasks. The organization of these tables maintains the schedule of a member. The LevelXMemberTaskHistory table (926, 928, 930) store the history of the schedule of the lower level tasks. The ProjectTeam table 910 contains information about the project members. The project member information for a project member includes the IDs used for determining the identifier of the member tasks at various levels.

The task assignment editor uses and/or updates information in the tables DefaultTasks 912, TaskAssignment 902, TaskAssignmentHistory 919, TopLevelProjectTask 904, and MemberTasks 908. The project schedule editor uses and/or updates information in the tables DefaultTasks 912, TaskAssignment 902, TopLevelProjectTask 904, TopLevelProjectTaskHistory 920, MemberTasks 908, and Level1MemberTask 906. The member schedule editor uses and/or updates information in the tables ProjectTeam 910, TaskAssignment 902, TopLevelProjectTask 904, MemberTasks 908, LevelXMemberTask, and LevelXMemberTaskHistory. The inspection meeting form uses and/or updates information in the tables ProjectTeam 910, MemberTasks 908, LevelXMemberTask, and LevelXMemberTaskHistory.

Descriptions of the various tables depicted in FIG. 9, and used in an embodiment of the project management system described herein, are as follows. However, the number and structure of the tables described in reference to FIG. 9 may vary from implementation to implementation.

DefaultTasks table 912 contains the names of tasks that are typically tasks for all projects. In the context of software development projects, some examples of default tasks are Project Plans, Requirements, and Top Level Design.

ProjectTeam table 910 contains information about project members for a project. sMemberLabel is a 2 to 4 character string used to identify a project member when displaying the project schedule, which depicts the project tasks and associated member tasks as depicted in FIGS. 1A and 1B. In one embodiment, the initials of the project member are used for sMemberLabel.

nMemberTaskID is a number assigned to a project member that is used to determine the ID of a task for that member. According to one embodiment, the nMemberTaskIDs are used as the start ID for a task. Depending upon the size of the project team, the ID can be MOD 10 (1, 2, . . . , 9) for a small team or MOD 100 (1, 2, . . . , 99) or higher for a large team. The task IDs are increments of the MOD. For example, if the nMemberTaskID of project member ‘T1’ is 1, then the task IDs of T1's task will be 11, 21, 31, and so forth (or 101, 201, 301, and so forth for a large team). The task ID uniquely identifies a task for a project member even if the names of some of the tasks are the same. The task ID also uniquely identifies a task at all levels. nLevelXMaxTaskID is a number used to maintain the highest task IDs that have been used so far for the different level tasks of a project member. These numbers provide the starting IDs used to determine the task IDs of tasks that are added in the member's schedule editor session. These values are retrieved and updated after each editor session. Except for the values for nLevelXMaxTaskID, the values for the other entries must be set prior to the beginning of a project.

TaskAssignment table 902 contains information about the project tasks and its subtasks that are assigned to project members for a project. sTaskName is used for the names of the tasks and nProjectTaskID are the IDs associated with the tasks. The project start task ID is 0 so that the ID for its tasks will be increments of the MOD (10, 20, 30, . . . for small team). sLevel1TaskName is used for the names of the subtasks (member tasks) associated with the project tasks and nLevel1TaskID is used for the IDs associated with the subtasks. sMemberLabel is used to identify the project members that are assigned the subtasks. bIsObsoleted is used to indicate whether the task has been removed from the project. Even though a task is deleted from the schedule, information about the task is maintained in the database. Values for sTaskName, nProjectTaskID, sLevel1TaskName, and sMemberLabel can be added to the TaskAssignment table 902 through a task assignment editor session. The project schedule editor session can add values for sTaskName and nProjectTaskID. Only the member schedule editor session can add values for nLevel1TaskID. nRevNumber is the revision number of the current assignment of the task. If no members are assigned to the task, nRevNumber is 0.

TopLevelProjectTask table 904 contains information about the most current scheduling of project tasks. sTaskName is used for the names of the tasks and nProjectTaskID is used for the IDs associated with the tasks. planStart and planEnd are used for the expected dates for starting and completing the task. actualStart and actualEnd are used for the actual dates in which the task was started and completed. setDate is used for the date in which the task was added, planned dates were set, or planned dates were modified. If no planned dates are set for the task, then the revision number is 0. nScheduleRevNumber is used for the revision number of the task schedule. The most current revision number of a project task is maintained in the TopLevelProjectTask table 904. The revision is incremented only when the planned dates are changed in the project schedule editor on different days. All values for nProjectTaskID, sTaskName, dates, and nScheduleRevNumber are added or updated in the TopLevelProjectTask table 904 through a project schedule editor session or a task assignment editor session. nDateState indicates the current state of a task. A variety of values may be used to represent the state of a task, depending upon a particular implementation. One set of example values for nDateState are as follows:

4 indicates that the task was completed. All the dates have been set.

3 indicates that the task was started. All the dates except the actualEnd have been set.

2 indicates that the task was planned. Only the planStart and planEnd have been set.

1 indicates that the task was planned start-only. Only the planStart has been set.

0 indicates that the task was not scheduled. This task is a to-do list task. This task was added to the member schedule but not actually scheduled. The setDate is set to the date that the task was added to the schedule. When the member logs back into the member schedule editor or views his/her member schedule web page, the task is listed to remind the member to schedule the task.

The nDateState field simplifies and reduces the number of queries needed to obtain information in the desired order from the database. To obtain tasks listed in order of completed tasks with ascending actual end dates, started tasks with ascending actual start dates, planned tasks with ascending plan end dates, planned start-only tasks with ascending plan start dates, and unscheduled tasks with ascending set dates, five separate queries are needed to obtain the tasks in this order (one query for each type of task) in the previous system. For example, to obtain task information for started tasks from project “J20” is “SELECT * FROM Level1MemberTask WHERE sProjectNumber=‘J20’ AND actualEnd IS NULL AND actualStart IS NOT NULL ORDER BY actualStart”. Similar queries are needed for other groups of tasks. With the new field, one query will obtain the tasks in the listed order of completed, started, planned, planned start-only, and unscheduled. For example, the query to obtain task information in the desired order for project “J20” is “SELECT * FROM Level1MemberTasks WHERE sProjectNumber=‘J20’ ORDER BY nDateState DESC, actualEnd, actualStart, planEnd, planStart, setDate”. The purpose of nDateState is to provide a simple query to obtain the task in a desired order so that it may be displayed in a form or a web page in that order. At the same time, nDateState indicates the status of a task.

MemberTasks table 908 contains information about all the tasks (tasks at all levels) for all the project members. Associated with each member of a project are the task Ids, nLevelXTaskID, which identify all the tasks and their relationship with one another. As with the TaskAssignment table, bIsObsoleted indicates if the task has been removed from the project member's schedule. bIsCompleted indicates if the tasks is completed. nLevelXTaskID is used for the tasks which are added to the MemberTasks table 908 and are determined from the nLevelXMaxTaskID of the ProjectTeam table 910 when new tasks are added in the member's schedule editor session. Values in the table can be updated or modified (bIsObsoleted or bIsCompleted) from the results of any of the three editor sessions (member schedule, project schedule, task assignment). The MemberTasks table 908 is important to provide a link between the lower level task schedules with the upper level task schedules.

LevelXMemberTask table (e.g., Level1MemberTask table 906, Level2MemberTask table 914, Level3MemberTask table 916, Level4MemberTask table 918) contains information about the most current scheduling of member tasks. sLevelXTaskName is used for the name of the tasks and nLevelXTaskID is used for the IDs associated with the tasks. nLevelXTaskID for the tasks which are added to the table are determined from the nLevelXMaxTaskID of the ProjectTeam table 910 when new tasks are added in the member's schedule editor session. planStart and planEnd are used for the expected dates for starting and completing the task. actualStart and actualEnd are used for the actual dates in which the task was started and completed. setDate is used for the date in which the task was added, planned dates were set, or planned dates were modified. If no planned dates are set for the task, then the revision number is 0. nScheduleRevNumber is used for the revision number of the task schedule. The most current revision number of a member task is maintained in the LevelXMemberTask table. According to one embodiment, the revision is incremented only when the planned dates are changed in the member schedule editor on different days. Each LevelXMemberTask table contains a task ID for upper level tasks (except for level 1, where a task either has a project task as its parent or no parent task). This provides for a task a link to its parent task and its child tasks. All values for parent task ID, sLevelXTaskName, nLevelXaskID, dates, and nScheduleRevNumber are added or updated in the table through the member schedule editor session. Only Level1MemberTask table 906 contains the sMemberLabel to provide a link to the TaskAssignment table 902.

FIG. 9 depicts only lower levels down to level 4 for purposes of explanation. However, the database can be modified to include lower levels for greater details in the task schedule.

TaskAssignmentHistory table 919 contains information about the history of the assignment to project members of tasks associated with project tasks. This table maintains information about the project members that were previously assigned the tasks before the tasks were reassigned to other project members. nProjectTaskID are the IDs associated with the tasks. sLevel1TaskName are the names of the subtasks (member tasks) associated with the project. sMemberLabel are the project members that are assigned the subtasks. nRevNumber is the revision numbers of the assignment of tasks to project members. The nRevNumber depicts the reassignment of the tasks in the project. The task assignment editor 102 (FIG. 1A) uses and/or updates information in the TaskAssignmentHistory table 919.

The TopLevelProjectTaskHistory table 920 contains information about the history of the schedule of project tasks. This table maintains all prior planned schedules of the project tasks. nProjectTaskID is used for the IDs associated with the tasks. planStart and planEnd are used for the expected dates for starting and completing the task. actualStart and actualEnd are used for the actual dates in which the task was started and completed. setDate is used for the date in which the task was added, planned dates were set, or planned dates were modified. If no planned dates are set for the task, then the revision number is 0. nScheduleRevNumber is used for the revision number of the task schedule. The more recent scheduling for a project task corresponds to the higher revision numbers. All previous scheduling of a project task are maintained in the TopLevelProjectTaskHistory table 920 to track the changes in the project task's schedule. The TopLevelProjectTask table 904 contains the current schedule of all the tasks in the TopLevelProjectTaskHistory table 904.

LevelXMemberTaskHistory tables (e.g., Level1MemberTaskHistory table 924, Level2MemberTaskHistory table 926, Level3MemberTaskHistory table 928, Level4MemberTaskHistory table 930) contain information about the history of the schedule of member tasks. These tables maintain all prior planned schedules of the member tasks. nLevelXaskID is used for the IDs associated with the tasks. planStart and planEnd are used for the expected dates for starting and completing the task. actualStart and actualEnd are used for the actual dates in which the task was started and completed. setDate is used for the date in which the task was added, planned dates were set, or planned dates were modified. If no planned dates are set for the task, then the revision number is 0. nScheduleRevNumber is used for the revision number of the task schedule. The more recent scheduling for a member task corresponds to the higher revision numbers. All previous scheduling of a member task are maintained in the LevelXMemberTaskHistory tables to track the changes in the member task's schedule. The LevelXMemberTask tables contain the current schedule of all the tasks in the LevelXMemberTaskHistory tables.

FIG. 10 depicts an example schema of database tables used to store and manage information about a project and the members of the project that is needed to setup the project for the project management system and setting up the web site for the project. The log in process uses information in the database tables to determine access privileges to a requested editor or meeting form before displaying the editor or meeting form. In FIG. 10, the ProjectInformation table 1002 contains information about the project number, the title or description of the project, the directory where the web pages for the project are located, the status of the project and the email address of the document controller of the project. The document controller is responsible for maintaining the documents of a project—assigning a project number to the document and adding the document to the appropriate place in the web site. The inspection meeting system and discussion meeting system automatically creates the inspection web pages and discussion web pages and place them in the appropriate place in the web site. They also assign the document control id to the meetings. The system automates the process that was originally performed by the document controller. However, if the system fails, the document controller is notified that the system failed to create the documents and the document controller must update the documents with the information from the meeting. The MemberInformation table 1004 contains member information for a given project. Member information includes member name, label such as initials for the member, role of member, the directory of the home page of the member where all the member's web pages are located, and the member's email address.

Various values may be used for the nProjectStatus field to indicate the status of a project. Example values are as follows:

0 indicates the project has not started

1 indicates that the project has started

10 indicates that the project is completed.

New numbers can be added to indicate other possible status of the project such as abandoned or reassigned.

Various values may also be used for the nMemberRole field to indicate the role of a member. Example values are as follows:

1 for manager
2 for member
3 for manager-member.
   These roles are example roles provided for explanation purposes and the invention is not limited to these particular roles. Additional roles may be added, for example, project leader, developer, or tester.

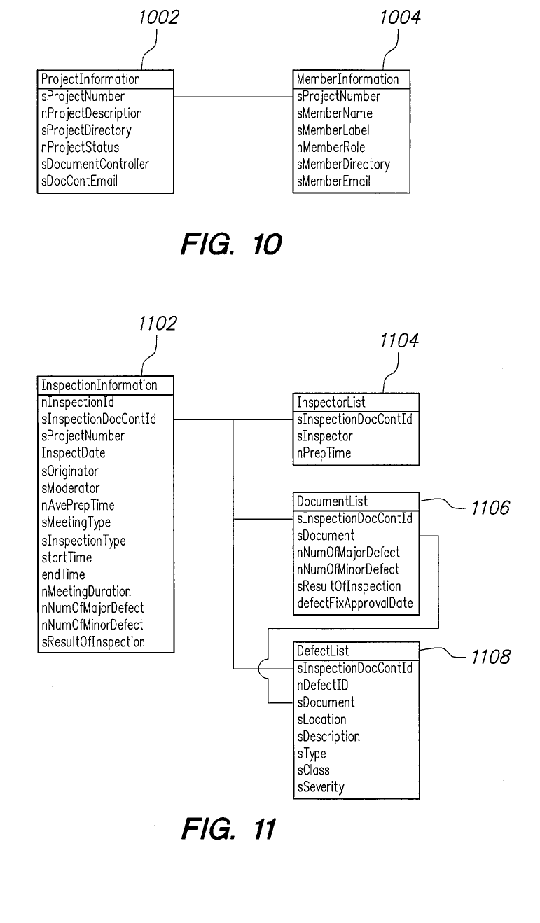

FIG. 11 depicts an example schema of database tables used to store information about the inspection meetings of a project. An inspection meeting is the inspection of inspection material for defect by project members. The inspection material may be project documents such as requirements or design or code. Other possible inspection material may include devices, electronic components, or user interface. An inspection meeting form of the project management system allows project members to enter information through a web browser for an inspection meeting. When the inspection meeting form is submitted, the HTML document for the meeting is generated and the inspection meeting information is stored in the database so that reports can be easily generated for statistical information related to all the inspection meetings of a project after each inspection meeting.

In FIG. 11, an InspectionInformation table 1102 contains general information about all the inspections. nInspectionId and sInspectionDocContId are assigned to the inspection meeting which uniquely identifies the inspection for a project. nInspectionId is a number that may be used to identify types of inspection based upon various conditions. For example, an nInspectionId value between 1 and 99 may be used to indicate that these inspection sessions occurred before the actual start of the project. Some material may require inspection prior to the start of a project. An nInspectionId value between 101 and 1099 may be used to indicate that the inspection sessions occurred during the project.

sInspectionDocContId is also used for the filename of the HTML document for the meeting. inspectDate is the date of the inspection and startTime and endTime is the time in which the inspection starts and ends. sOriginator is the member label of the member who is the author of the inspection material. sModerator is the member label of the member who presides over the inspection meeting and enters information in the inspection form. nAvePrepTime is the average time of all the time spent by the inspectors in preparing for the inspection. sMeetingType is the inspection meeting type which can be inspection, re-inspection, or maintenance. More meeting types may be added. sInspectionType is the type of inspection material which can be document, code, or others. More inspection types may be added. nMeetingDuration is the length of the inspection meeting. nNumOfMajorDefect and nNumOfMinorDefect is the total number of major and minor defects discovered for all the inspection material. sResultOfInspection is the sum of the results of the inspection of all the inspection material which can be either Accepted, Conditional, or Re-Inspect. If the result of any inspection material is Re-Inspect, then sResultOfInspection is Re-Inspect. If the result of any inspection material is Conditional and none are Re-Inspect, then sResultOfInspection is Conditional. If the results of all inspection material are Accepted, then sResultOfInspection is Accepted. More results can be added.

The InspectorList table 1104 contains all the inspector information for all the inspections. sInspector is the member label of the member who inspected the inspection material. nPrepTime is the time spent by the inspector in inspecting the material.

The DocumentList table 1106 contains all the inspection material for all the inspections. sDocument is the name of the inspection material. nNumOfMajorDefect and nNumOfMinorDefect is the total number of major and minor defects discovered in the inspection material. sResultOfInspection is the results of the inspection of the inspection material which can be either Accepted, Conditional, or Re-Inspect. Usually if there are one or more major defects for inspection material, then sResultOfInspection for the inspection material is Re-Inspect. If there are one or more minor defects without any major defects for inspection material, then sResultOfInspection for the inspection material is Conditional. If there are no defects for inspection material, then sResultOfInspection for the inspection material is Accepted. More results can be added. defectFixApprovalDate is the date that the correction of the defects discovered in the inspection meeting for the inspection material was approved.

The DefectList table 1108 contains all the defect lists for all the inspection material for all the inspections. nDefectID is assigned to the defect discovered for inspection material of an inspection meeting which uniquely identifies the defect for the inspection material. sLocation is a description of where the defect was discovered in the inspection material. sDescription is a description of the defect discovered. sType is the type of defect that includes Data, Documentation, Functionality, Interface, Logic, Input/Output, Human Factors, Maintainability, Performance, syntax, Standards, and Other. More types can be added. sClass is the class of defect that includes Missing, Wrong, Extra, or Unclear. More classes can be added. sSeverity is the severity of the defect that includes Minor or Major. More severity types can be added.

### Programming Package Diagrams for the Server

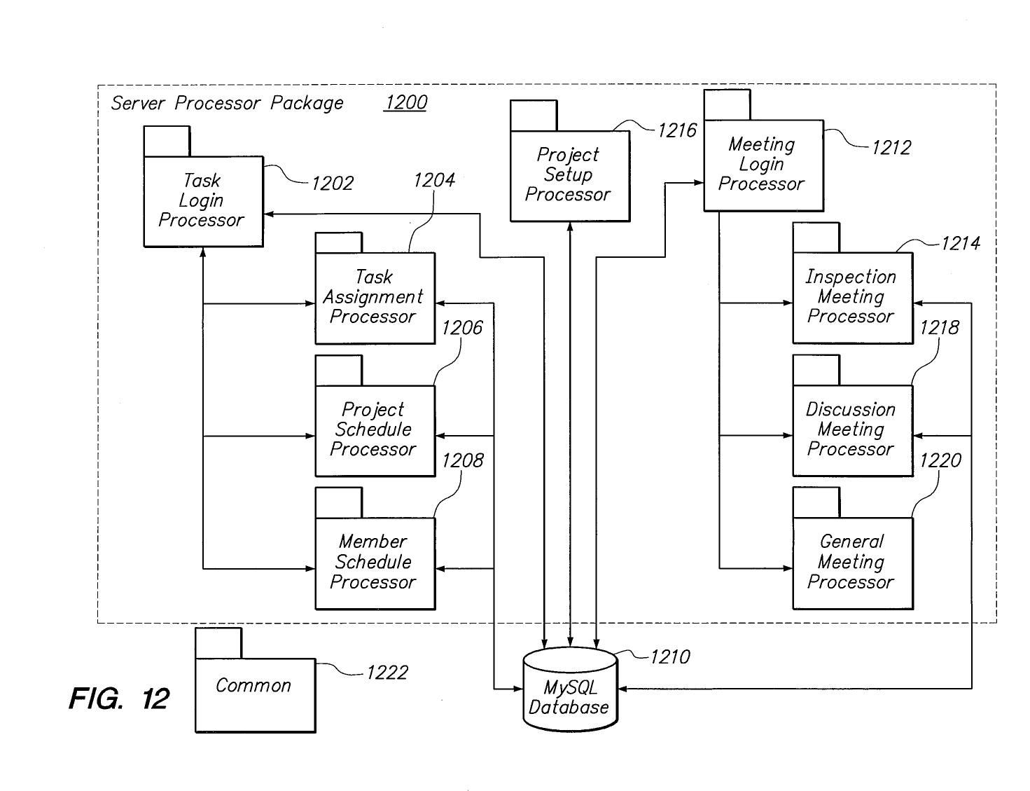

FIG. 12 is a diagram depicting a programming package diagram of the server processor 604 of FIG. 6. The server processor package 1200 contains seven packages, wherein each package corresponds to a Web page that is displayed to the user on the client processor 602 and through which the information entered by the user is processed when the user completes the login, editor, meeting or project setup session.

The TaskLoginProcessor 1202 package provides the Web page to display the form (FIG. 4) that allows a project member to log in to one of the editors. When the member submits the form, the LoginProcessor 1202 package processes the information entered by the member to validate the information. If the information is valid and if the member has the appropriate access privilege, the LoginProcessor 1202 package redirects the system to one of the packages corresponding to the editors.

The TaskAssignmentProcessor 1204 package provides the Web page to display the task assignment editor 102 (FIG. 1A), which is used to add or modify the assignment of project tasks to project members. When the task assignment editor 102 is submitted, the TaskAssignmentProcessor 1204 package processes and stores the information from the task assignment editor 102 and creates the Web page for the latest task assignment.

The ProjectScheduleProcessor 1206 package provides the Web page to display the project schedule editor 202 (FIG. 2A), which is used to add or modify the schedule of project tasks. When the project schedule editor 202 is submitted, the ProjectScheduleProcessor 1206 package processes and stores the information from the project schedule editor 202 and creates the Web page for the latest project schedule.

The MemberScheduleProcessor 1208 package provides the Web page to display the member schedule editor 302 (FIG. 3A), which is used to add or modify the schedule of member tasks. When the member schedule editor 302 is submitted, the MemberScheduleProcessor 1208 package processes and stores the information from the member schedule editor 302 and creates the Web page for the latest member schedule.

The MeetingLoginProcessor 1212 package provides the Web page to display the form (FIGS. 18A-18C) that allows a project member to log in to an inspection meeting or other meeting forms. When the member submits the login form, the MeetingLoginProcessor 1212 package processes the information entered by the member to validate the information. If the information is valid and if the member has the appropriate access privilege, the MeetingLoginProcessor 1212 package redirects the system to the InspectionMeetingProcessor 1214 package. Packages for other types of meeting can be added to the server processor package. Other types of meeting include discussion meeting or general meeting. The MeetingLoginProcessor 1212 package can redirects the system to these other packages.

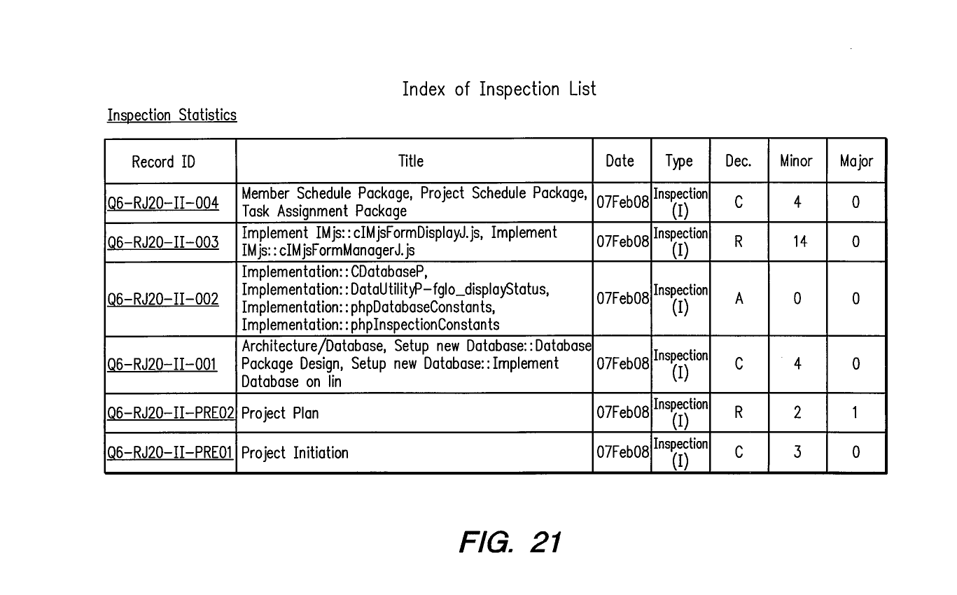

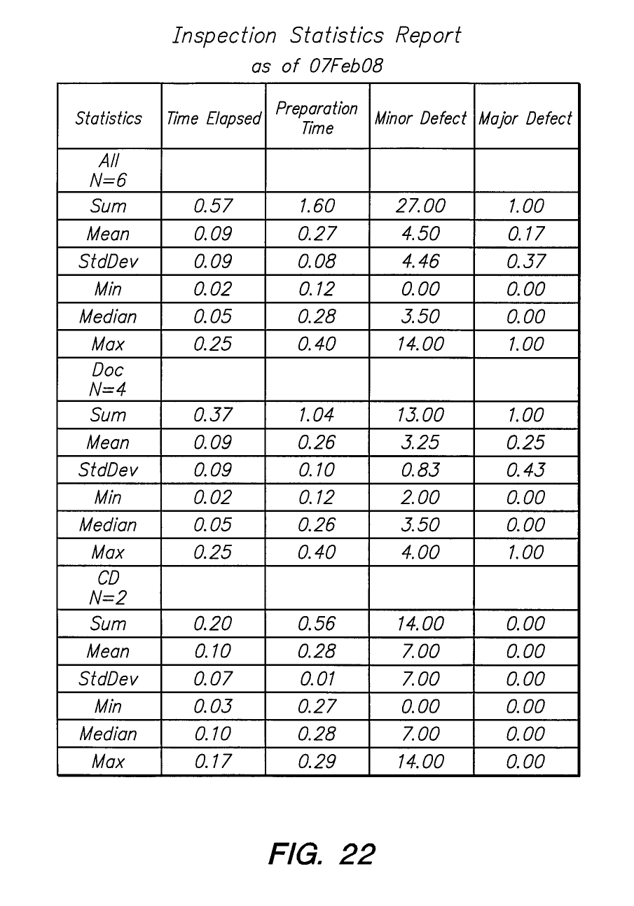

The InspectionMeetingProcessor 1214 package provides the Web page to display the inspection meeting form (FIG. 19), which is used for entering information pertaining to an inspection meeting. When the inspection meeting form is submitted, the InspectionMeetingProcessor 1214 package processes and stores the inspection meeting data from the inspection meeting form into the database 1210. The InspectionMeetingProcessor 1214 package also generates the inspection meeting document (FIG. 20), the inspection index document (FIG. 21) and the inspection statistics report (FIG. 22).

The ProjectSetupProcessor 1216 package provides the Web page to display the new project setup form (FIG. 39), which is used for entering information pertaining to a new project. When the new project setup form is submitted, the ProjectSetupProcesor 1216 package processes and stores the new project data from the new project setup form into the database 1210. The ProjectSetupProcessor 1216 package will set up the website for the new project.

The DiscussionMeetingProcessor 1218 package provides the Web page to display the discussion meeting form (FIG. 24), which is used for entering information pertaining to a discussion meeting. When the discussion meeting form is submitted, the DiscussionMeetingProcessor package generates the discussion meeting document (FIG. 25) and the discussion index document (FIG. 26).

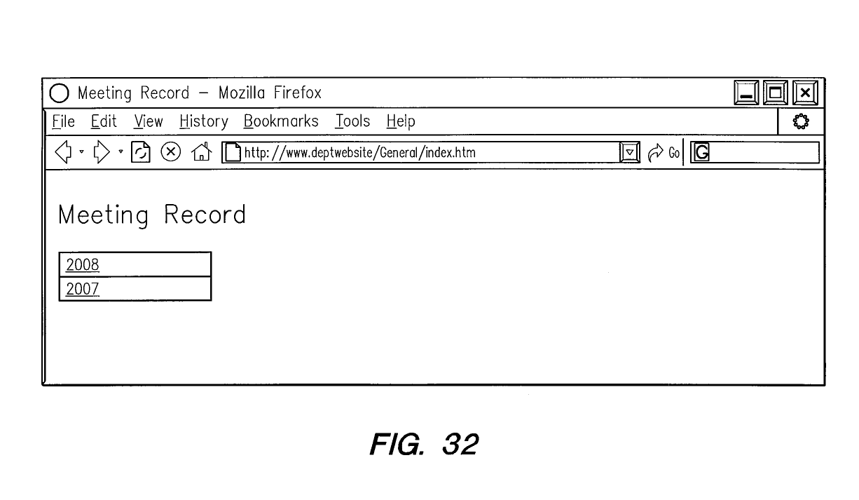

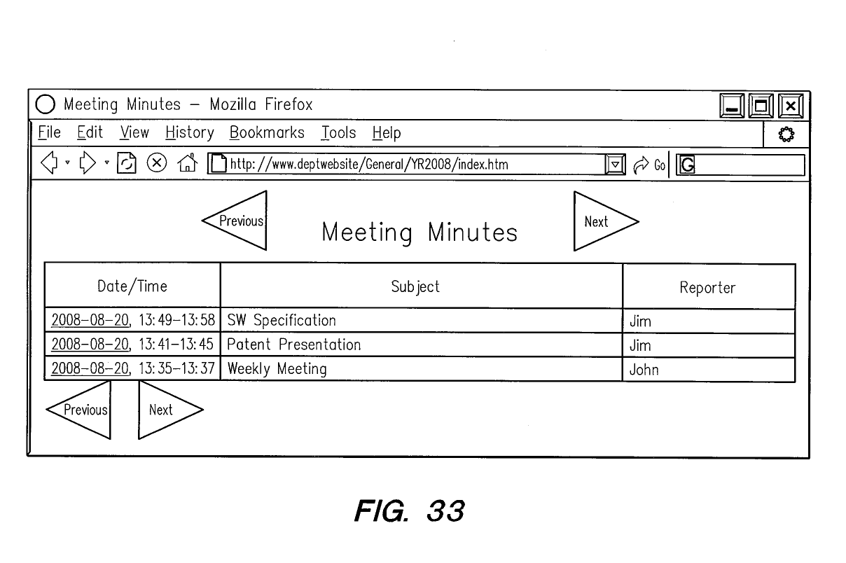

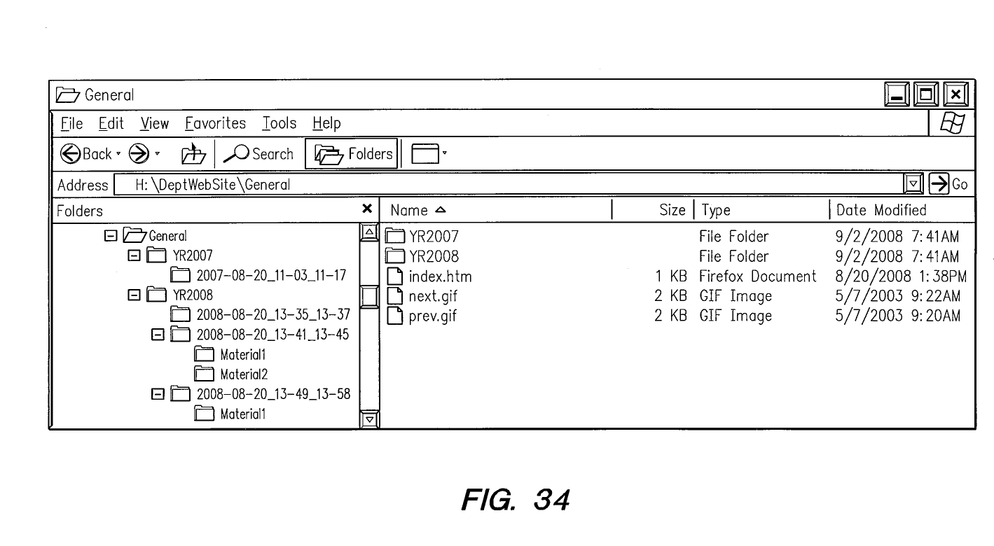

The GeneralMeetingProcessor 1220 package provides the Web page to display the general meeting form (FIG. 30), which is used for entering information pertaining to a general meeting. When the general meeting form is submitted, the DiscussionMeetingProcessor package generates the general meeting document (FIG. 31), the general current year index document (FIG. 33), and the general year index document (FIG. 32).

The Common 1222 package includes utilities, constraints and classes that are used by the other packages.

Except for the redirection of the TaskLoginProcessor 1202 package to the editor packages and the redirection of the MeetingLoginProcessor 1212 package to the InspectionMeetingProcessor 1214 package or other meeting type packages, the processor packages are independent of each other and, generally, there is no interaction between the editor packages or meeting packages. Each of the processor packages 1202-1218 interacts with a database 1210 (e.g., databases 506, 536 of FIG. 5) to obtain, add, or update information. The Login Processors 1202 and 1212 packages access the database 1210 to obtain project information to display in the login form and determine if the member has access privileges to the editor or meeting form. Each of the other processor packages 1204-1208 and 1214-1218 accesses the database 1210 to obtain task or inspection or discussion information to display in the corresponding editors or meeting forms and in the corresponding Web page it generates, and to add or update corresponding task or inspection or discussion information. The project setup processor 1216 package accesses the database 1210 to obtain project and project member information to display in the project setup form and to setup the project website for the new project. For a non-limiting example, the database 1210 may be implemented using MySQL; however, the database 1210 is not limited to implementation using MySQL.

According to an embodiment, each of the processor 1204-1220 packages comprises PHP script files, JavaScript files, and HTML files. The PHP script files obtain project, task, and inspection information from the database 1210 and generate the JavaScript that displays the editor, meeting form, or project setup form on the client processor 602 (FIG. 6). This allows the PHP script to interface with the JavaScript. JavaScript will create the editor, meeting form, or project setup form web page and manage all the interactions between the web page and a project member. When data from an editor or a form is submitted, the PHP script files process the data add or update the data in the database 1210, and create the Web page corresponding to the editor or form.

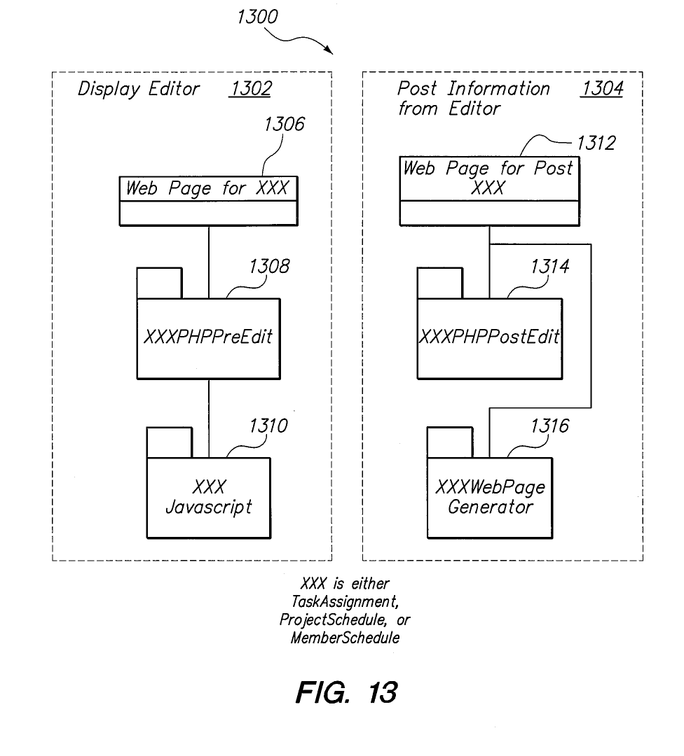

FIG. 13 is a diagram depicting a programming package diagram of the processor 1204-1208 and 1212 packages. According to an embodiment, the TaskAssignmentProcessor 1204, ProjectScheduleProcessor 1206, MemberScheduleProcessor 1208, and InspectionMeetingProcessor 1214 packages all use the package diagram depicted in FIG. 13. The package is divided into two major parts, the display editor/form 1302 being responsible for the display and management of the editor/form and the post information from editor/form 1304 being responsible for posting information in the editor/form and generating the Web page.

The Web Page for XXX 1306 (where “XXX” refers to either TaskAssignment, ProjectSchedule, MemberSchedule, or InspectionMeeting) integrates two packages to display the editor/form. The Web page 1306 includes all the PHP script files of a XXXPHPPreZZZ 1308 package and all the javascript files of a XXXJavaScript 1310 package to display and manage the editor/form. Note that if ZZZ is Edit (for editor), then XXX is either TaskAssignment, ProjectSchedule or MemberSchedule and if ZZZ is Form, then XXX is InspectionMeeting. All the PHP script files are processed on the Web server (e.g., Web server 507, 530 of FIG. 5) to obtain the task or inspection information from the database, and generate the Javascript that will interface with the XXXJavaScript 1310 package. All the Javascript is executed in the Web browser of the client processor 602 (FIG. 6) to provide for the initial display of the editor/form. All the JavaScript files are passed to the Web browser of the client processor 602 to manage the editor/form, i.e., to handle all corresponding events.

The Web Page for PostXXX 1312 integrates two packages that post the information and generate the Web page. The Web Page for PostXXX 1312 includes all the PHP script files of XXXPHPPostZZZ 1314 package to post the information from the editor/form and all the PHP script files of XXXWebPageGenerator 1316 package to create the Web page. The XXXPHPPostZZZ 1314 package obtains all the task or inspection information from the editor/form and adds or updates the task or inspection information in the database. The XXXWebPageGenerator 1316 package obtains task or inspection information from the database to generate the appropriate Web page.

Each of the packages of FIG. 13 provides a class that provides the interface for the package and manages the classes within the package. This allows the design within the package to be easily changed without affecting the other packages. The CDataBaseP class (not shown) allows access to any database including the three databases of FIGS. 9 through 11.

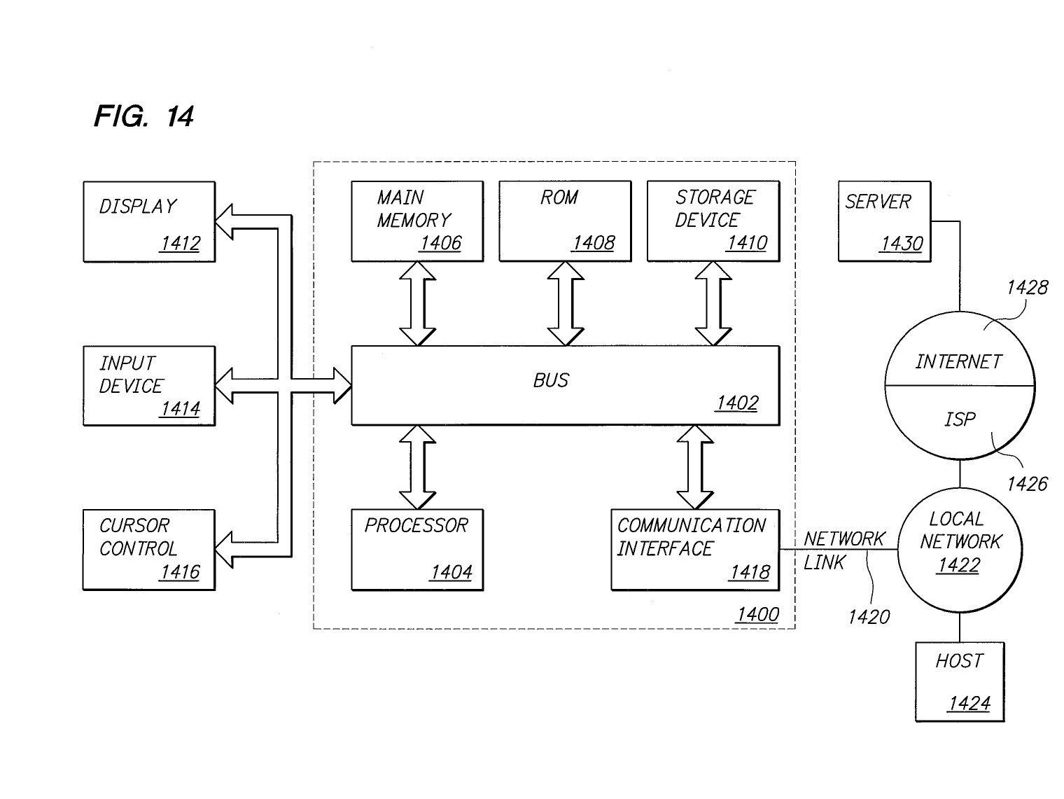

FIG. 14 is a block diagram that depicts an example computer system 1400 upon which embodiments of the invention may be implemented. Computer system 1400 includes a bus 1402 or other communication mechanism for communicating information, and a processor 1404 coupled with bus 1402 for processing information. Computer system 1400 also includes a main memory 1406, such as a random access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Computer system 1400 further includes a read only memory (ROM) 1408 or other static storage device coupled to bus 1402 for storing static information and instructions for processor 1404. A storage device 1410, such as a magnetic disk or optical disk, is provided and coupled to bus 1402 for storing information and instructions.

Computer system 1400 may be coupled via bus 1402 to a display 1412, such as a LCD monitor, for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane.

The invention is related to the use of computer system 1400 for implementing the techniques described herein. According to one embodiment of the invention, those techniques are performed by computer system 1400 in response to processor 1404 executing one or more sequences of one or more instructions contained in main memory 1406. Such instructions may be read into main memory 1406 from another computer-readable medium, such as storage device 1410. Execution of the sequences of instructions contained in main memory 1406 causes processor 1404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operation in a specific manner. In an embodiment implemented using computer system 1400, various computer-readable media are involved, for example, in providing instructions to processor 1404 for execution. Such a medium may take many forms, including but not limited to, non-volatile media and volatile media. Non-volatile media includes, for example, optical or magnetic disks, such as storage device 1410. Volatile media includes dynamic memory, such as main memory 1406. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 1404 for execution. For example, the instructions may initially be carried on a magnetic disk of a remote computer. The remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infra-red signal and appropriate circuitry can place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the world wide packet data communication network now commonly referred to as the “Internet” 1428. Local network 1422 and Internet 1428 both use electrical, electromagnetic or optical signals that carry digital data streams.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418. The received code may be executed by processor 1404 as it is received, and/or stored in storage device 1410, or other non-volatile storage for later execution.

FIGS. 15A-15D depict example entries in the Level1MemberTask, Level2MemberTask, Level3MemberTask, and Level4MemberTask tables of the schedule database depicted in FIG. 9. The entries correspond to project “J20” for the members having labels “AF” and “TM”. By querying the tasks in the database by order of descending nDateState, the task are grouped in order of completed tasks, started tasks, planned tasks, planned started-only tasks, and unscheduled tasks. By including more ordering restrictions, each group of tasks may be further ordered. The entries depicted in FIG. 15A are ordered based on ascending order of sMemberLabel and descending order of nDateState to see the grouping of task by members. The entries depicted in FIGS. 15B, 15C and 15D are ordered in descending order based upon the value of nDateState.

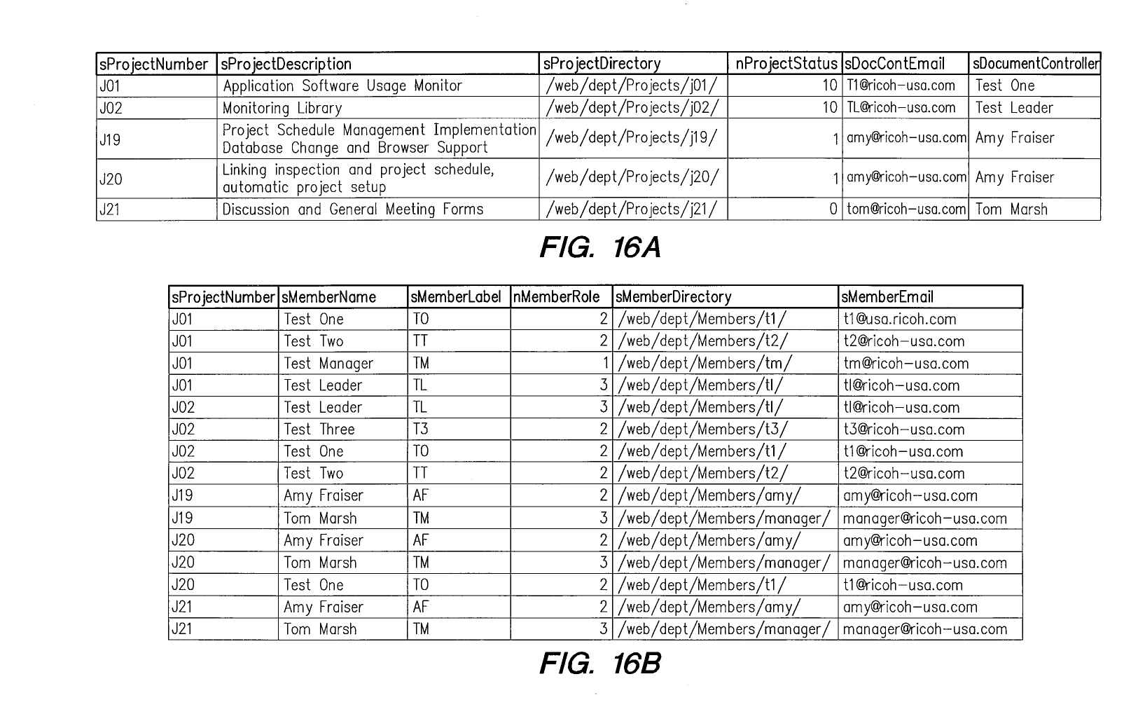

FIGS. 16A and 16B depict example entries in the ProjectInformation and MemberInformation tables of the ProjectTeam database depicted in FIG. 10. The tables depict the project information and member information for five projects. Projects J01 and J02 have been completed. Projects J19 and J20 have been started but not completed. Project J21 has not yet been started. Status is indicated by nProjectStatus in FIG. 16A.

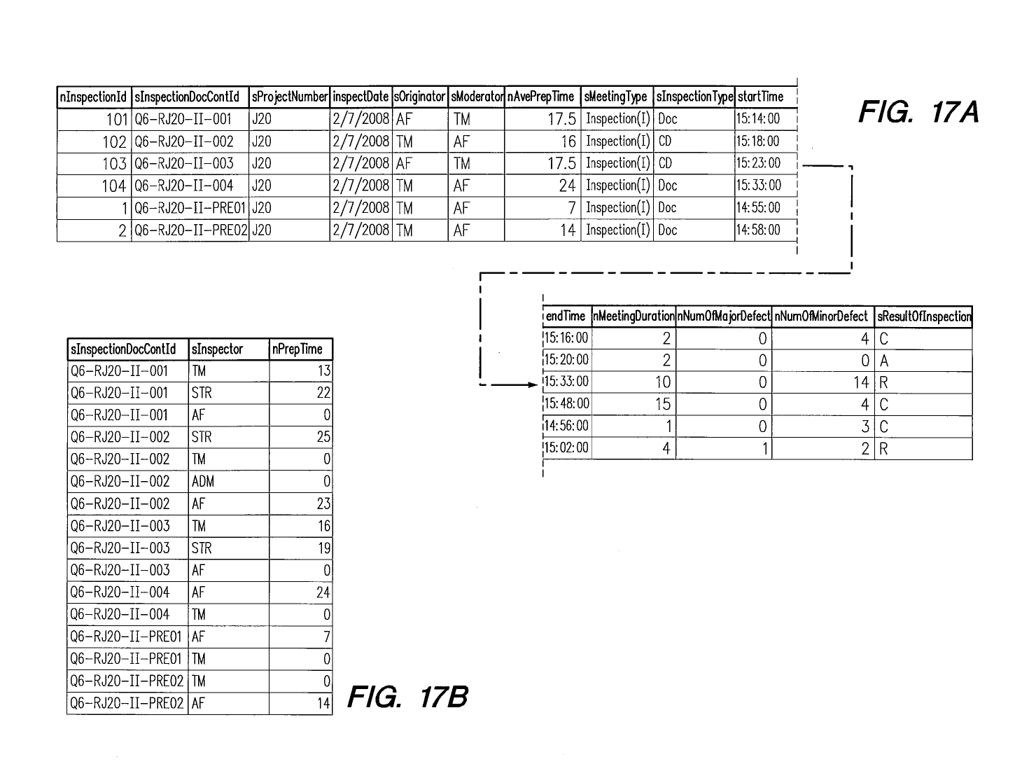

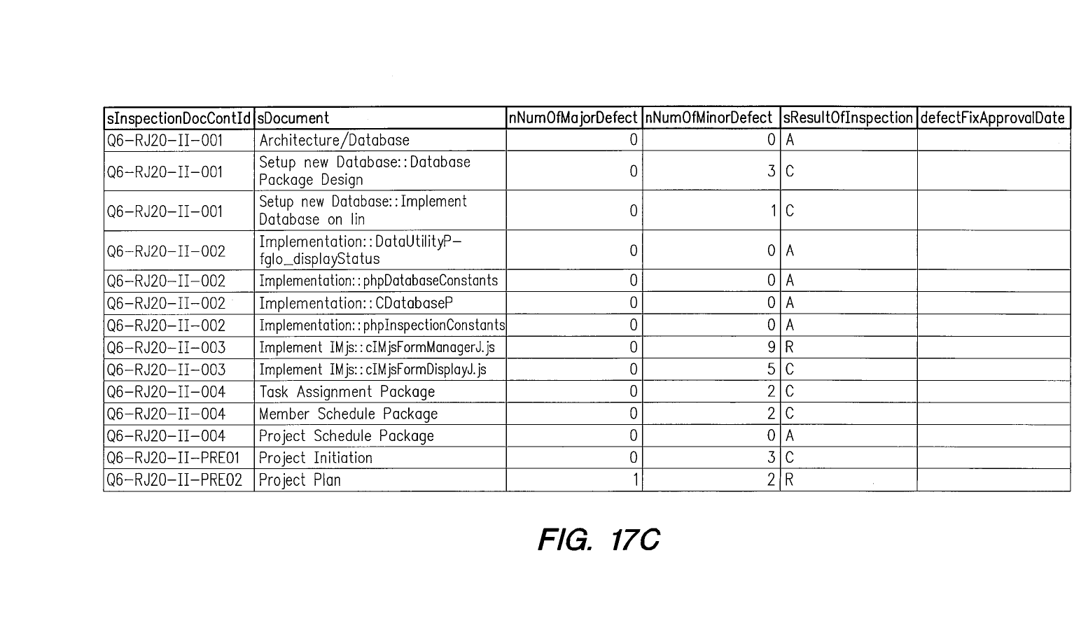

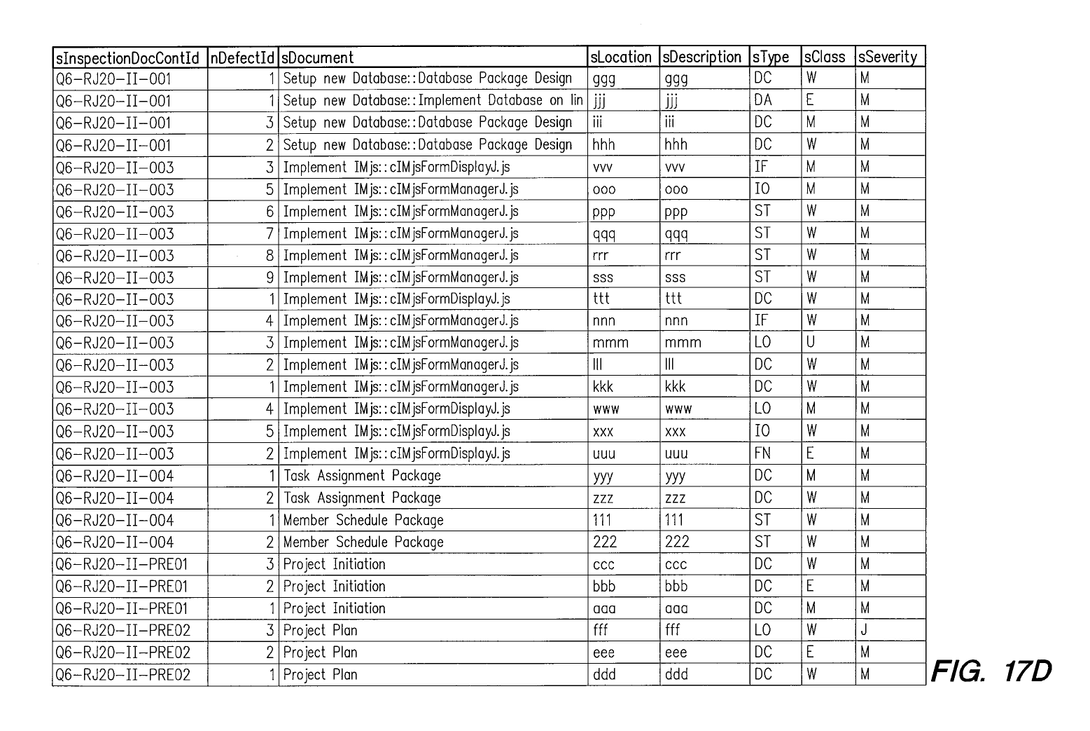

FIGS. 17A through 17D depict sample entries in InspectionInformation, InspectorList, DocumentList, and DefectList tables of the inspection database depicted in FIG. 11. The table depicts only inspection meetings that have taken place during project J20. Two inspections were assigned an nInspectionId value of 1 and 2 to indicate that the inspections occurred prior to the start of the project. The corresponding nInspectionDocContIds contain “PRE01” and “PRE02” respectively to indicate that the inspections occurred prior to the start of the project. The nInspectionDocContIds are used for the filename of the inspection meeting web page to uniquely identify the file for the inspection. Once the project has started, the value of nInspectionId starts at 101 and is incremented by 1 for each inspection. The corresponding nInspectionDocContIds contain a number starting at 001 and is incremented by 1 for each inspection.

FIGS. 18A through 18C depict example meeting login web pages for logging into one of the meeting web pages (Inspection Meeting for FIG. 18A, Discussion Meeting for FIG. 18B, and General Meeting for FIG. 18C). The information that needs to be entered for a meeting depends upon the meeting type selected. If the user selects “Inspection Meeting”, the user selects the project number and the originator (a member of the project) of the inspection material. If the user selects “Discussion Meeting”, the user selects the project number. If the user selects “General Meeting”, the user does not need to enter any information. The information from which the user selects is obtained from the database (project numbers of uncompleted projects and project members corresponding to each project). The information the user can select depends upon the meeting type.

FIG. 19 depicts an example Inspection Meeting Form. Dropdown items are taken from the database 1210. The moderator or recorder enters information related to the inspection (within the gray boxed area) such as inspection material to inspect, the inspectors, the inspector's preparation time, meeting type, and inspection type. By selecting on the Start Inspection Meeting button, the defect tables appear at the bottom of the form for each inspection material. As each inspection material is inspected, the moderator or recorder enters defect information as defects are discovered. Once the inspection meeting is finished, the moderator or recorder selects the Submit button and all the inspection information is passed to the server where the inspection information is added to the Inspection database and Web pages for the inspection meeting, inspection index, and inspection statistics are generated.

FIG. 20 depicts an example Inspection Meeting document generated after an inspection meeting session. The document includes all information related to the inspection such as date, time, and id number (nInspectionDocContId). nInspectionDocContId is used as the record control number of the inspection as well as the filename, q6-rj20-ii-004.htm, of the document.

FIG. 21 depicts an example Inspection Index document generated after an inspection meeting session. The index includes link to all the Inspection Meeting documents for a project (J20 is the project in this index). The index shows the results of the inspection along with the number of minor and major defect discovered. A link is also provided to the Inspection Statistics Report depicted in FIG. 22.

FIG. 22 depicts an example Inspection Statistic Report generated after an inspection meeting session. From all the data collected for the inspections of a project stored in the database, statistical data may be calculated for all the inspections after each inspection meeting session. Statistics are determined for the duration of the inspection meeting, the average preparation time spent by the inspectors, and the number of minor and major defects. The statistics of the inspections is further divided into the inspection type (all inspections-6, documents-4, and code-2).

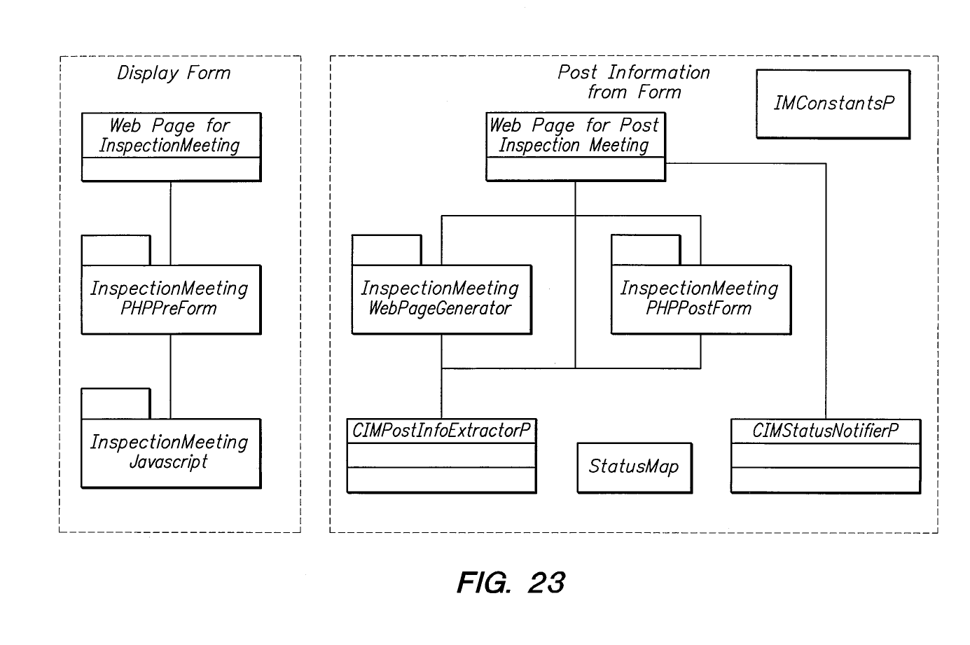

FIG. 23 is an example package diagram of the InspectionMeetingProcessor package. The Web Page for Inspection Meeting integrates two packages to display the inspection meeting form. The Web Page includes all the PHP script files of InspectionMeetingPHPPreForm package and all the JavaScript files of InspectionMeetingJavaScript package to display and manage the form. The PHP script files are processed on the Web server (e.g., Web server 507, 530 of FIG. 5) to obtain the inspection information from the database and generate the JavaScript that will interface with the InspectionMeetingJavaScript package. All the JavaScript is executed in the Web browser of the client processor 602 (FIG. 6) to provide for the initial display of the inspection meeting form. All the JavaScript files are passed to the Web browser of the client processor 602 to manage the form, i.e., to handle all corresponding events.

The Web Page for Post Inspection Meeting integrates two packages that add the inspection meeting information into the database and generate the inspection Web pages. The Web Page for Post Inspection Meeting includes all the PHP script files of InspectionMeetingPHPPostForm package to add all the inspection information in the form into the database and all the PHP script files of InspectionMeetingWebPageGenerator package to create the Web pages. The Web Page for Post Inspection Meeting also includes the classes CIMPostInfoExtractorP and CIMStatusNotifierP and data structure StatusMap. The class CIMPostInfoExtractorP provides access to information in the inspection meeting form. The InspectionMeetingPHPPostForm package uses CIMPostInfoExtractorP to obtain all the inspection information so that it can be added to the database. The InspectionMeetingWebPageGenerator package uses CIMPostInfoExtractorP to obtain all the inspection information so that it can be added to the inspection web pages. The data structure StatusMap is used to maintain the status of adding inspection information into the database and to generate and write out the inspection web pages to the project web site. The packages InspectionMeetingPHPPostForm and InspectionMeetingWebPageGenerator add the status to the StatusMap for the processes it performs in adding information to the database and generating the web pages. The class CIMStatusNotifierP is used to notify the document controller and/or system administrator if failure occurred in adding the inspection information to the database or generating the inspection web pages. The CIMStatusNotifierP class echoes to the client server and emails to the document controller and/or system administrator the status of the inspection meeting system and the web pages generated by the system so that the database can be correctly updated and/or the web pages can be created or updated. If the inspection meeting system was successful, the CIMStatusNotifierP class does not need to be used.

FIG. 24 depicts an example Discussion Meeting Form. The discussion meeting form allows project members and guests to discuss different project materials. Project materials may include documents such as project plans, project requirements, design documents, user interfaces, code conventions, document guidelines and devices. The discussion meeting allows members and guests to become familiar with the project materials and allows them to discover defects and suggest alternative solutions and/or improvements. Discussion meetings on a project material occur before the inspection meeting on the project material. The inspection meeting focuses on defects in the material. The recorder enters information into the discussion meeting form about the materials that are discussed, the type of discussion meeting, and the attendants at the meeting. Once the meeting starts by clicking on the Start Discussion Meeting, discussion tables are displayed at the bottom where the recorder can enter comments about the discussion materials. The comments include defects, alternative solutions, and improvements. The results of the discussion are set for each discussion material to determine what course of action needs to be taken for the material such as modifying the material for another discussion meeting or the material is ready for inspection. The discussion meeting session is completed when the Submit button is selected.

FIG. 25 depicts an example of the discussion form document. The header contains the document control number generated by a server program and the project number. Below the header is discussion session information obtained from the discussion meeting form, such as the date and time of the discussion, the recorder and attendants, and the list of discussion materials along with the originators. The list of discussion materials contains a link to the main file corresponding to the discussion material. Below the discussion session information is the discussion information about each discussion material obtained from the discussion meeting form, along with the results of the discussion for each material.

FIG. 26 depicts an example discussion index. The discussion index contains all the discussion meetings of a project with links to the discussion form documents and to the main files of each discussion material. The index contains the document control id which uniquely identifies the discussion meetings. Some of the document control ids contain the term “PRE” indicating that the discussion meeting occurred before the project started. The index contains information obtained from the discussion meeting form such as the date of the discussion and the discussion types.

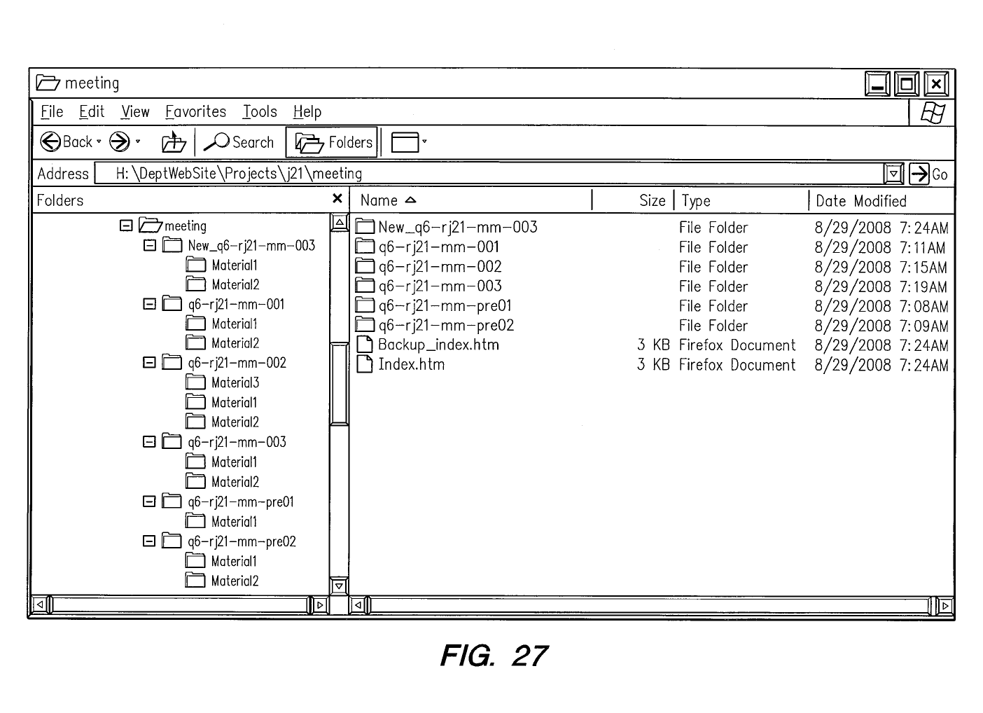

FIG. 27 depicts an example directory/file structure of the discussion meetings corresponding to the discussion index of FIG. 26. All the discussion web pages are placed under the directory meeting under the project directory j21. The discussion index is under the directory meeting that includes links to all the discussion form document web pages that exist in the directory corresponding to its document control number. There is a directory for each discussion meeting and the document control id is unique for each meeting so that the directory name will also be unique. The directory for a discussion meeting contains one or more material directory (Material1, Material2, etc) which contains the files for the discussion material. For each discussion meeting session, the index is updated with the current discussion meeting and a new directory is created that contains the discussion form document web page and the material files for the discussion material.

In this example, during the posting of the discussion meeting, an error occurred in generating the correct document control id that is used to uniquely identify the meeting. The web page for the discussion meeting is created under the directory with a directory name corresponding to the document control id. Since the directory already exists (q6-rj21-mm-003), a directory prefixed with New_is created for the discussion meeting. This prevents the meeting corresponding to the original q6-rj21-mm-003 from being overwritten. Also, backup of index.htm (Backup_index,htm) is always created before generating the new index.htm file. If an error occurs in generating the discussion meeting web page, the system emails the document controller of the error. The email may include information necessary to correct the web pages. The document controller can use the Backup_index.htm and the New_directory to correctly restore the meeting web pages.

FIG. 28 depicts an example directory/file structure of one of the material directories in the discussion meeting of FIG. 27. The discussion meeting has the document control id of Q6-RJ21-MM-PRE01. The file name for the discussion form document corresponds to the id so that the filename is q6_r21_mm_pre01.htm. The discussion meeting involves the discussion of the architecture. The main file associated with the discussion material is architecture.htm. The discussion material contains supplemental files, XXX.gif, which are all figures that are used in architecture.htm. The discussion meeting form allows the recorder to enter the main file and supplemental files and when the form is submitted, the files are passed to the web server and the web server creates the directories and stores the files in the appropriate directories so that the discussion form document and discussion index can link to them.

FIG. 29 depicts an example package diagram of the DiscussionMeetingProcessor package. The Web Page for Discussion Meeting integrates a package to display the discussion meeting form as depicted in FIG. 24. The Web Page includes PHP script and all the JavaScript files of the DiscussionMeetingJavaScript package to display and manage the form. All the PHP scripts are processed on the Web server (e.g., Web server 507, 530 of FIG. 5) to obtain the project information (project member names to display in the recorder and attendant select element) from the database and generate the JavaScript that interfaces with the DiscussionMeetingJavaScript package. All the JavaScript is executed in the Web browser of the client processor 602 (FIG. 6) to provide for the initial display of the discussion meeting form. All the JavaScript files are passed to the Web browser of the client processor 602 to manage the form, i.e., to handle all corresponding events. The Web Page for a Post Discussion Meeting integrates a package to generate the discussion Web pages. The Web Page for a Post Discussion Meeting includes all the PHP script files of DiscussionMeetingWebPageGenerator package to create the Web pages.

FIG. 30 depicts an example General Meeting Form. The general meeting form allows project members and guests to discuss different topic relate or unrelated to a project. Topics may include meetings with other project teams to discuss their projects or presentations by sources outside of the company. The reporter enters general session information into the general meeting form about the subject of the meeting, the reporter, and the attendants. The date and time can be entered if the meeting has already occurred at an earlier time. Otherwise, the form will automatically enter the date and times for the meeting. The reporter can add material in the general meeting form if there were materials involved in the meeting. Materials may include documents for a description of other project teams' project or a power point presentation made by the outside source. Below the general session information are general tables where comments/remarks can be made about the subjects and/or materials. The general table contains a text box for the main topic of discussion and rows of text box in which rows can be broken down into sub rows. This allows the comments/remarks to be organized. More general tables can be added to the general meeting form by clicking on the “Add New Table” and more rows or detail rows can be added to a general table by selecting the row where the row or detail rows are to be added and clicking on the “Add Row” or “Add Detail” buttons. The buttons on the right side of the general table are buttons that scroll along the window of the browser. If more tables are added to the form and the entire form cannot fit in the window, the buttons will always be displayed in the window even when scrolling up and down the form. This allows continued access to the buttons to manipulate the tables and to submit the form. The tables allow for the organization of the comments in the general form document web page that is generated when the general meeting form is submitted by clicking the “Submit” button.

FIG. 31 depicts an example of the general form document. The header general session information obtained from the general meeting form such as the date and time of the discussion, the reporter and attendants. Below the header is the general information about topic and rows of comments/remarks obtained from the general meeting form. The rows of the general table in the general meeting form are organized into lists in the general form document.

FIG. 32 depicts an example of the general yearly index. The index contains links to all the indexes corresponding to the year.

FIG. 33 depicts an example of the general index for the year 2008. Each row of the index corresponds to a general meeting and provides a link to the general form document for the meeting. The information such as the date, time, subject, and reporter are obtained from the general meeting form. The index also has links to the index of the previous year and next year.

FIG. 34 depicts the directory/file structure of the general meetings that correspond to the yearly index of FIG. 33. All the general web pages are placed under the directory General. The yearly index contains links to the index for the general meetings in 2007 and 2008 which are located under the directory YR2007 and YR2008 respectively. Each of the general meeting documents are located under a directory corresponding to the date and times of the meeting.

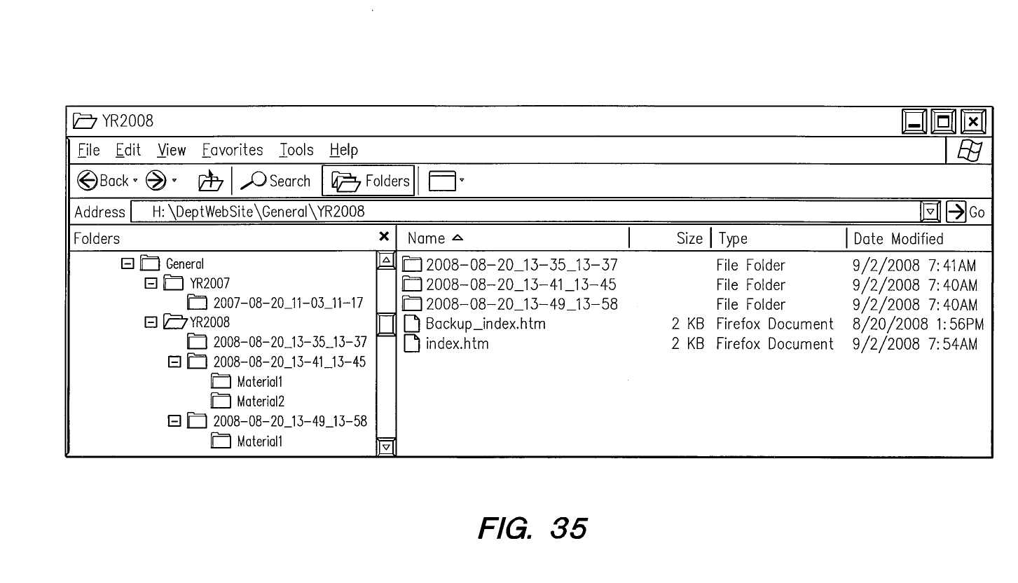

FIG. 35 depicts the directory/file structure of the general meetings corresponding to the index of year 2008 of FIG. 33. All the general web pages for the year are placed under the directory YR2008. The index contains links to all the general meeting documents for that year.

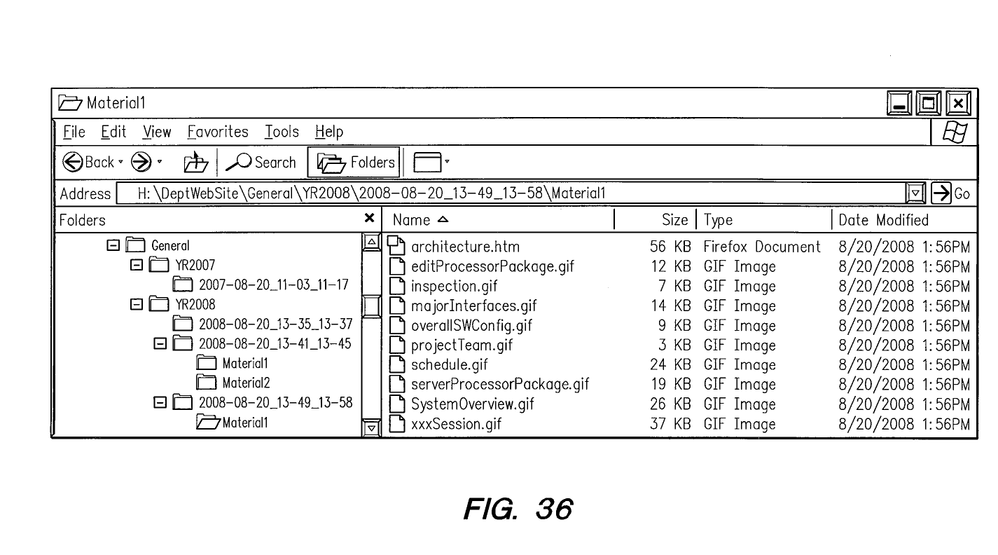

FIG. 36 depicts an example directory/file structure of one of the material directories in the general meeting. The file name for the general form document corresponds to the date and times so that the filename is 2008-08-20_{—}13-49_{—}13-58.htm. The general meeting involves the discussion of the architecture. The main file associated with the material is architecture.htm. The material contains supplemental files, XXX.gif, which are all figures that are used in architecture.htm. The meeting form allows the reporter to enter the main file and supplemental files and when the form is submitted, the files are passed to the web server and the web server creates the directories and stores the files in the appropriate directories so that the general form document can link to them.

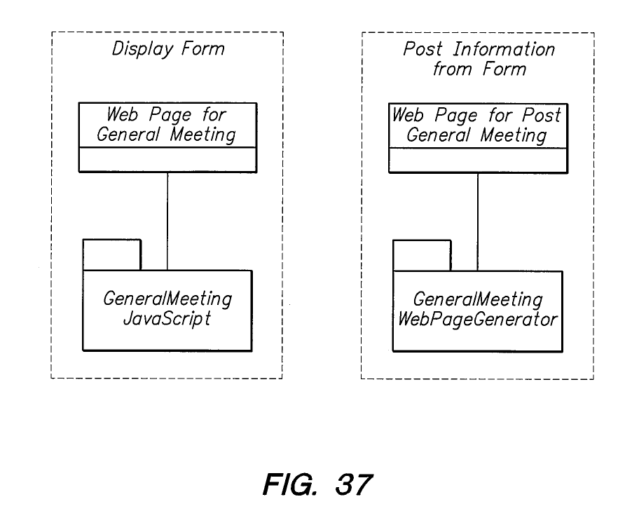

FIG. 37 is the package diagram of the GeneralMeetingProcessor package. The Web Page for General Meeting integrates a package to display the general meeting form as depicted in FIG. 30. The Web Page includes all the JavaScript files of GeneralMeetingJavaScript package to display and manage the form. All the JavaScript is executed in the Web browser of the client processor 602 (FIG. 6) to provide for the initial display of the general meeting form. All the JavaScript files are passed to the Web browser of the client processor 602 to manage the form, i.e., to handle all corresponding events. The Web Page for Post General Meeting integrates a package to generate the general Web pages. The Web Page for Post General Meeting includes all the PHP script files of GeneralMeetingWebPageGenerator package to create the Web pages.

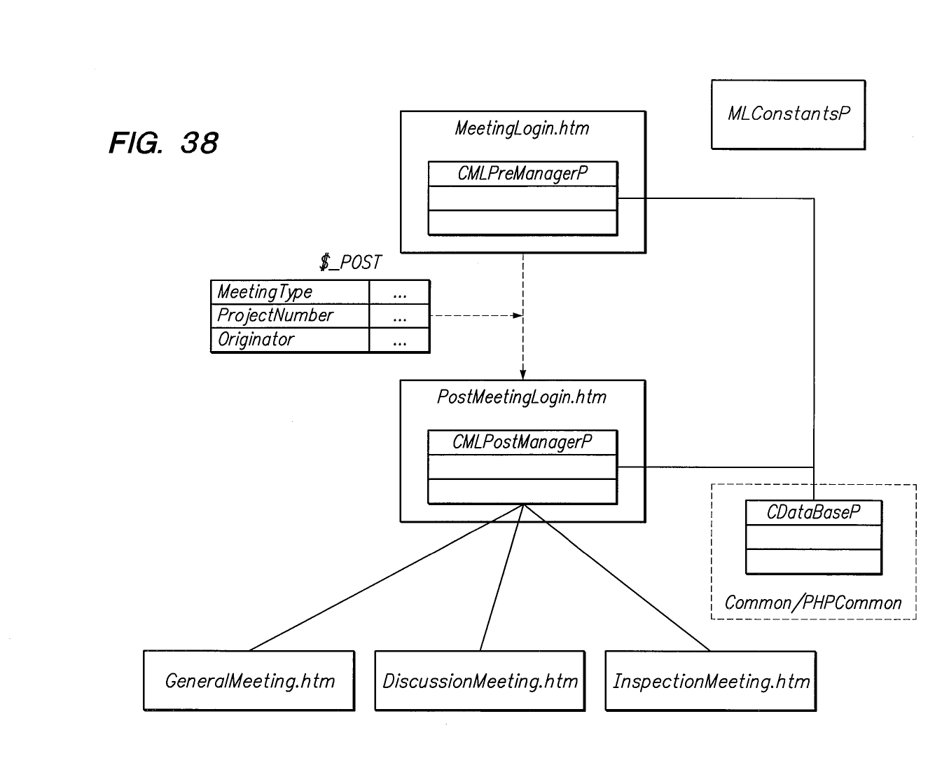

FIG. 38 depicts an example class diagram of the MeetingLoginProcessor package. The Web Page MeetingLogin.htm displays the meeting login form as shown in FIGS. 18A to 18C. The Web Page includes a class CMLPreManagerP that obtains project information from the database (uncompleted projects and project members corresponding to the projects) and all the JavaScript to display and manage the form. All the PHP scripts are processed on the Web server (e.g., Web server 507, 530 of FIG. 5) to obtain the project information from the database generate the JavaScript that will interface with the JavaScript in the web page. All the JavaScript is executed in the Web browser of the client processor 602 (FIG. 6) to provide for the initial display of the meeting login form. All the JavaScript files are passed to the Web browser of the client processor 602 to manage the form, i.e., to handle all corresponding events. The Web Page PostMeetingLogin.htm obtains the information entered in the Web page MeetingLogin.htm to determine which meeting form to return to the web browser. From the information entered, the web server returns the web page corresponding to the selected meeting.

FIG. 39 depicts the New Project Setup Form that allows a user to setup the new project. Initially the form will contain the name for the new project and the member information of all members of the previous project (assuming most if not all the project members remain the same). This information corresponds to the latest project in the ProjectTeam database. The user must enter in the directory and title for the new project. The user can update member information and add new members. When the user submits the form, the project and member information is updated in the ProjectTeam database. Directories and files are created for the project that allow web access to the various documents in the project such as project schedule, task assignments, inspection meetings, change reports, members home page, and member's schedule. The form automates the process of creating and setting up the directories and files for the new project. Directories and files must be set with the appropriate owner, group, and permissions. With incorrect owner, group, or permissions, the task editors and inspection meeting forms may not be able to generate the appropriate web page. Automating the project setup process avoid the problems encountered when manually setting up the project website by the person responsible for maintaining the website such as not setting the appropriate permissions to the directories. When the appropriate permissions are not set for a directory, web pages generated by the task editors or meeting forms cannot create the web pages for the editors or forms.

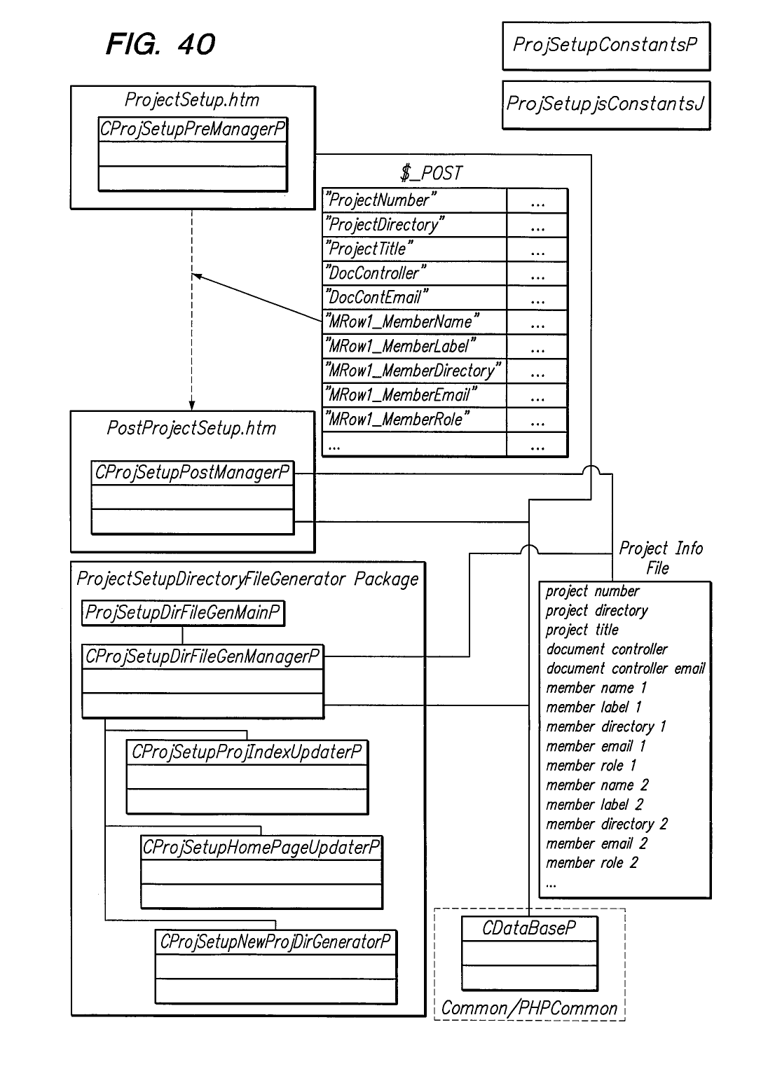

FIG. 40 depicts example components of the ProjectSetupProcessor package depicted in FIG. 12. ProjectSetup.htm is the web page that will display the project setup form as depicted in FIG. 39. This web page uses the class CProjSetupPreManagerP to obtain information for the initial display of the form including the latest name of the project and the member information for the previous project. The form is posted to web page PostProjectSetup.htm when the form is submitted. $_POST is the information that is passed from ProjectSetup.htm to PostProjectSetup.htm. PostProjectSetup.htm uses the class CProjSetupPostManagerP to write the information in the project setup form to a project info file and to add the new project information to the ProjectTeam database. The ProjectSetupDirectoryFileGenerator package creates the directories and files for the new projects. ProjSetupDirFileGenMainP contains the main program that initiates the creation of the directories and files. The CProjSetupDirFileGenManagerP class manages the classes in the package that creates the various components of the new project setup. The class CProjSetupProjIndexUpdaterP updates the indexes related to the new project. The class CProjSetupHomePageUpdaterP updates the home page files to link to the new project. The class CProjSetupNewProjDirGeneratorP creates the project directories and files for the new project and creates a directory in the members' home page corresponding to the new project. The class updates and creates directories and files to provide access to the web pages of various documents associated with the new project. CProjSetupPreManagerP, CProjSetupPostManagerP, and CProjSetupDirFIleGenManagerP use the CDataBaseP classes that access the ProjectTeam database.

In some situations, the existence of a large number of project tasks can cause delays for members when logging into the member schedule editor. Delays may also occur when members post information in the member schedule editor. The delays are attributable to required interactions with the database. For example, when a member logs into the member schedule editor, queries are made against the database to obtain uncompleted project tasks for the member to be displayed in the member schedule editor. Furthermore, when information from the member schedule editor is posted, queries are made to add or update task schedules in the database and to obtain task information to generate the member schedule web page.

According to one embodiment of the invention, the member schedule editor and the task assignment editor is configured to use cache files to improve system performance. When information is submitted in the task assignment editor, the uncompleted tasks that will be displayed in the member's schedule editor are stored in one or more cache files for each project member. The generation of the cache files containing information from the database queries is performed in the background so as not to impact the response time of the web page showing the completion of the task assignment editor session. When the member logs onto the member schedule editor, the one or more cache files are accessed to obtain the task information to display in the editor rather than accessing the database. Accessing the cache file is much faster than executing the database queries.

Similarly, when information is submitted in the member schedule editor, the uncompleted tasks that will be displayed in the next member's schedule editor session are stored in one or more cache files for the project member. Also, the web page for the member schedule is generated and saved. The cache file and web page for the member schedule are generated in the background so as to not impact the response time of the web page showing the completion of the member schedule editor session.

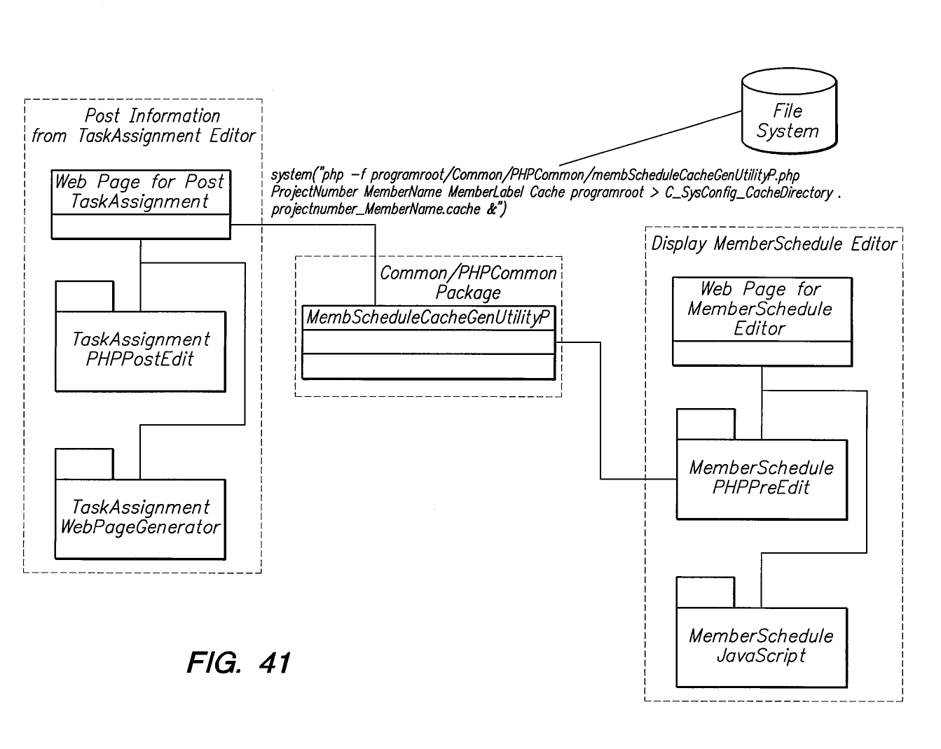

FIG. 41 is a package diagram that depicts the server package providing more detail for generating one or more cache files used for the member schedule editor. The posting or submitting of information from the task assignment editor triggers the generation of the cache file. The web page for posting the task assignment editor uses the utility MembScheduleCacheGenUtilityP in the Common package to generate the cache file. The utility in turn uses the package of the member schedule editor, MemberSchedulePHPPreEdit, to generate the cache containing the task information. MemberSchedulePHPPreEdit executes the database queries to obtain task information that is displayed in the member schedule editor. The web page for posting the information from the task assignment editor calls the system( ) function with parameters passed in to execute the function that generates the cache files in the background. This allows the rest of the web page for posting the editor to finish processing without waiting for the system( ) function to complete. There is no delay in displaying the message indicating the completion of the task assignment session while generating the cache files for all project members. The system call php -f programroot/Common/PHPCommon/membScheduleCacheGenUtilityP.php ProjectNumber MemberName MemberLabel Cache programroot>C_SysConfig_CacheDirectory.projectnumber_MemberName.cache & requires parameters to function properly. The programroot is the absolute directory path to the source code of the project management system. programroot/Common/PHPCommon/membScheduleCacheGenUtilityP.php is the PHP script that is executed that will generate the cache. ProjectNumber MemberName MemberLabel Cache programroot are parameters passed into the PHP script. The ProjectNumber corresponds to the project number of the project in which tasks are assigned in the task assignment session. The MemberName and MemberLabel correspond to the name and label (usually the initials of the member) of a project member. Cache indicates that a cache file is to be generated. C_SysConfig_CacheDirectory is a constant that represents the absolute directory path where the cache files are located. The redirection of the script “>” will echo the task information to the cache file projectnumber_MemberName.cache. The symbol “&” at the end is to indicate to the PHP script is to be executed in the background. An example of the system call is php -f/ProjManageSystem/Common/PHPCommon/membScheduleCacheGenUtilityP.php J25 MaryAnn MA Cache/ProjManageSystem>/ProjManageSystem/Cache/j25_MaryAnn.cache &.

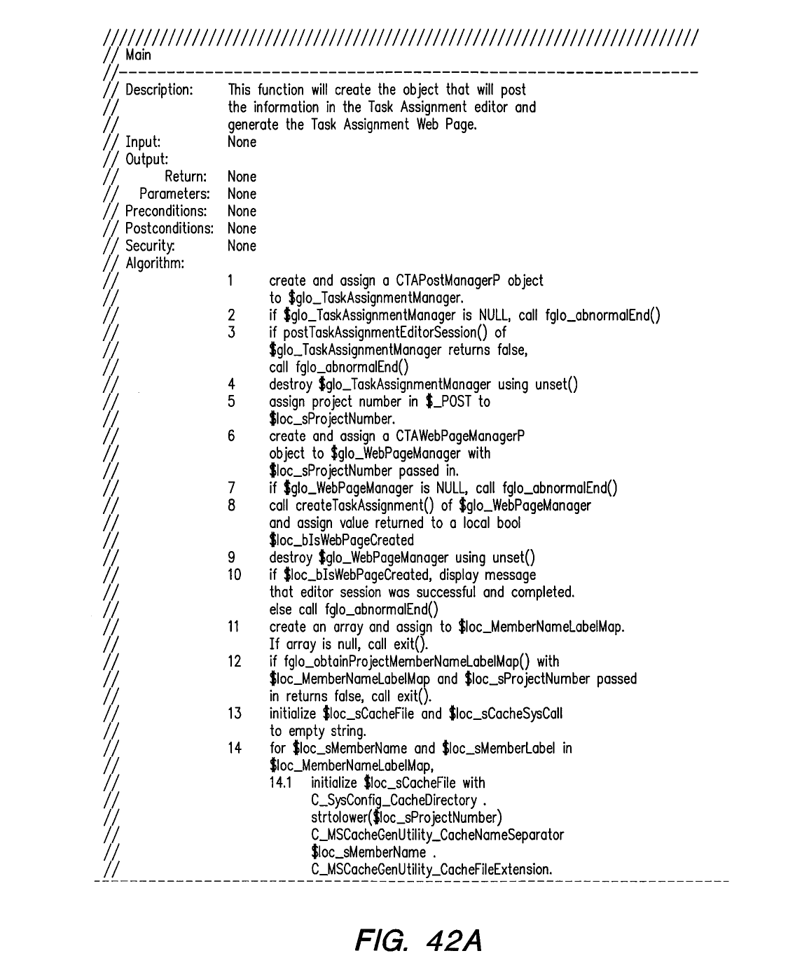

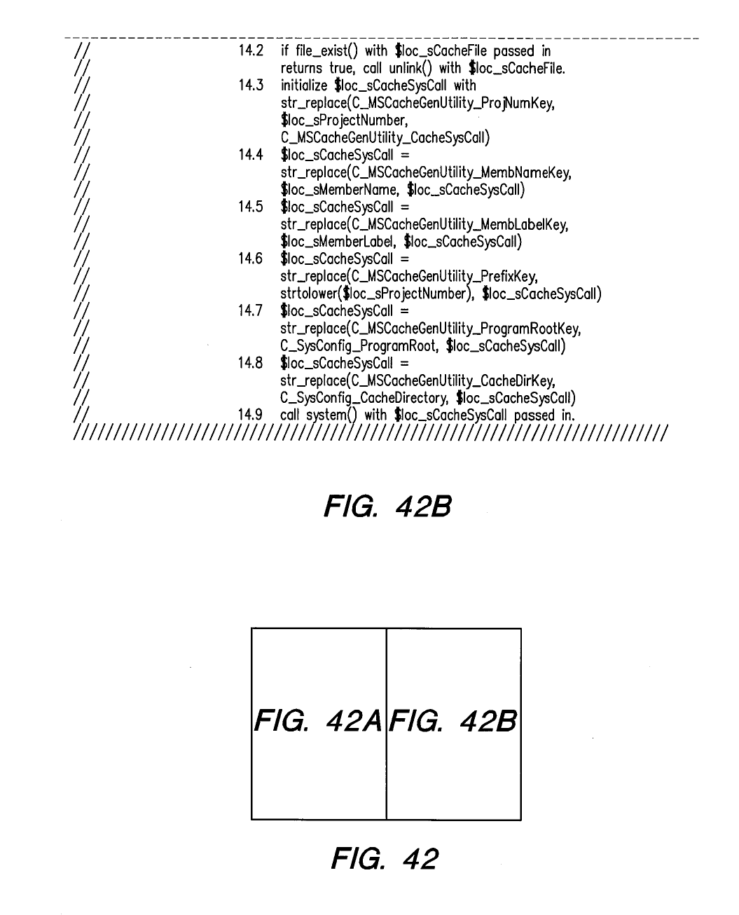

FIG. 42 depicts an example algorithm executed in the web page by the web server when posting information from the task assignment editor. Steps 1 through 4 add and update project task assignment information in the schedule database. Steps 5 through 10 generate the task assignment web page. Steps 11 through 14 generate the cache file for each project member. All the member information (member name and member label) is obtained for a project in step 12. Steps 14.1 through 14.9 is a loop to generate the cache file for each project member. Step 14.1 obtains the filename of the cache file for a project member from the member name and project number. In step 14.2, if the cache file exists (from a previous task assignment editor session or member schedule editor session), the old cache file is removed. In steps 14.3 to 14.8, the string for the system call php -f programroot/Common/PHPCommon/membScheduleCacheGenUtilityP.php ProjectNumber MemberName MemberLabel Cache programroot>C_SysConfig_CacheDirectory.projectnumber_MemberName.cache & is built by replacing ProjectNumber, MemberName, MemberLabel, programroot, and C_SysConfig_CacheDirectory with the appropriate values. After the string is built, it is executed in step 14.9 as input to system( ).

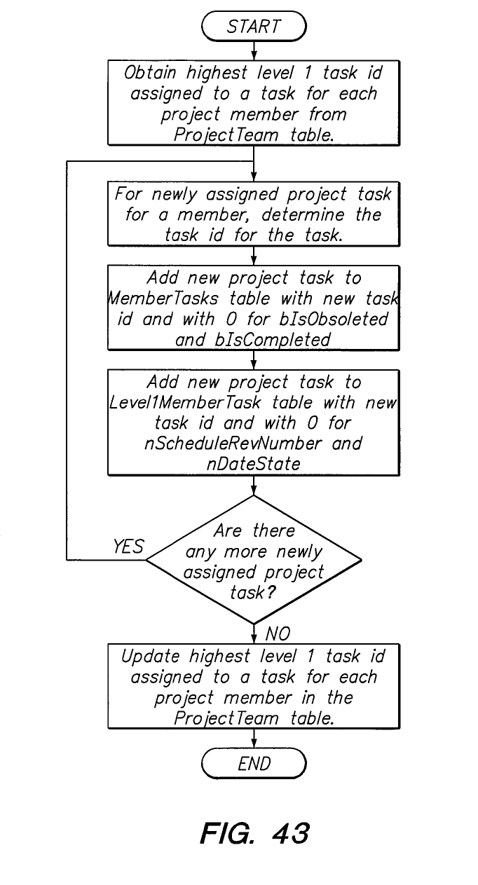

FIG. 43 is a flowchart that depicts information from the task assignment editor being posted and the project tasks being added to the schedule database. More specifically, a newly assigned project task is added. The task information is added to the appropriate tables of the database, which adds the project tasks to the member's schedule. The highest task id of a member is obtained from the ProjectTeam table so as to determine the next task id to assign to the newly assigned project task. As an example, the next task id is determined by adding 10 for a small project team or adding 100 for a large project team. Once the task id for the newly assigned project task is determined, the task is placed into the MemberTasks table with the task id and 0 for bIsObsoleted and bIsCompleted to indicate that the task is not deleted or completed. Then the task is placed into the Level1MemberTask table with the task id and 0 for nScheduleRevNumber and nDateState to indicate that task has not been scheduled and it is a to-do list task. With the task added to the MemberTasks and Level1MemberTask tables, the member schedule editor includes the newly assigned task as a to-do list task. This prevents the project member from forgetting to add or schedule the project task to the schedule. The process of determining the task id and adding the project task to the MemberTasks and Level1MemberTask tables is repeated for all newly assigned project tasks. If all the newly assigned project tasks have been added to the schedule database, then the highest task id for each member is updated in the ProjectTeam table and the process of adding newly assigned project task is completed.

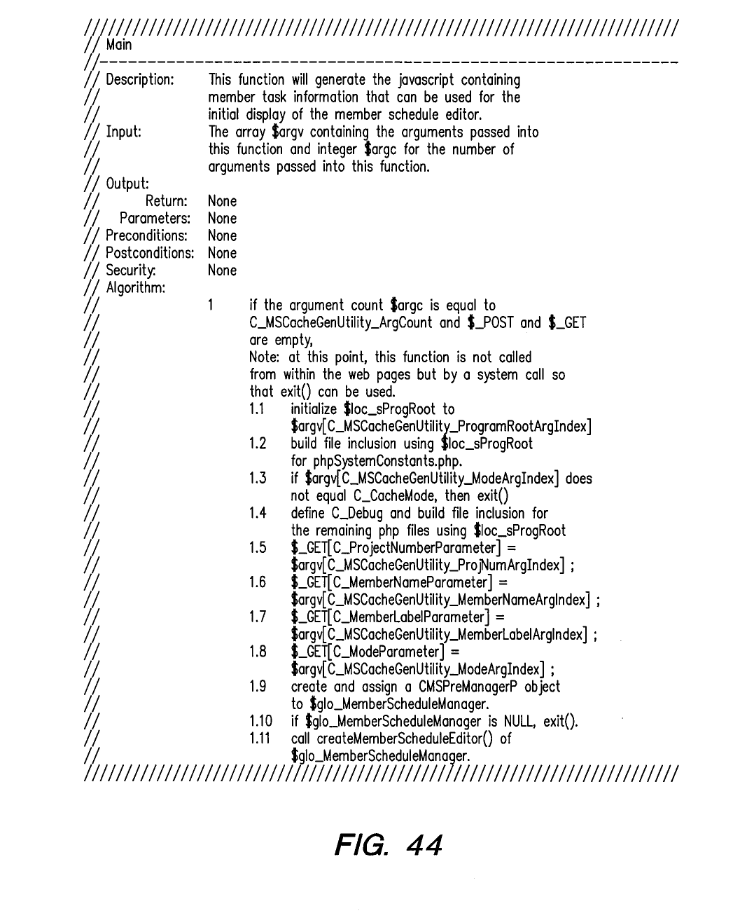

FIG. 44 depicts an example algorithm implemented by a script executed on the web server by the system( ) function to generate the cache file containing member task information for display in the member schedule editor. The script is called with parameters as follow: php -f programroot/Common/PHPCommon/membScheduleCacheGenUtilityP.php ProjectNumber MemberName MemberLabel Cache programroot>C_SysConfig_CacheDirectory.projectnumber_MemberName.cache &. The function adds the parameters to the associated array $_GET in steps 1.5 through 1.8. The values added to $_GET that are used to determine the member and project from which the task information is obtained from the schedule database. The function calls createMemberScheduleEditor( ) of the CMSPreManagerP object to echo the task information that are displayed in the member schedule editor. createMemberScheduleEditor( ) of the CMSPreManagerP will use the values in $_GET.

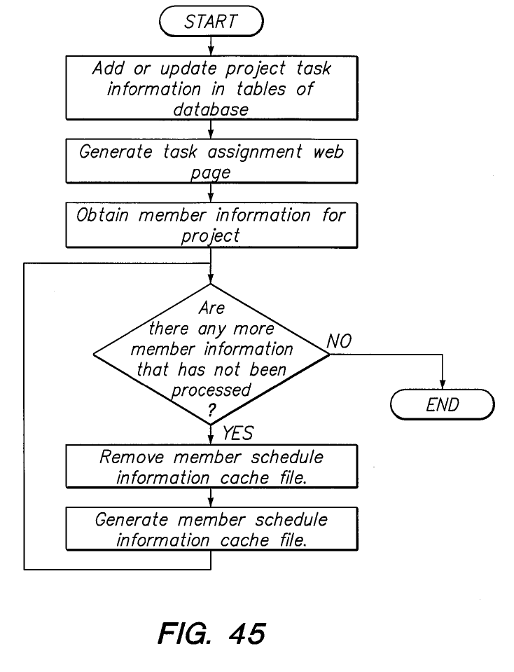

FIG. 45 is a flowchart that depicts generating the cache files when information from the task assignment editor is submitted. The task information in the schedule database is added or updated for the newly added project tasks, re-assigned project tasks, and/or delete project tasks. After updating the tables of the database, the task assignment web page is generated. Next, member information for the project is obtained from the database (member name and member label). For each member of the project, the existing cache file for the member is removed and a new cache file for the member is generated. After all the cache files have been generated for the members of the project, the task assignment editor session is complete. The system( ) function executes the cache generation script which executes in the background. After the script has been executed for all the members, the execution of the web page is completed. Since the script executes in the background, the generation of the cache files may still be performed even if the web page is complete.

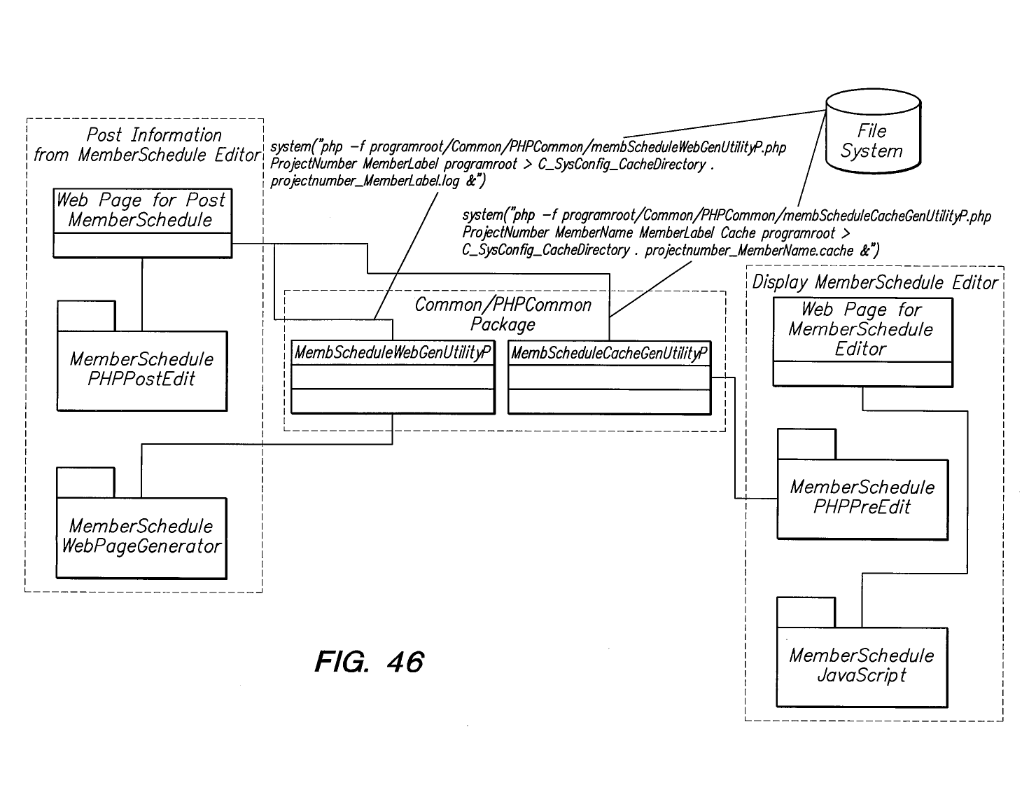

FIG. 46 depicts an example package diagram for the server package that provides more detail for generating the cache file used for the member schedule editor and the member schedule web page. The posting or submitting of information from the member schedule editor triggers the generation of the cache file and member schedule web page for the one member. The web page for posting information from the member schedule editor uses the utility MembScheduleCacheGenUtilityP in the Common package to generate the cache file and the utility MembScheduleWebGenUtilityP in the Common package to generate the member schedule web page. MembScheduleCacheGenUtilityP uses the package of the member schedule editor, MemberSchedulePHPPreEdit, to generate the cache containing the task information. MembScheduleWebGenUtilityP uses the package of the member schedule editor, MemberScheduleWebPageGenerator, to generate the member schedule web page containing the task information. MemberSchedulePHPPreEdit and MemberScheduleWebPageGenerator execute the database queries to obtain task. The web page for posting the member schedule editor calls the system( ) function with parameters passed in to execute the function that generates the member schedule web page and another system( ) function with parameters passed in to execute the function that generates the cache file in the background. This allows the rest of the web page for posting the editor to finish processing without waiting for the system( ) function to complete. There is no delay in displaying the message indicating the completion of the member schedule editor session while generating the member schedule web page and cache files for the project members.

The system call php -f programroot/Common/PHPCommon/membScheduleWebGenUtilityP.php ProjectNumber MemberLabel programroot>C_SysConfig_CacheDirectory.projectnumber_MemberLabel.log & requires parameters to function properly. The programroot is the absolute directory path to the source code of the project management system. programroot/Common/PHPCommon/membScheduleWebGenUtilityP.php is the PHP script that generates the member schedule web page. ProjectNumber MemberLabel programroot are parameters passed into the PHP script. The ProjectNumber corresponds to the project number of the project. The MemberLabel correspond to the label (usually the initials of the member) of a project member. C_SysConfig_CacheDirectory is a constant that represents the absolute directory path where the cache files are located. The redirection of the script “>” echos the results of generating the member schedule web page into the file projectnumber_MemberLabel.log. The file is empty if the member schedule web page was generated successfully. The symbol “&” at the end is to indicate to the PHP script is to be executed in the background. An example of the system call is php -f/ProjManageSystem/Common/PHPCommon/membScheduleWebGenUtilityP.php J25 MA/ProjManageSystem >/ProjManageSystem/Cache/j25_MA.log &.

The system call php -f programroot/Common/PHPCommon/membScheduleCacheGenUtilityP.php ProjectNumber MemberName MemberLabel Cache programroot>C_SysConfig_CacheDirectory.projectnumber_MemberName.cache & requires parameters to function properly. The programroot is the absolute directory path to the source code of the project management system. programroot/Common/PHPCommon/membScheduleCacheGenUtilityP.php is the PHP script that generates the cache. ProjectNumber MemberName MemberLabel Cache programroot are parameters passed into the PHP script. The ProjectNumber corresponds the project number of the project. The MemberName and MemberLabel correspond to the name and label (usually the initials of the member) of a project member. Cache indicates that a cache file is to be generated. C_SysConfig_CacheDirectory is a constant that represents the absolute directory path where the cache files are located. The redirection of the script “>” echos the task information to the cache file projectnumber_MemberName.cache. The symbol “&” at the end indicates that the PHP script is to be executed in the background. An example of the system call is php -f/ProjManageSystem/Common/PHPCommon/membScheduleCacheGenUtilityP.php J25 MaryAnn MA Cache/ProjManageSystem>/ProjManageSystem/Cache/j25_MaryAnn.cache &. The system call is the same as that used in the submitting of the task assignment editor. The difference is that the caches for all the project members are generated when submitting the task assignment editor, but only the cache for the one project member is generated when submitting the member schedule editor.

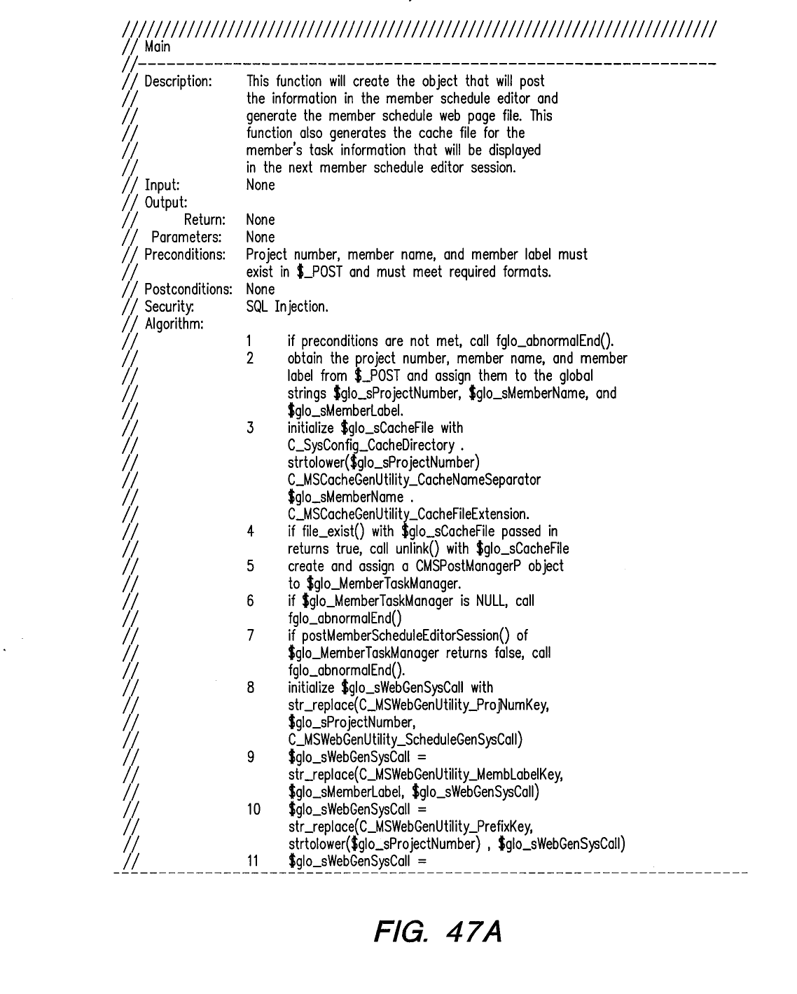

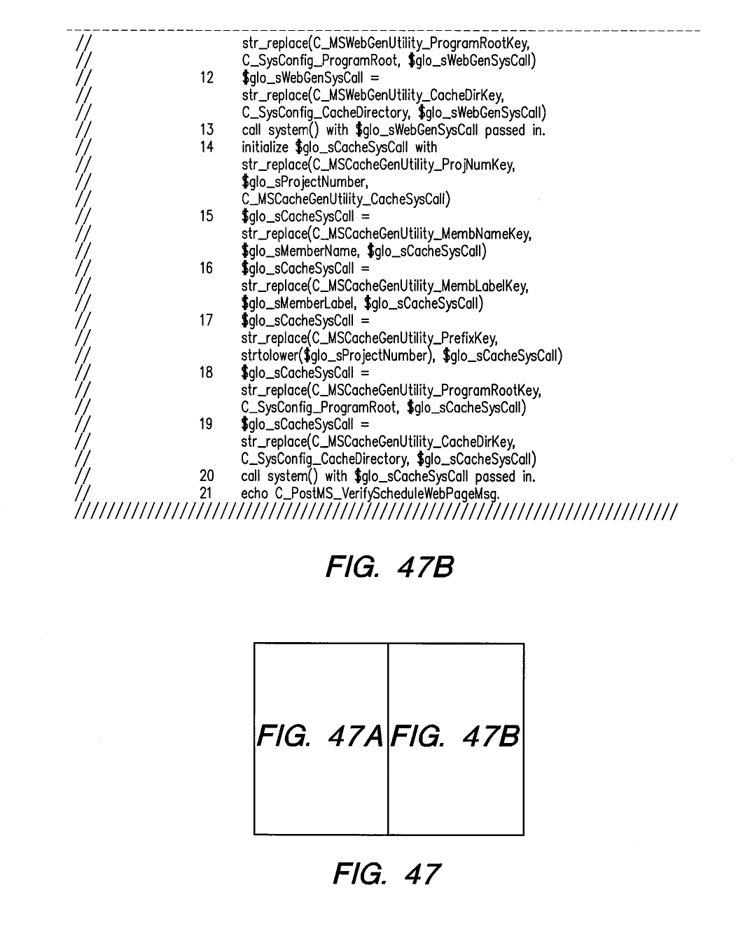

FIG. 47 depicts an example algorithm that is executed in the web page by the web server when posting information from the member schedule editor. Steps 1 through 4 remove the existing cache file that was used for the member schedule editor. Steps 5 through 7 add and update task scheduling information in the schedule database. Steps 8 through 13 generate the member schedule web page. In steps 8 to 12, the string for the system call php -f programroot/Common/PHPCommon/membScheduleWebGenUtilityP.php ProjectNumber MemberLabel programroot>C_SysConfig_CacheDirectory.projectnumber_MemberLabel.log & is built by replacing ProjectNumber, MemberLabel, programroot, and C_SysConfig_CacheDirectory with the appropriate values. After the string is built, it is executed in step 13 as input to system( ). Steps 14 through 20 generate the cache file for the project member that is used in the next member schedule editor session. In steps 14 to 19, the string for the system call php -f programroot/Common/PHPCommon/membScheduleCacheGenUtilityP.php ProjectNumber MemberName MemberLabel Cache programroot>C_SysConfig_CacheDirectory.projectnumber_MemberName.cache & is built by replacing ProjectNumber, MemberName, MemberLabel, programroot, and C_SysConfig_CacheDirectory with the appropriate values. After the string is built, it is executed in step 20 as input to system( ). Step 21 displays a message on the web page informing the user to verify the member schedule web page. Using the system( ) functions in step 13 and 20 starts the generation of the member schedule web page and cache file in the background. The system( ) does not wait for the completion of the generation. Since both the generation of the member schedule web page and cache file requires database queries, their creation may not be completed before the display of the message on the web page.

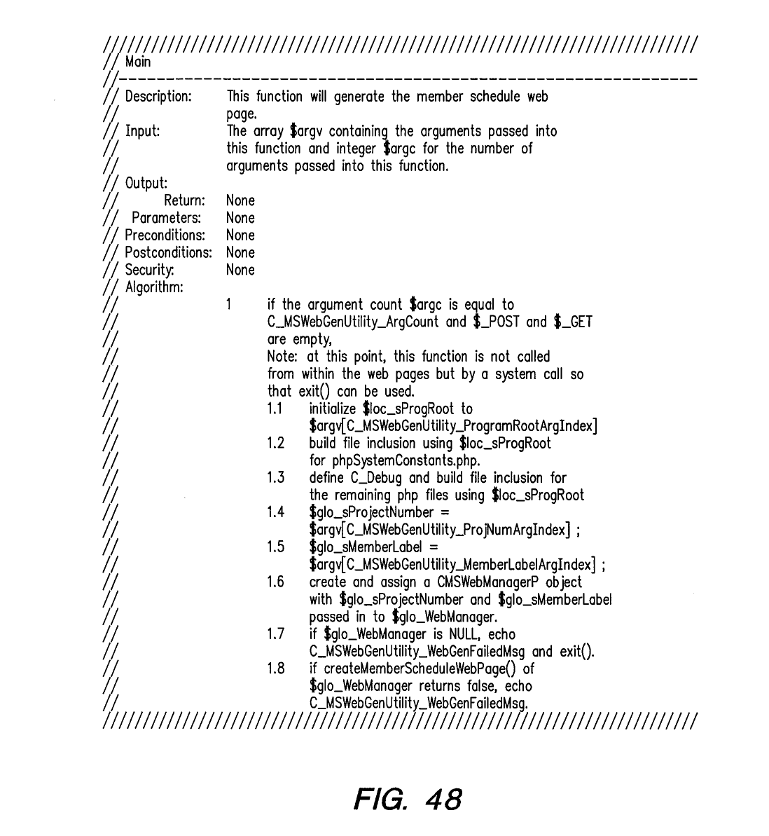

FIG. 48 depicts an example algorithm for the script executed on the web server by the system( ) function to generate the member schedule web. The script is called with parameters as follow: php -f programroot/Common/PHPCommon/membScheduleWebGenUtilityP.php ProjectNumber MemberLabel programroot>C_SysConfig_CacheDirectory.projectnumber_MemberLabel.log &. The function obtains the parameters for the project number and member label in steps 1.4 and 1.5 that are used to determine which project and project member for the member schedule web page are generated. The function calls createMemberScheduleWebPage( ) of the CMSWebManager object to create the web page in step 1.8.

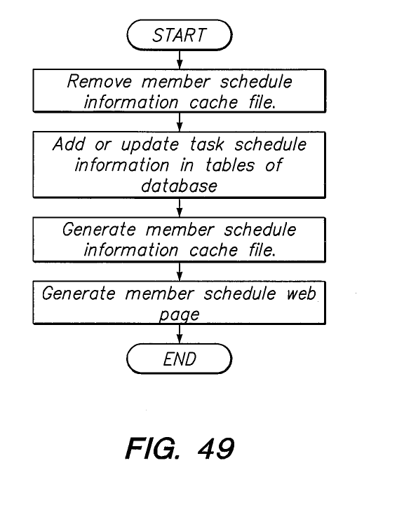

FIG. 49 is a flowchart that depicts generating the member schedule web page and cache file when the member schedule editor is submitted. The cache file for the member is first removed. Then the task schedule of the member is added or updated for the newly added tasks, scheduled tasks, and/or delete tasks in the schedule database. After updating the tables of the database, the member schedule web page is generated. Next, a new cache file for the member is generated. The system( ) function executes the web page and cache generation script which runs in the background. After the scripts have been executed, the execution of the web page is completed. Since the scripts are running in the background, the generation of the web page and cache file may still be executing even if the web page is complete. The order of web page generation and cache generation is not important as FIG. 47 shows where the web page generation starts before the cache generation.

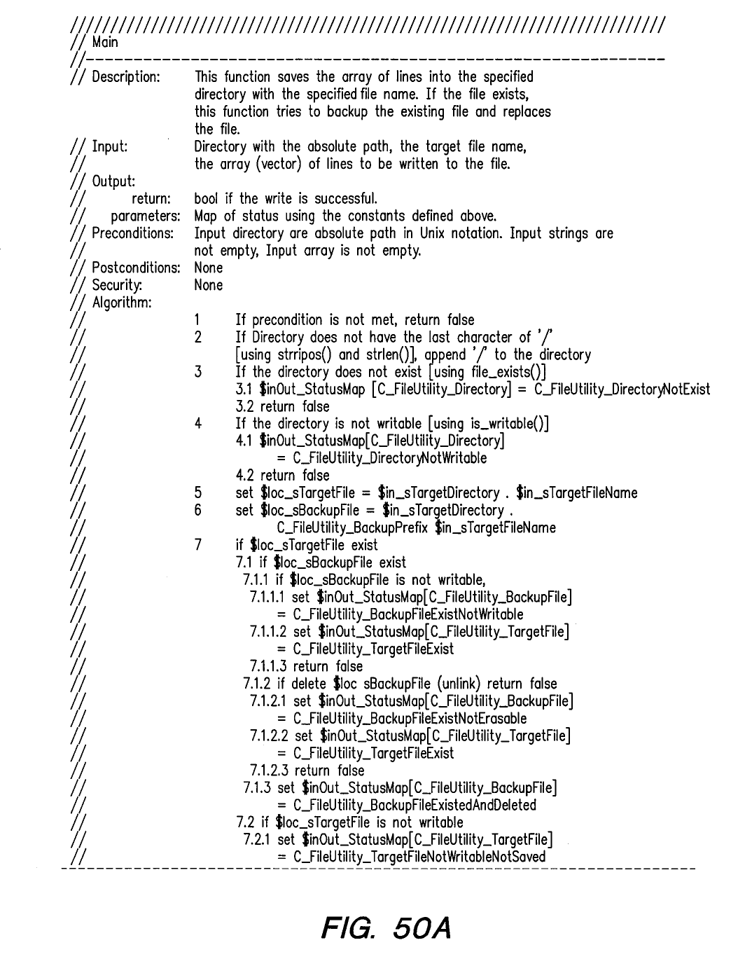

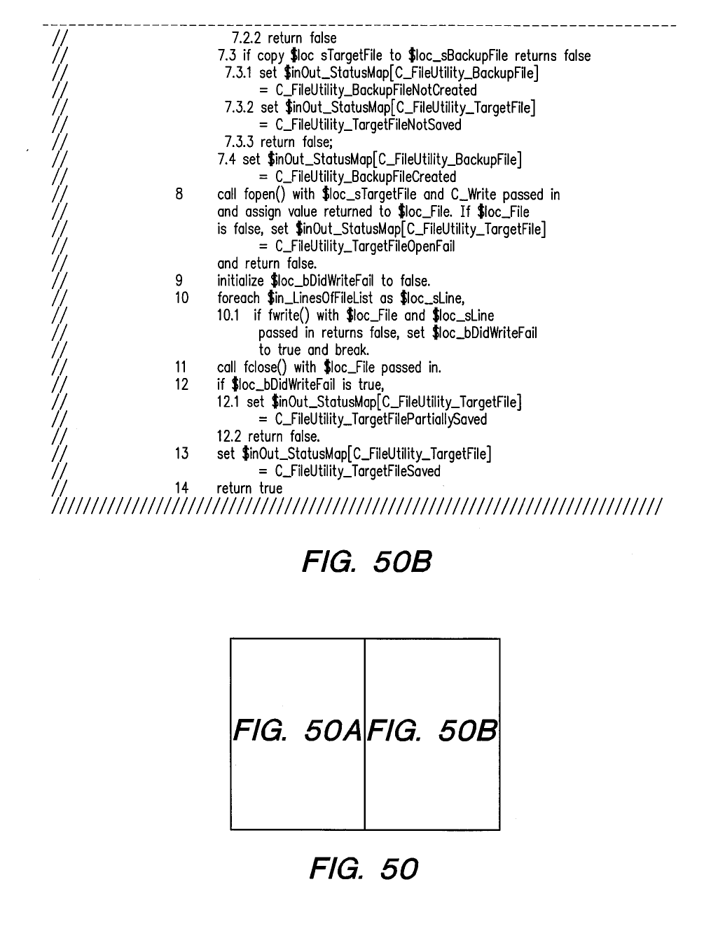

FIG. 50 depicts an example algorithm for the function fglo_WriteLinesToFileWithStatusReportAndBackup( ) for generating writing lines to a file. The function writes the lines to a file and creates a backup of the file if it already exists. The status of writing the file is added to the status map. The parameters to the function are the status map for the status of generating the file, the target directory where the file is to be generated, the target file name for the file to be generated, and array of strings that are written into the file. Steps 2 through 4 validate the directory. Step 7 generates a backup of the file if it already exists. Steps 9 through 11 generate the new file.

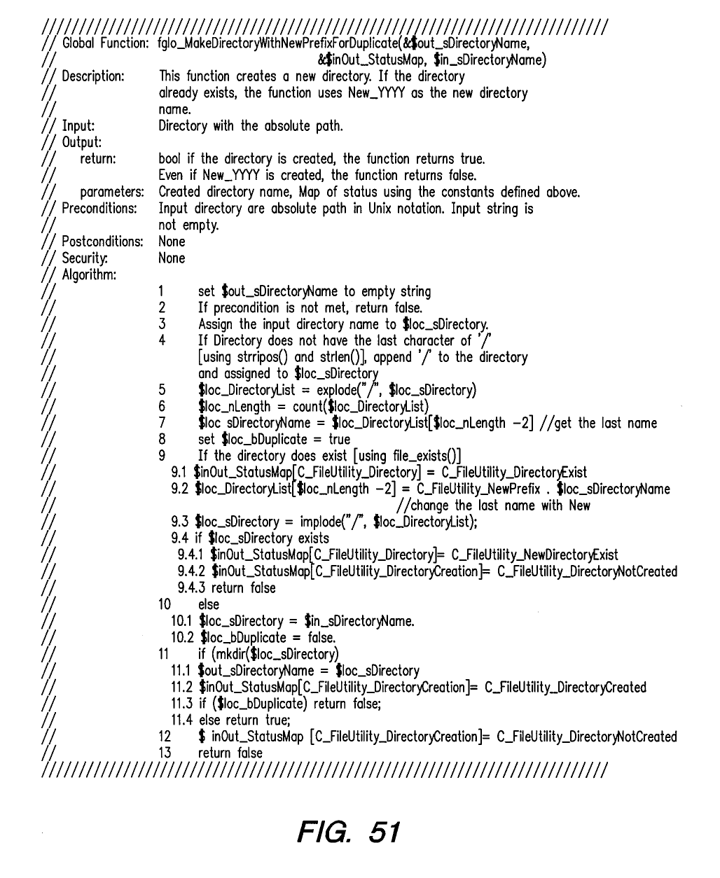

FIG. 51 depicts an example algorithm for the function fglo_MakeDirectoryWithNewPrefixForDuplicate( ) for generating a new directory. The function creates a new directory if the directory does not already exist or creates a new directory with “New_” prefixing the name if the directory already exists. The status of creating the new directory is added to the status map. The parameters to the function are the resulting directory name used for new directory (which can be the same as the directory name to create if it does not exist), the status map for creating the directory, and the directory name for the directory to be created. Step 9 determines if the directory exists and if it does, it creates a directory name to be prefixed with “New_”. Step 11 generates the new directory.

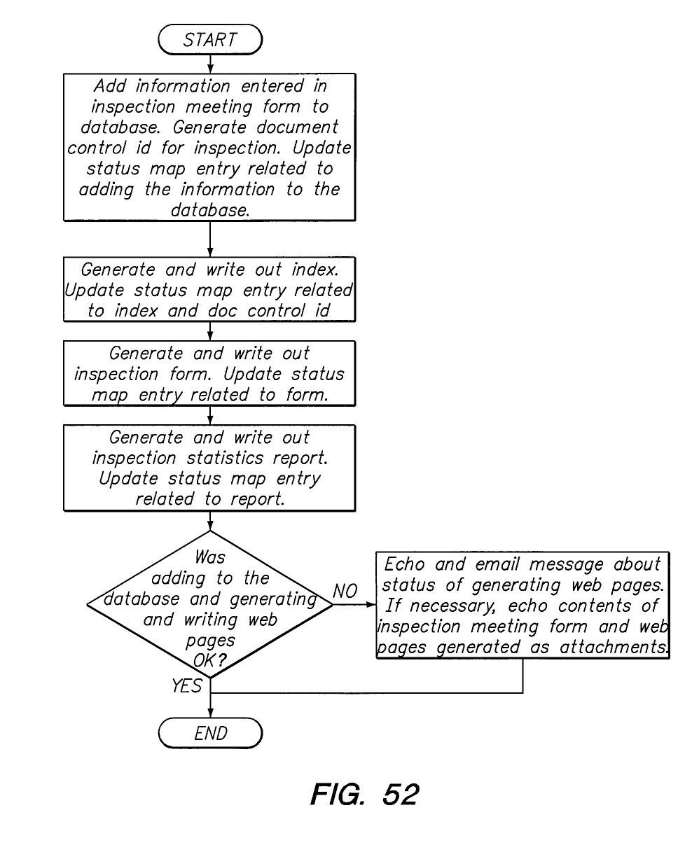

FIG. 52 is a flow diagram that depicts adding inspection information into the database and generating the inspection web page when the inspection meeting form is submitted. In adding the inspection information to the database, the document control id of the inspection is determined. The document control id uniquely identifies the inspection meeting session. According to one embodiment of the invention, each inspection has a unique document control id. If the document control id cannot be determined, the inspection information cannot be added to the database and entries are added to the status map to indicate that the inspection information cannot be added to the database and the document control id cannot be determined. If the document control id can be determined, the inspection information is added to the tables of the database and entries are added to the status map indicating the results of adding the inspection information to the tables.

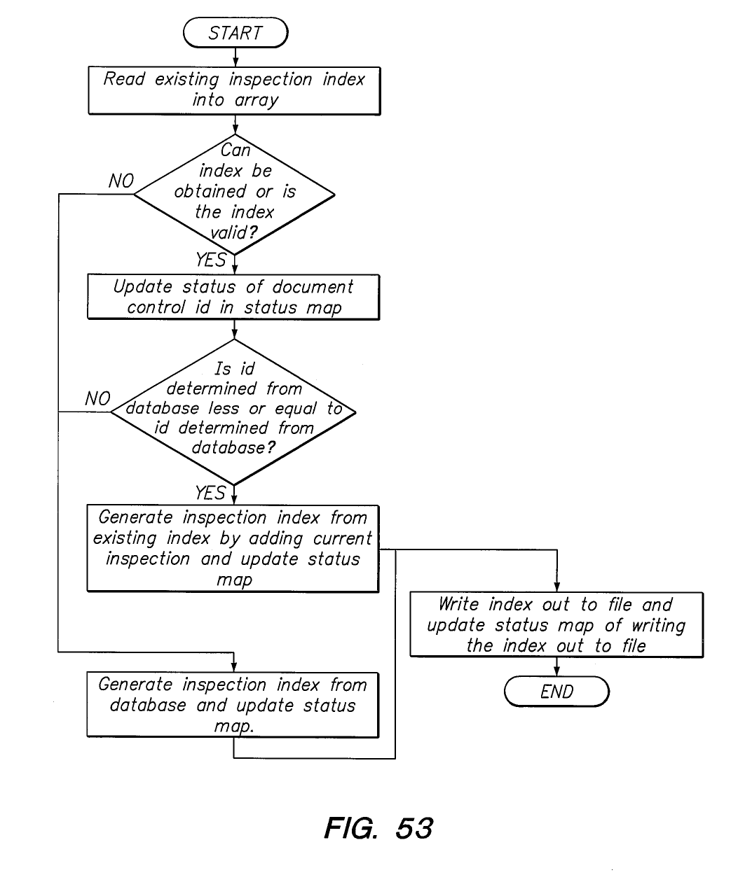

Next the web pages for the inspection are generated and stored in the appropriate location in the file system corresponding to the web site. More details of generating the inspection web pages are depicted in FIGS. 53 through 57. The inspection index, an example of which is depicted in FIG. 21, is generated and stored. The existing inspection index is used to generate the new index and to determine the document control id of the new inspection form. If the inspection index does not exist or is not a valid inspection index, the system generates a new index from the inspection information in the database. Entries are added to the status map for generating and storing the inspection index. An entry is added to the status map that will be used to determine whether there is a mismatch in the document control id of the inspection determined from the database and determined from the existing index.

The inspection form web page, an example of which is depicted in FIG. 20, is generated and stored. Information from the inspection meeting form is used to generate the inspection form web page. Entries are added to the status map for generating and storing the inspection form web page. Finally, the inspection report, an example of which is depicted in FIG. 22, is generated and stored. Information from the database is used to generate the inspection report. Entries are added to the status map for generating and storing the inspection report. Possible status for generating or storing the web pages are: partially generated (the web pages are missing information where the missing information is explicitly specified in the web page so that the document controller or administrator can manual update the information), completely generated (all the information is entered in the web page), writing failed (the web page could not be written due to access problems), and/or writing successful (the web page successfully written to the file system). Other status entries may be added.

If adding the inspection information to the database and generating and storing the inspection web pages are successful, the inspection meeting system is completed. However, if a failure occurs, the inspection meeting system echoes to the browser and emails to the document controller/administrator the results of processing the inspection information. With the information about adding the inspection information to the database and generating and writing the inspection web pages in the status map, the information of the status map can be echoed and emailed to provide information about the problems/errors/failures that occurred during the processing of the inspection information. Also if the web pages were generated and/or written, the web pages can be echoed and emailed so that the web pages can be added to the file system if necessary and the database can be updated. The information in the inspection meeting form may also be echoed and emailed. The status map information and web pages may be emailed as attachments. The information echoed and emailed allows the document controller and administrator to restore the database and web pages with the correct information.

FIG. 53 is a flow diagram that depicts the overall generation of the inspection index. The inspection meeting system attempts to generate the inspection index using the existing index. Generating the index from the existing index requires fewer resources than accessing information from the database. If the inspection index can be accessed and is a valid index, the document control id of the current inspection is determined from the document control id of the previous inspection from the index. An entry is added to the status map indicating whether there is a mismatch between the document control id determined from the database and determined from the existing index. If a mismatch exists, the greater of the two ids is used as the id and an entry is added to the status map indicating the source of the id (database or existing index). If the id determined from the database is less than or equal to the id determined from the existing inspection index, then the existing inspection index is updated with the current inspection meeting information and an entry is added to the status map indicating that the index was generated from the existing index. An entry is added to the status map indicating the status of adding the current inspection meeting. Then the inspection index is store in the file system and an entry is added to the status map indicating the status of storing the inspection index.

If the existing index does not exist or is an invalid index, or if the document control id determined from the database is greater than the id determined from the existing index, then the inspection index is generated from the inspection information in the database. The entire index for all the inspection meetings of the project is added to the index. An entry is added to the status map indicating that the index was generated from the database. An entry is added to the status map indicating the status of adding all the inspection meetings to the index. Then the inspection index is stored in the file system and an entry is added to the status map indicating the status of storing the inspection index.

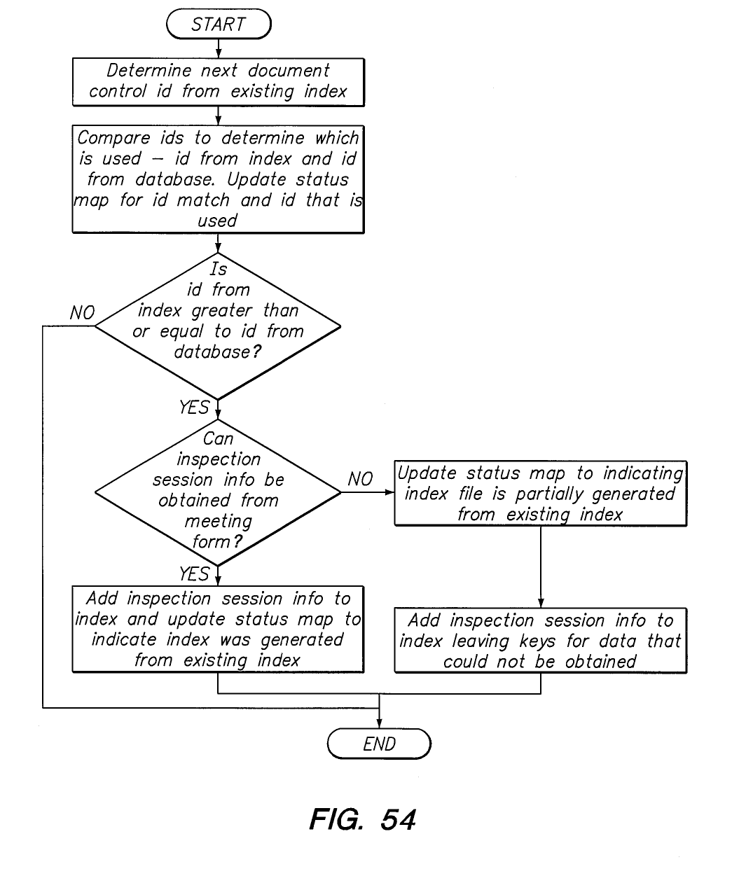

FIG. 54 is a flow diagram that depicts the process of generating the inspection index from the existing index in more detail. The inspection meeting system obtains the document control id of the prior inspection from the inspection index and determines the document control id for the current inspection from it. This document control id is compared with the document control id generated when adding the inspection information into the database. If the ids are different, then an entry is added to the status map indicating that the ids do not match. If the id generated from the database is greater than the id determined from the existing inspection index, then the process of generating the index from the existing index stops. Otherwise, the inspection information is retrieved from the inspection meeting form and information is added to the index. If any information cannot be obtained from the inspection meeting form, an entry is added to the status map indicating that the index is partially generated and keys are placed in the index to indicate that information must be added to the index. If the information can be obtained, the index is generated containing the information and an entry is added to the status map indicating that the index is completely generated. Then the process of generating the inspection index from the existing index is completed.

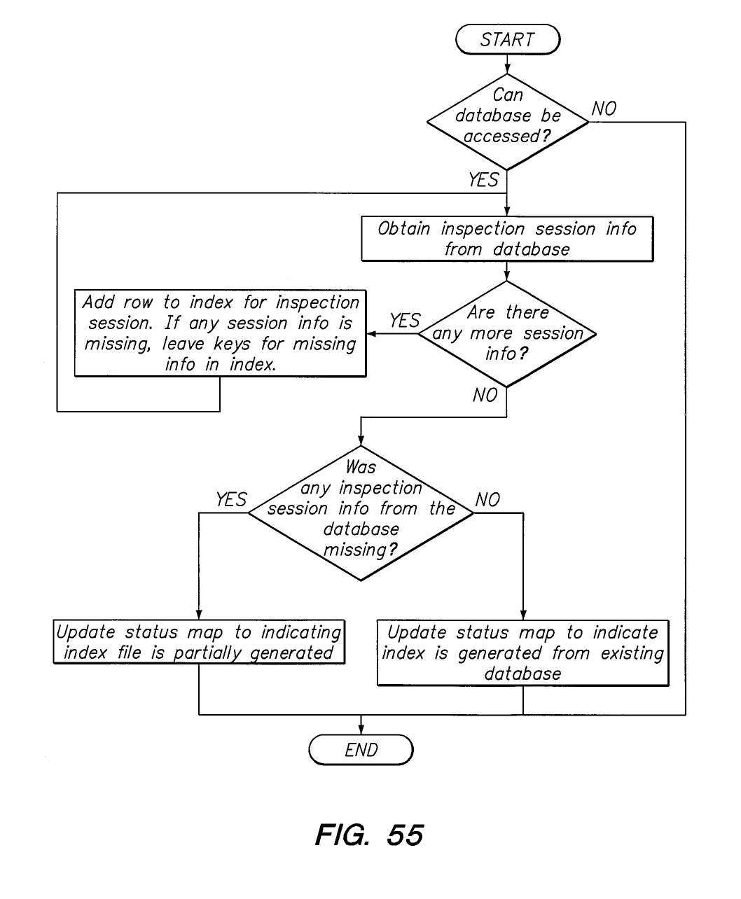

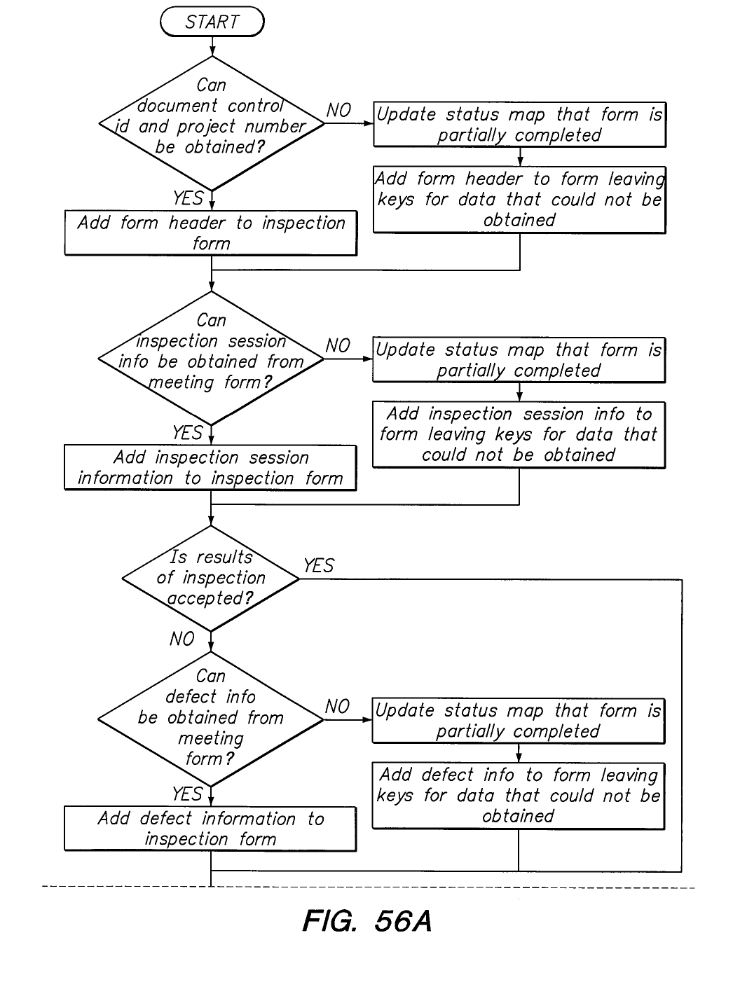

FIG. 55 is a flow diagram that depicts the process of generating the inspection index from inspection information in the database in more detail. This process generates the entire index to link to all the inspection meeting documents for a project. Accessing the database to generate the index requires more resources than accessing the existing inspection index to generate the index. However, it may be necessary to generate the inspection index using inspection information from the database if the existing index does not exist or is corrupt. In the first step, if the database cannot be accessed, the inspection index cannot be created and the process of generating the index stops. If the database can be accessed, a query is made to obtain the inspection information for all inspections of a project. For each inspection meeting session, the inspection information is added to the inspection index to link the index to the inspection form document. If any of the inspection information for a session is missing, then a key string for the missing data will be added to the index to indicate that data is missing in the index. After all the inspection meeting sessions are added to the index, a check is made to determine if any of the sessions added to the index contained missing information. If so, an entry is added to the status map to indicate that the inspection index was partially generated. Otherwise, an entry is added to the status map to indicate that the inspection index was completely generated. Then the generation of the inspection index using the database is completed.

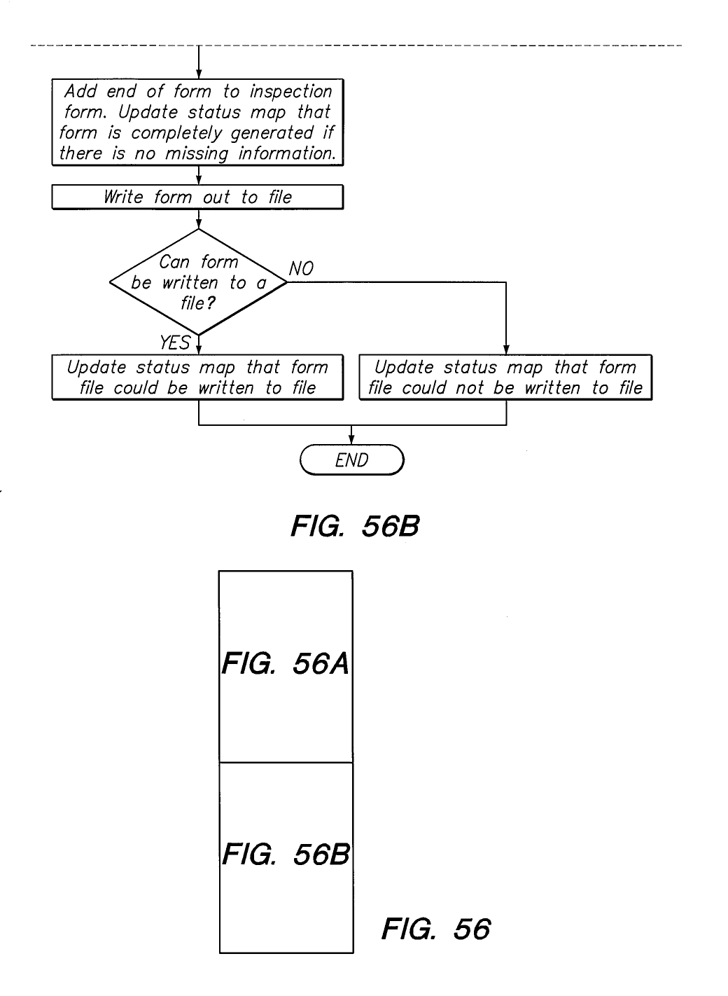

FIG. 56 is a flow diagram that depicts the generation and storing of the inspection form web page, an example of which is depicted in FIG. 20. If the document control id or the project number cannot be obtained, an entry is added to the status map to indicate that the inspection form web page is partially generated. Also, keys are added to the inspection form web page header for the id or project number indicating that this information will need to be added. Otherwise, the information is added to the inspection form web page header. If any of the inspection session information cannot be obtained from the inspection meeting form, an entry is added to the status map to indicate that the inspection form web page is partially generated. Also, keys are added to the inspection form web page for the missing inspection session information indicating that this information will need to be added. Otherwise, the inspection session information is added to the inspection form web page. If the results of the inspection meeting session are accepted (inspection material has no defects), the end of form is added to the inspection form web page. If the results are not accepted, the defect tables are added to the inspection form web page for each inspection material. If any of the defect information cannot be obtained from the inspection meeting form, an entry is added to the status map to indicate that the inspection form web page is partially generated. Also, keys are added to the inspection form web page for the missing defect information indicating that this information will need to be added. Otherwise, the defect information is added to the inspection form web page. The end of form is added to the inspection form web page. If there is no missing information in the inspection form web page, then an entry is added to the status map to indicate that the inspection form web page is completely generated. After the inspection form web page has been generated, the inspection form web page is stored to the file system where the inspection form web pages are located for the project in the project web site. If writing to the file system fails, an entry is added to the status map to indicate that the inspection form web page could not be written. Otherwise, an entry is added to the status map to indicate that the inspection form web page was stored to a file. The process for generating and writing the inspection form web page is completed.

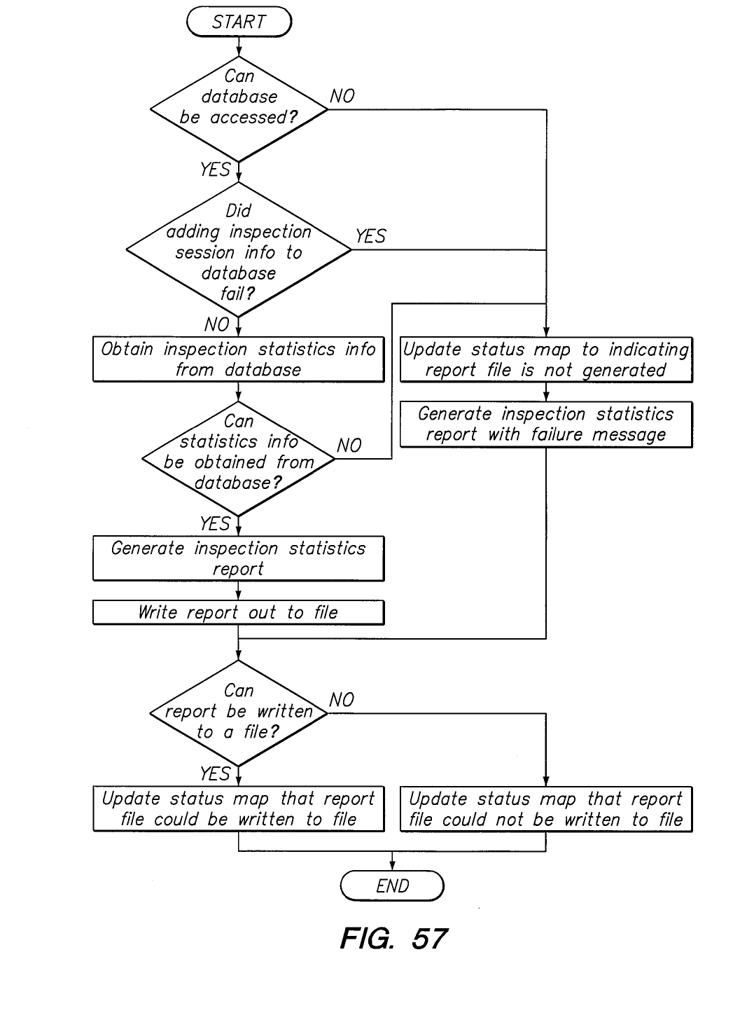

FIG. 57 is a flow diagram that depicts the process of generating the inspection report using the database to obtain statistical information for all the inspections of a project up to the current inspection session, an example of which is depicted in FIG. 22. If the database cannot be accessed or if the inspection session information for the current inspection session could not be added to the database, or if the inspection statistics of a project could not be obtained from the database, then an entry is added to the status map to indicate that the inspection report could not be generated and the process stops. Otherwise, the inspection report is generated with the inspection statistics and an entry is added to the status map to indicate that the inspection report was completely generated. The inspection report is then stored in the file system where the website for the inspection web pages of a project is located. If writing to the file system fails, an entry is added to the status map to indicate that the inspection report could not be written. Otherwise, an entry is added to the status map to indicate that the inspection report was stored to a file. The process for generating and writing the inspection report is completed.

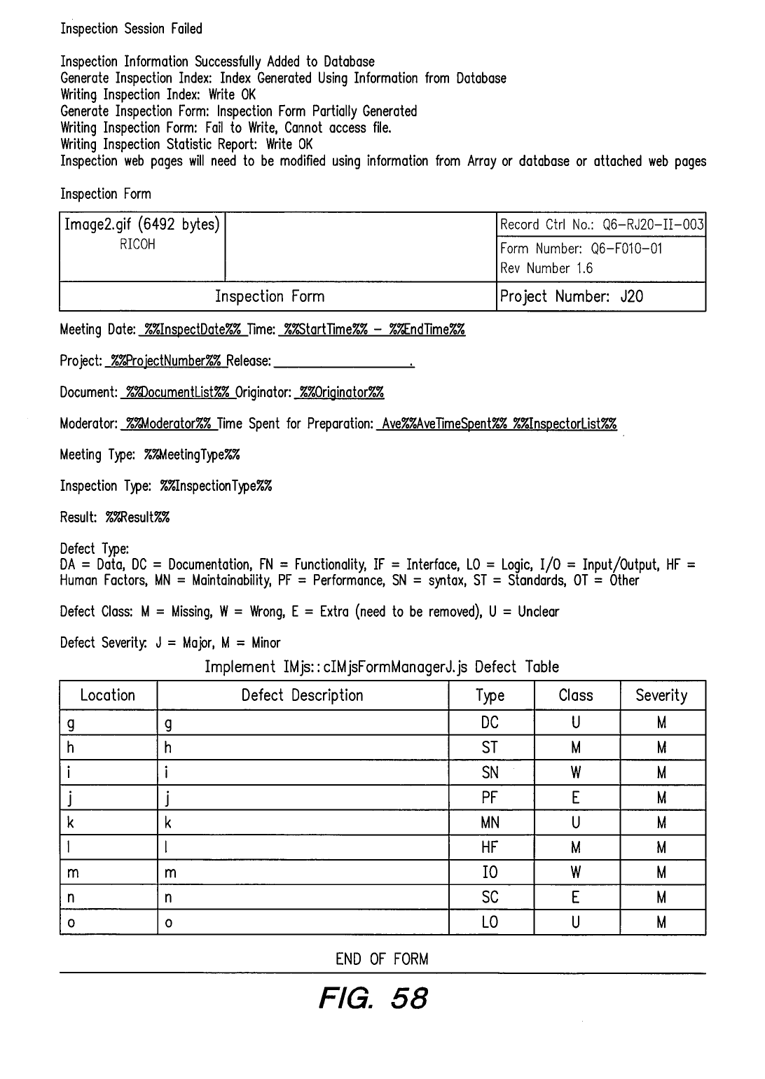

FIG. 58 depicts an example display in the web browser when an inspection meeting session fails after the user submits the inspection meeting form. A message is displayed on top indicating the session failed. Next, the contents of the status map is displayed indicating the results of adding the inspection session information to the database (successful in this example) and generating and writing out the inspection web pages to the project web site (the index and report were stored but the inspection form web page was partially generated and was not stored). Since the inspection form web page could not be stored, the web browser displays the contents of the form web page. The form web page may be added by the document controller or administrator to the project web site. The inspection form web page contains keys (strings enclosed within %%) to indicate that information is missing in the form web page. Since the inspection information was successfully added to the database, the document controller or administrator can obtain the information from the database and add the missing information to the inspection form web page.

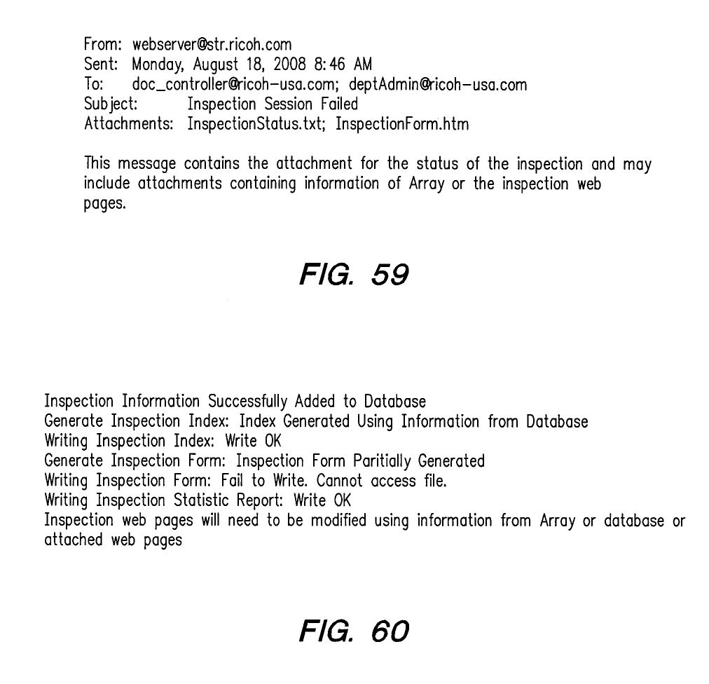

FIG. 59 depicts an example email message that is sent to the document controller and administrator responsible for the web server. The email is sent when the inspection session fails. The document controller or administrator may need to update the database, update the inspection web pages, and/or add web pages to the project web site. The message describes the contents of the email and includes two attachments. The attachments include the information (contents of status map and inspection form web page) that was displayed in the web browser in FIG. 58. The document controller and/or administrator can correct the database/web pages with the information provided in the attachments.

FIG. 60 depicts an example email attachment, inspectionStatus.txt, that was sent to the document controller and administrator. The attachment contains the content of the status map that was displayed in the web browser in FIG. 58.

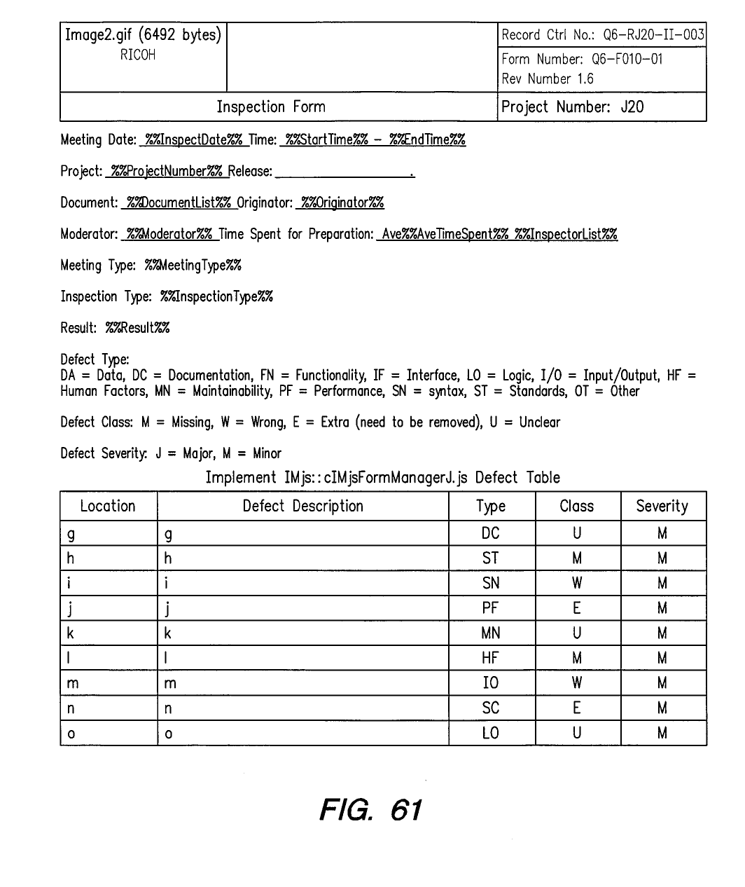

FIG. 61 depicts an example email attachment, InspectionForm.htm that was sent to the document controller and administrator. The attachment contains the inspection form web page that was displayed in the web browser in FIG. 58.

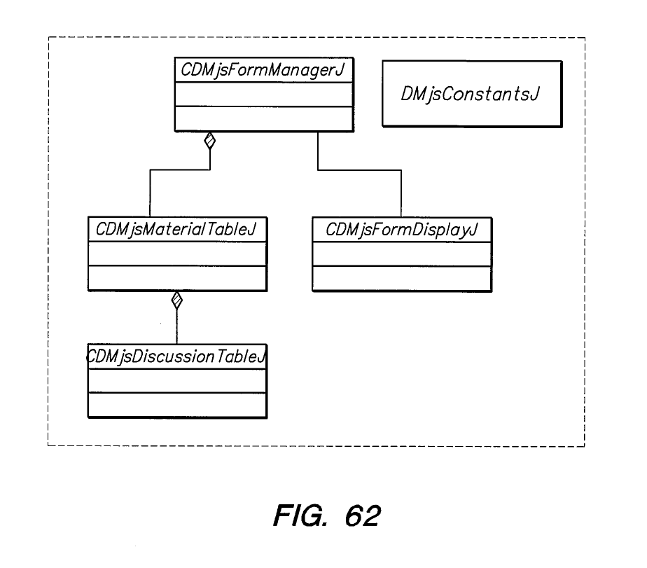

FIG. 62 depicts an example class diagram for the DiscussionMeetingJavaScript package to display and manage the discussion meeting form as depicted in FIG. 24. The class CDMjsFormManagerJ provides the interface for this package and creates the web page and form for the discussion meeting. The class CDMjsFormDisplayJ provides the initial display of the discussion meeting form. The class CDMjsMaterialTableJ manages the Discussion Material Table for adding the materials to be discussed. The class CDMjsDiscussionTableJ manages the Discussion Table for a discussion material. The discussion tables are displayed for each discussion material once the Start Discussion Meeting button is clicked. The package also contains constants, DMjsConstantsJ, that are used by the classes in the package.

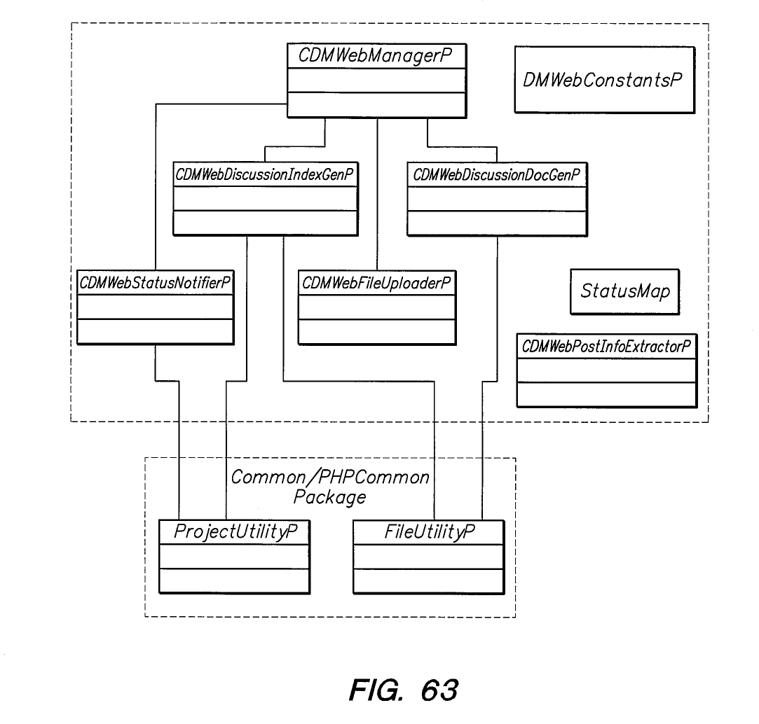

FIG. 63 depicts an example class diagram of the DiscussionMeetingWebPageGenerator package to generate the various discussion web pages as depicted in FIGS. 25 and 26. The class CDMWebManagerP provides the interface for this package to generate the various web pages resulting from the discussion meeting. CDMWebDiscussionIndexGenP generates the discussion index web page shown in FIG. 26 to link to all the discussion form web pages for a project. The class CDMWebDiscussionDocGenP generates the discussion form web page corresponding to the discussion meeting. The discussion form web page contains links to the discussion material. The class CDMWebFileUploaderP uploads the files and supplemental files corresponding to the discussion material so that the discussion form web page can link to them. The class CDMWebStatusNotifierP notifies the administrator and/or document controller if the generation of the discussion web pages failed. The notification may be an email containing all the information necessary to recover the information from the discussion meeting session, which may include the status for generating the discussion web pages, the discussion meeting information in the form, the discussion index web page, and/or the discussion form web page. The class CDMWebPostInfoExtractorP obtains information from the discussion meeting form that is passed from the DiscussionMeeting.htm to PostDiscussionMeeting.htm. CDMWebPostInfoExtractorP is used by all the classes that need information from the form. The package also contains constants, DMWebConstantsP, that are used by the classes in the package. Classes use the status map to set the status for generating the various web pages.

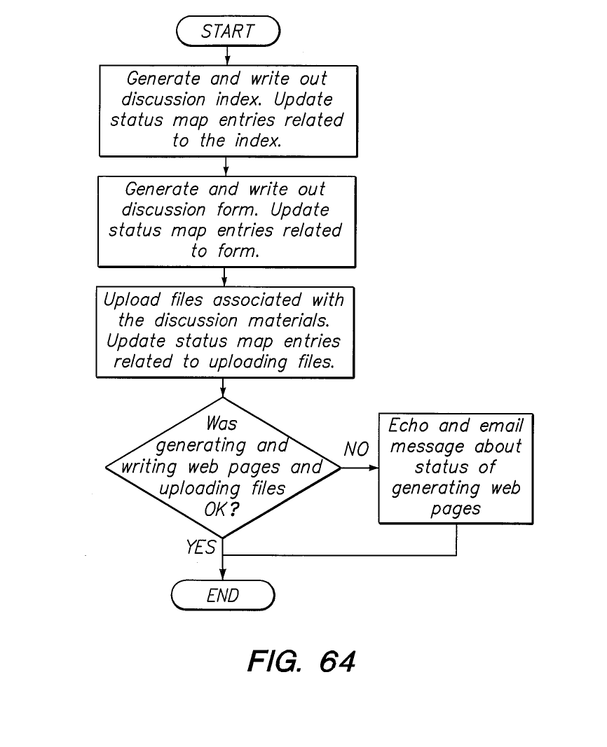

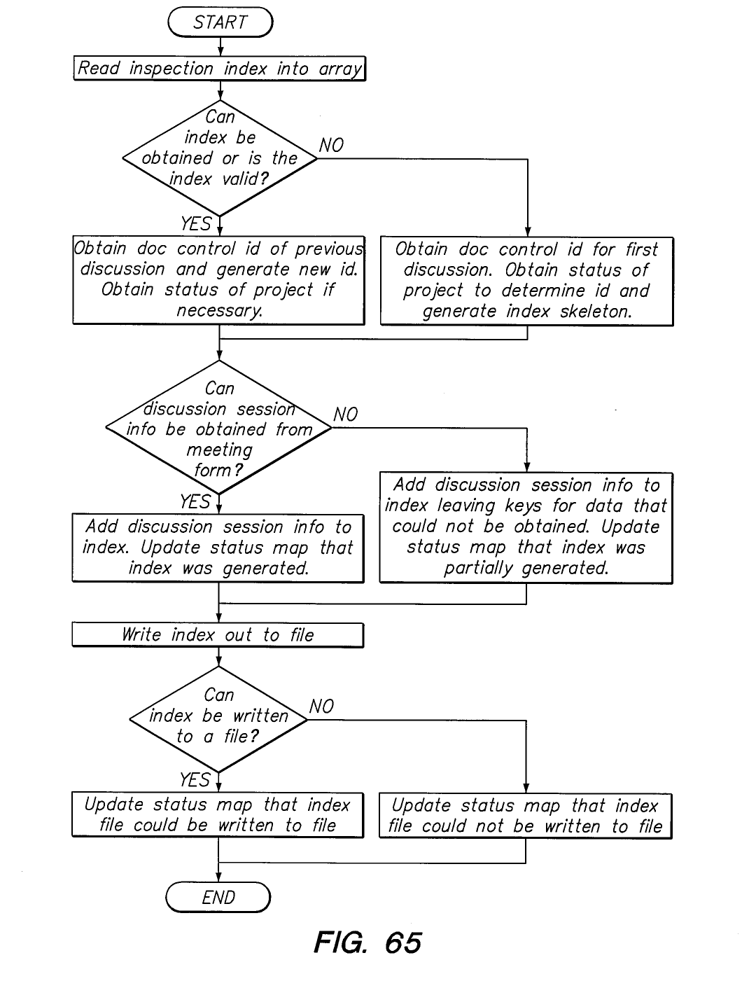

FIG. 64 is a flow diagram that depicts generating the discussion web page when the discussion meeting form is submitted. The web pages for the discussion are generated and stored to the appropriate location in the file system corresponding to the web site. More details of generating the discussion web pages are depicted in FIGS. 65 through 67. The discussion index, an example of which is depicted in FIG. 26, is first generated and stored. The existing discussion index is used to generate the new index and to determine the document control id of the new discussion form. If the discussion index does not exist or is not a valid discussion index, the system generates a new index. Entries are added to the status map for generating and storing the discussion index.

The discussion form web page, an example of which is depicted in FIG. 25, is generated and stored. Information from the discussion meeting form is used to generate the discussion form web page. Entries are added to the status map for generating and writing out the discussion form web page.

The files for the discussion material are uploaded and stored in the appropriate location so that the discussion index and discussion form web page can link to them. Entries are added to the status map for uploading the material files.

If generating and writing out the discussion web pages and uploading the material files are all successful, the discussion meeting system is completed. However, if a failure occurs, the discussion meeting system echoes to the browser and emails to the document controller/administrator the results of processing the discussion information. Since all the information about generating and writing the discussion web pages and uploading the material files in the status map, the information of the status map can be echoed and emailed to provide information about the problems/errors/failures that occurred during the processing of the discussion information. Also if the web pages were generated and/or written, the web pages can be echoed and emailed so that the web pages can be added to the file system if necessary. Also, if necessary the information in the discussion meeting form can be echoed and emailed. The status map information and web pages can be emailed as attachments.

FIG. 65 is a flow diagram that depicts the process of generating the discussion index from the existing index. If the index does not exist or is an invalid index, the document control id for the first discussion is obtained. If the status of the project (obtained from database) is not started, then the document control id contains the term “PRE” to indicate the discussion occurred before the start of the project so the id is for example Q6-RJ21-MM-PRE01. If the project is already started, the id will not contain the term “PRE” so the id is for example Q6-RJ21-MM-001. The skeleton index is then generated with no entries for any discussion meetings. If the discussion index does exist, the discussion meeting system obtains the document control id of the prior discussion from the discussion index and determines the document control id for the current discussion from it. If the prior id corresponds to a discussion that occurred before the start of the meeting (i.e., contains the term “PRE”), the status of the project is obtained to determine if the term “PRE” will or will not be used. If the project has not started, then the term “PRE” remains in the new document control id with the number incremented. If the project has started, the document control id will not contain the term “PRE” and the number starts at 001. If the prior id does not contain the term “PRE,” the new document control id uses the previous document control id with the number incremented.

Next, discussion information is obtained from the discussion meeting form and added to the index. If any information cannot be obtained from the discussion meeting form, an entry is added to the status map indicating that the index is partially generated and keys are placed in the index generated to indicate that information must be added to the index. If the information can be obtained, the index is generated containing the information and an entry is added to the status map indicating that the index is completely generated. Then the process of generating the discussion index is completed. The discussion index is then stored to the file system where the website for the discussion web pages of a project are located. If writing to the file system fails, an entry is added to the status map that the discussion index could not be written. Otherwise, an entry is added to the status map to indicate that the discussion index was stored to a file. The process for generating and writing the discussion index is completed.

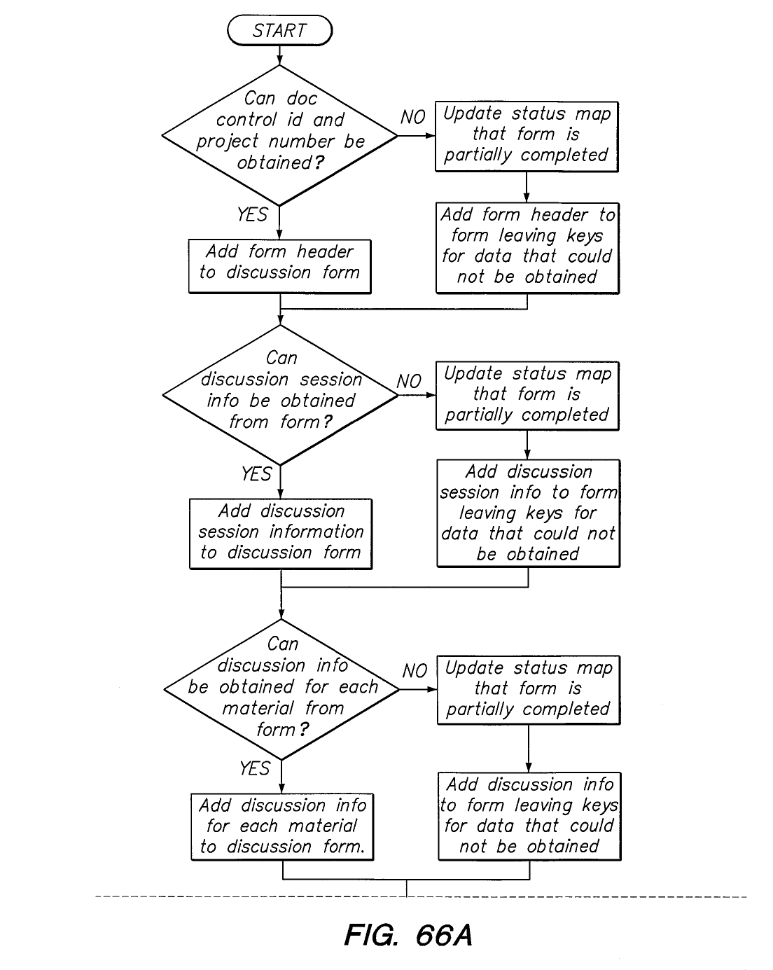

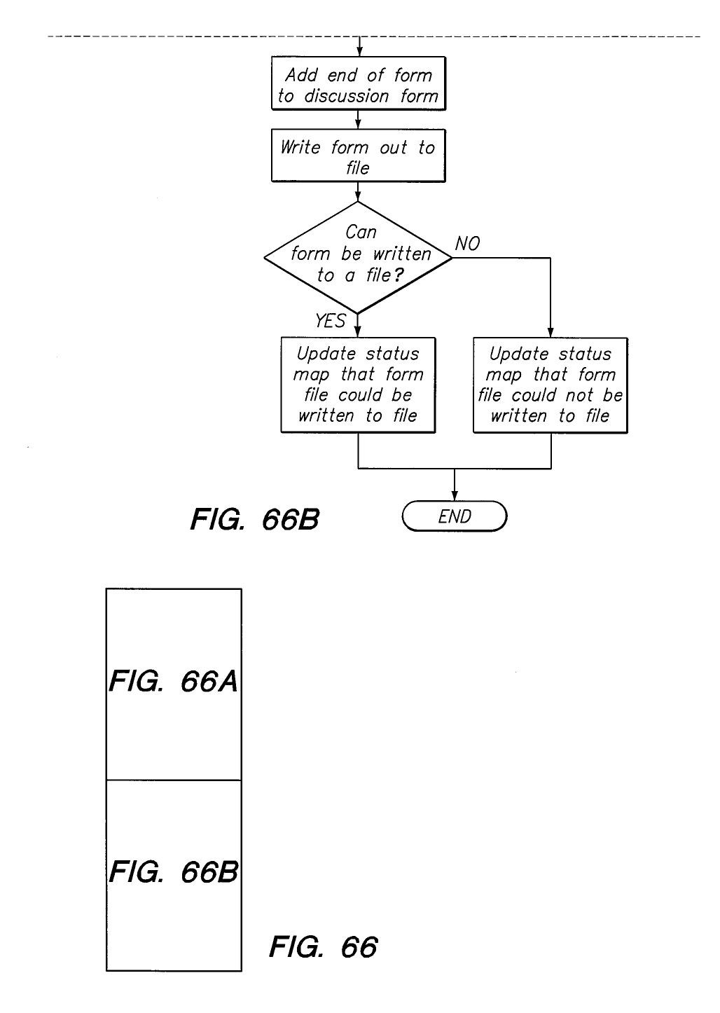

FIG. 66 is a flow diagram that depicts the generation and storing of the discussion form web page. If the document control id or the project number could not be obtained, an entry is added to the status map that the discussion form web page is partially generated and keys are added to the discussion form web page header for the id or project number indicating that this information will need to be added. Otherwise, the information is added to the discussion form web page header. If any of the discussion session information cannot be obtained from the discussion meeting form, an entry is added to the status map to indicate that the discussion form web page is partially generated and keys are added to the discussion form web page for the missing discussion session information indicating that this information will need to be added. Otherwise, the discussion session information is added to the discussion form web page. If any of the discussion information for each discussion material cannot be obtained from the discussion meeting form, an entry is added to the status map to indicate that the discussion form web page is partially generated and keys are added to the discussion form web page for the missing discussion information indicating that this information will need to be added. Otherwise, the discussion information is added to the discussion form web page. The end of form is added to the discussion form web page. If there is no missing information in the discussion form web page, then an entry is added to the status map to indicate that the discussion form web page is completely generated. After the discussion form web page is generated, the discussion form web page is stored in the file system where the discussion form web pages are located for the project in the project web site. If writing to the file system fails, an entry is added to the status map to indicate that the discussion form web page could not be written. Otherwise, an entry is added to the status map that the discussion form web page was stored to a file. The process for generating and writing the discussion form web page is completed.

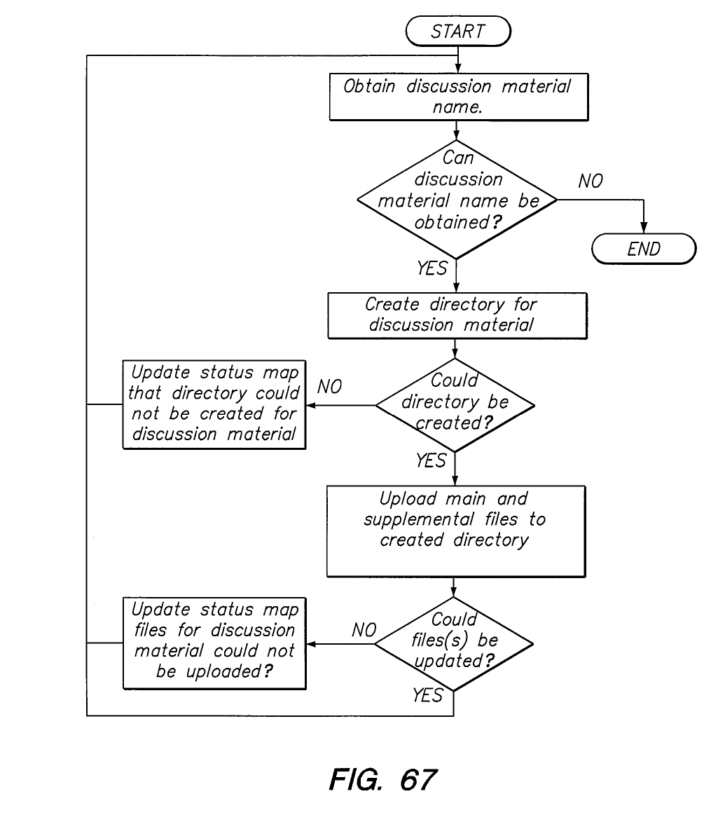

FIG. 67 is a flow diagram that depicts uploading discussion material files and storing the files within the file system where the discussion index and discussion form web page can link to them. The files for the materials are passed from the discussion meeting form from the browser to the web server and the web server stores the files in a temporary location. Each discussion material is associated with one or more files. One file is the main file for the discussion material and supplemental files may be needed that are referred to by the main file, such as figures. Each of the discussion meetings is stored within a directory corresponding to the document control id of the discussion meeting. Using the document control id for the directory name makes the directory unique. The discussion form web page and material files are stored under this directory. A subdirectory is created under the directory of the discussion meeting where each subdirectory contains the main file and supplemental files for each discussion material. According to one embodiment of the invention, discussion materials are stored in separate directories to prevent the main file and supplemental files of one discussion material from overwriting the main file and supplemental files of another discussion material. FIGS. 27 and 28 depict example directory structures of the discussion meeting web pages generated by the discussion meeting system. In the process of uploading the material files, the material name is obtained from the discussion meeting form. The process is performed for each discussion material until all the files for all of the discussion materials are uploaded. If no material names can be obtained, then the process to upload the files for the materials is completed. If a material name can be obtained from the discussion meeting form, the directory is created under the discussion meeting directory where the files for the material will be stored. The name of the directory is MaterialXXX, where XXX is the number of the material starting at 1. Each material is assigned a number so that the material directories are unique. “Material” was chosen as part of the name of the directory, but any other name may be used. If the directory cannot be created, an entry is added to the status map to indicate that the material directory could not be created for the discussion material and the name of the next discussion material is obtained. If the material directory could be created, the material files are uploaded (moving the files from the temporary location to the material directory) to the material directory. If the files cannot be uploaded, an entry is added to the status map to indicate that the files could not be uploaded for the discussion material and the name of the next discussion material is obtained. If there are no more discussion materials and if all the material files could be uploaded, then an entry is added to the status map to indicate that the files were uploaded successfully.

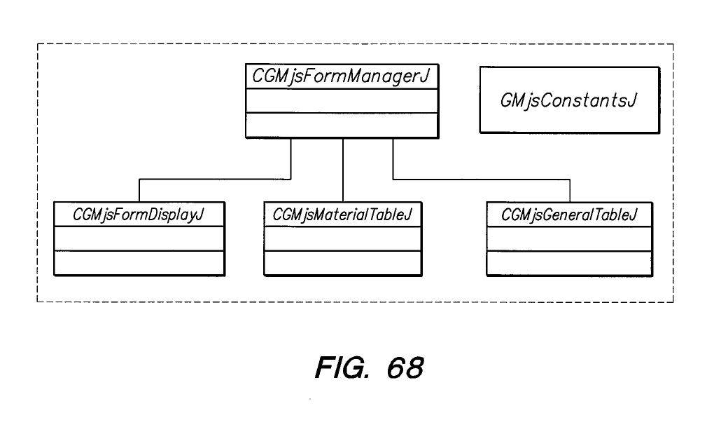

FIG. 68 is the class diagram of the GeneralMeetingJavaScript package to display and manage the general meeting form as depicted in FIG. 30. The class CGMjsFormManagerJ provides the interface for this package and creates the web page and form for the general meeting. The class CGMjsFormDisplayJ provides the initial display of the general meeting form. The class CGMjsMaterialTableJ manages the general material table for adding the materials to be used in the general meeting. The class CGMjsGeneralTableJ manages the general tables used for entering comments/remarks for various topics/items of the meeting. The package also contains constants, GMjsConstantsJ, that are used by the classes in the package.

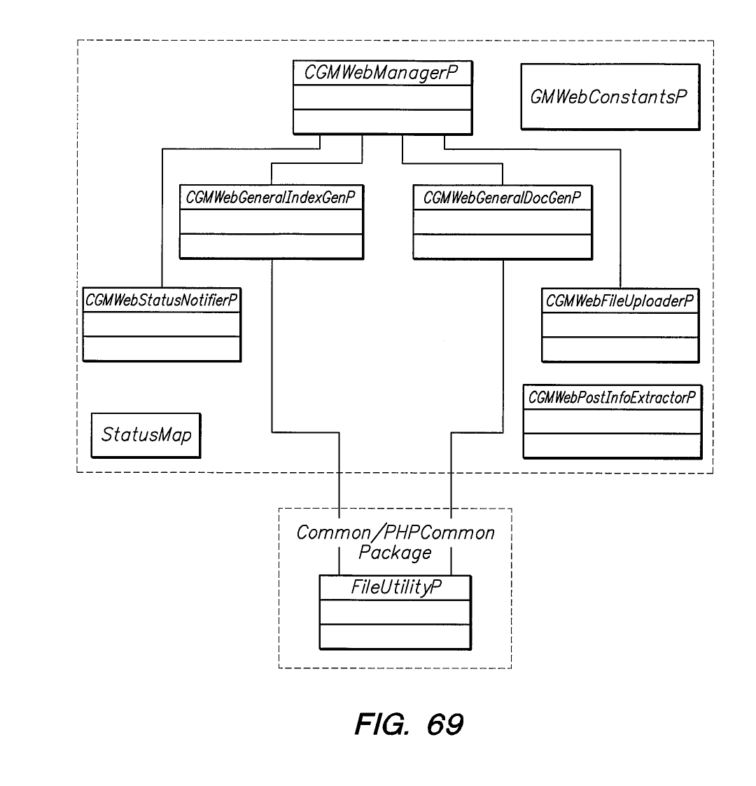

FIG. 69 is the class diagram of the GeneralMeetingWebPageGenerator package to generate form web pages. The class CGMWebManagerP provides the interface for this package to generate the various web pages resulting from the general meeting. CGMWebGeneralIndexGenP generates the general index web pages to link to all the general form web pages. A yearly index (as depicted in FIG. 32) links all the indexes (one example depicted in FIG. 33) that include links to all the general form web pages for a given year. The class CGMWebGeneralDocGenP generates the general form web page (as depicted in FIG. 31) corresponding to the general meeting. The general form web page contains links to the material used in the meeting if any were used. The class CGMWebFileUploaderP uploads the files and supplemental files corresponding to the material so that the general form web page can link to them. The class CGMWebStatusNotifierP notifies the administrator and/or document controller if the generation of the general web pages failed. The notification may be an email containing all the information necessary to recover the information from the general meeting session which may include the status for generating the general web pages, the general meeting information in the form, the general index web pages, and/or the general form web page. The class CGMWebPostInfoExtractorP obtains information from the general meeting form that is passed from the GeneralMeeting.htm to PostGeneralMeeting.htm. CGMWebPostInfoExtractorP is used by all the classes that need information from the form. The package also contains constants, GMWebConstantsP, that are used by the classes in the package. Classes use the status map to set the status for generating the various web pages.

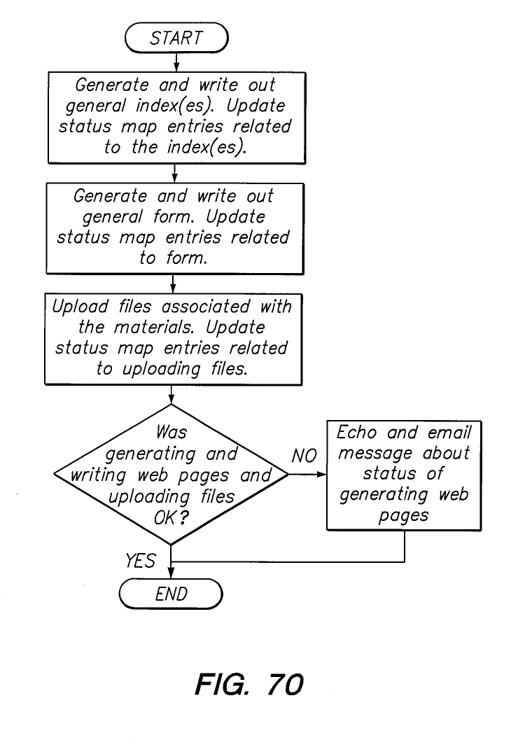

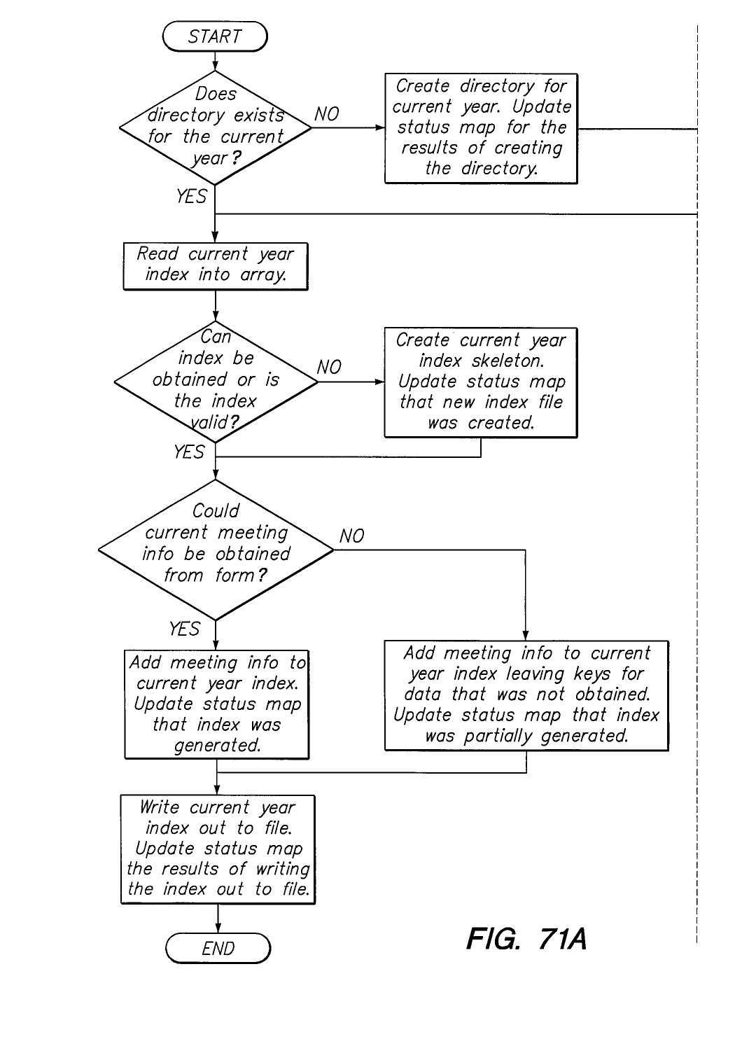

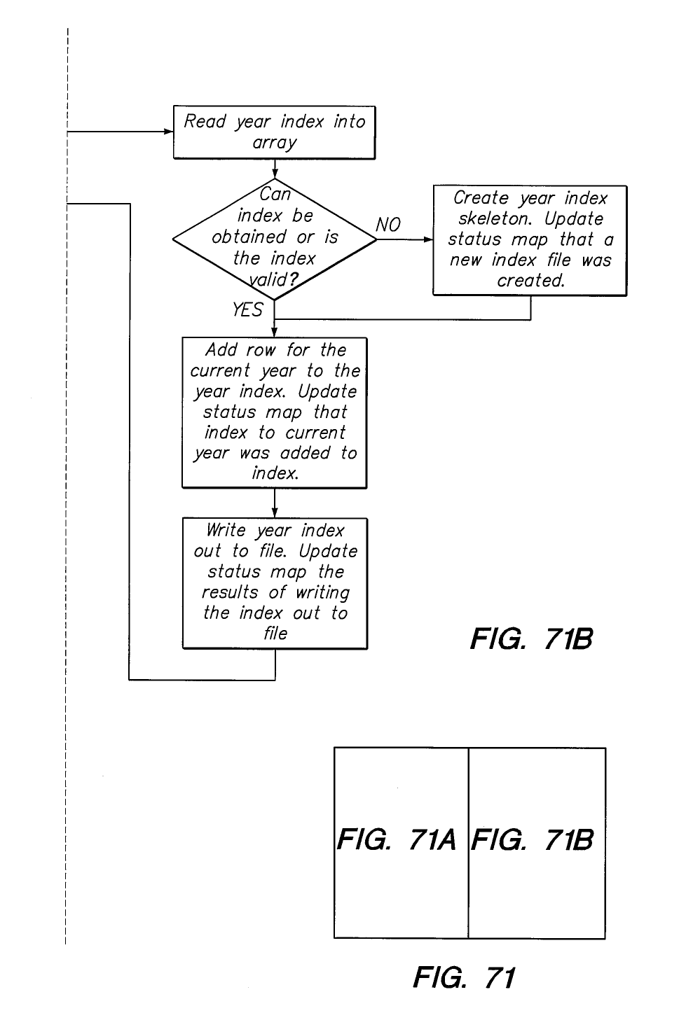

FIG. 70 is a flow diagram that depicts generating web pages for a general meeting when the general meeting form is submitted. The web pages for the general meeting are generated and stored in the appropriate location in the file system corresponding to the web site. More details of generating the web pages for a general meeting are depicted in FIGS. 71 through 73. The general indexes are first generated and stored. The existing general indexes are used to generate the new indexes. If the general indexes do not exist or are not valid indexes, the system generates new indexes. Information from the general meeting form may be used to generate the general indexes. Entries are added to the status map for generating and writing out the general indexes.

The general form web page, an example of which is depicted in FIG. 31, is generated and stored next. Information from the general meeting form is used to generate the general form web page. Entries are added to the status map for generating and writing out the general form web page.

The files for the materials used in the meeting are uploaded and stored in the appropriate location so that the general form web page can link to them. Entries are added to the status map for uploading the material files.

If generating and writing out the general web pages and uploading the material files are all successful, the general meeting system is completed. However, if a failure occurs, the general meeting system echoes to the browser and emails to the document controller/administrator the results of processing the general information. Given the information about generating and writing the discussion web pages and uploading the material files stored in the status map, the information of the status map can be echoed and emailed to provide information about the problems/errors/failures that occurred during the processing of the general information. Also if the web pages were generated and/or stored, the web pages can be echoed and emailed so that the web pages can be added to the file system if necessary. Also, if necessary the information in the general meeting form can be echoed and emailed. The status map information and web pages can be emailed as attachments.

FIG. 71 is a flow diagram that depicts the process of generating the general indexes from the existing indexes. Unlike the inspection meeting and discussion meeting system, the general meetings are not associated with a project so that the general form web pages generated are not placed into the file system according to the project web site. All the general form web pages are stored under a main directory which is divided into subdirectories corresponding to the year as shown in FIG. 34. All the general form web pages for a given year are placed in the subdirectory with the year in the directory name. For example, all general form web pages generated in 2007 are placed in the subdirectory YR2007.

The first step is determining whether the directory exists for the year entered in the general meeting form. If the directory does not exist, a subdirectory is created for the year with the name having the prefix “YR” followed by the year. If the yearly index does not exist or is an invalid index, a new yearly index skeleton is created and an entry is added to the status map that a new yearly index was created. Then a row is added to the index with a link to the new year index and an entry is added to the status map to indicate that a new year index was added to the yearly index. The yearly index is stored in the file system under the directory where all the general form web pages are stored and an entry is added to the status map indicating whether or not the yearly index was successfully written.

After the yearly index is created or updated, if necessary for a new year, the index for the year corresponding to the general meeting session is created or updated. If the index does not exist or is an invalid index, an index skeleton is created and an entry is added to the status map to indicate that a new index was created. Next, general information is obtained from the general meeting form and added to the index. If any information cannot be obtained from the general meeting form, an entry is added to the status map indicating that the index is partially generated and keys are placed in the index generated to indicate that information must be added to the index. If the information can be obtained, the index is generated containing the information and an entry is added to the status map indicating that the index was completely generated. Then the process of generating the index is completed. The index is then stored in the file system under the directory corresponding to the year. If writing to the file system fails, an entry is added to the status map to indicate that the index could not be written. Otherwise, an entry is added to the status map to indicate that the index was stored to a file. The process for generating and writing the indexes is completed.

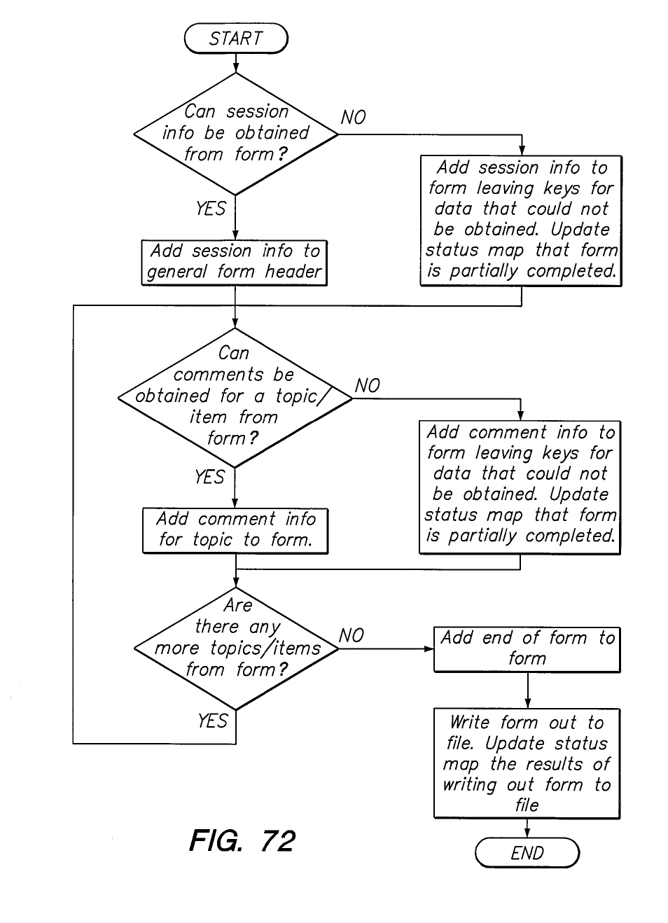

FIG. 72 is a flow diagram that depicts the generation and storing of the general form web page. If any of the general session information cannot be obtained from the general meeting form, an entry is added to the status map to indicate that the general form web page is partially generated and keys are added to the general form web page for the missing general session information indicating that this information will need to be added. Otherwise, the general session information is added to the general form web page. If any of the comments/remarks for each general table cannot be obtained from the general meeting form, an entry is added to the status map to indicate that the general form web page is partially generated and keys are added to the general form web page for the missing general information indicating that this information will need to be added. Otherwise, the general information is added to the general form web page. Then the end of form is added to the general form web page. If there is no missing information in the general form web page, then an entry is added to the status map to indicate that the general form web page is completely generated. After the general form web page is generated, the general form web page is stored in the file system where the general form web pages are located in the file system under the directory where all general form web pages are located and under the directory correspond to the year of the meeting. If writing to the file system fails, an entry is added to the status map to indicate that the general form web page could not be written. Otherwise, an entry is added to the status map to indicate that the general form web page was stored to a file. The process for generating and writing the general form web page is completed. For each general meeting, a directory and file for the general form web page is created with the name corresponding to the meeting date, start time, and end time. For example, the general meeting form shown in FIG. 31 with a meeting date of 2008-08-20 and start and end time of 13:35 and 13:37 will have a file name of 2008-08-20_{—}13-35_{—}13-37.htm and are stored in the created directory 2008-08-20_{—}13-35_{—}13-37 under the YR2008 directory. Using the date and times creates a unique name for the directory/file.

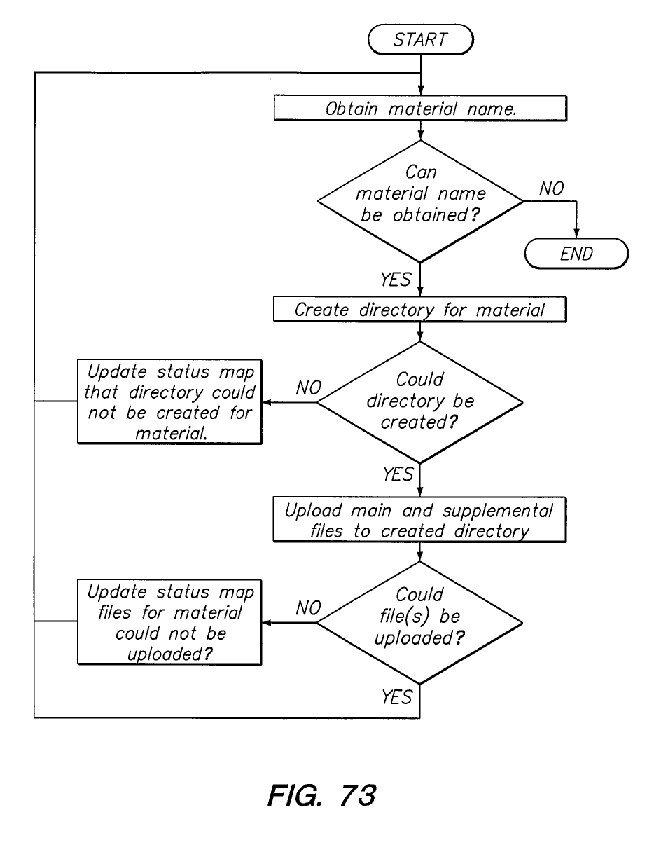

FIG. 73 is a flow diagram that depicts uploading all the general material files and storing the files within the file system where the general form web page can link to them. The files for the materials are passed from the general meeting form from the browser to the web server and the web server stores the files in a temporary location. Each general material is associated with one or more file. One file is the main file for the general material and supplemental files may be needed that is referred to by the main file such as figures. Each of the general meetings is stored within a directory in which the name corresponds to the date and times of the general meeting. Using the date and times for the directory name makes the directory unique. The general form web page and material files are stored under this directory. A subdirectory is created under the directory of the general meeting where each subdirectory contains the main file and supplemental files for each material. Each general material is placed in separate directories to prevent main file and supplemental files of one material from overwriting main file and supplemental files of another material. FIGS. 32 to 33 depict example directory structures of the general meeting web pages generated by the general meeting system. In the process of uploading the material files, the material name is obtained from the general meeting form. The process is performed for each material until all the files for all the materials are uploaded. If no material names can be obtained, then the process to upload the files for the material is completed. If a material name can be obtained from the general meeting form, the directory is created under the general meeting directory where the files for the material are stored. The name of the directory is MaterialXXX, where XXX is the number of the material starting at 1. Each material is assigned a number so that the material directories are unique. “Material” was chosen as part of the name of the directory but any other name could have been used. If the directory could not be created, an entry is added to the status map to indicate that the material directory could not be created for the material and the name of the next material is selected. If the material directory could be created upload the material files (moving the files from the temporary location to the material directory) to the material directory. If the files could not be uploaded, an entry is added to the status map to indicate that the files could not be uploaded for the material and the name of the next material is selected. If there are no more material and if all the material files could be uploaded, then an entry is added to the status map to indicate that the files were uploaded successfully.

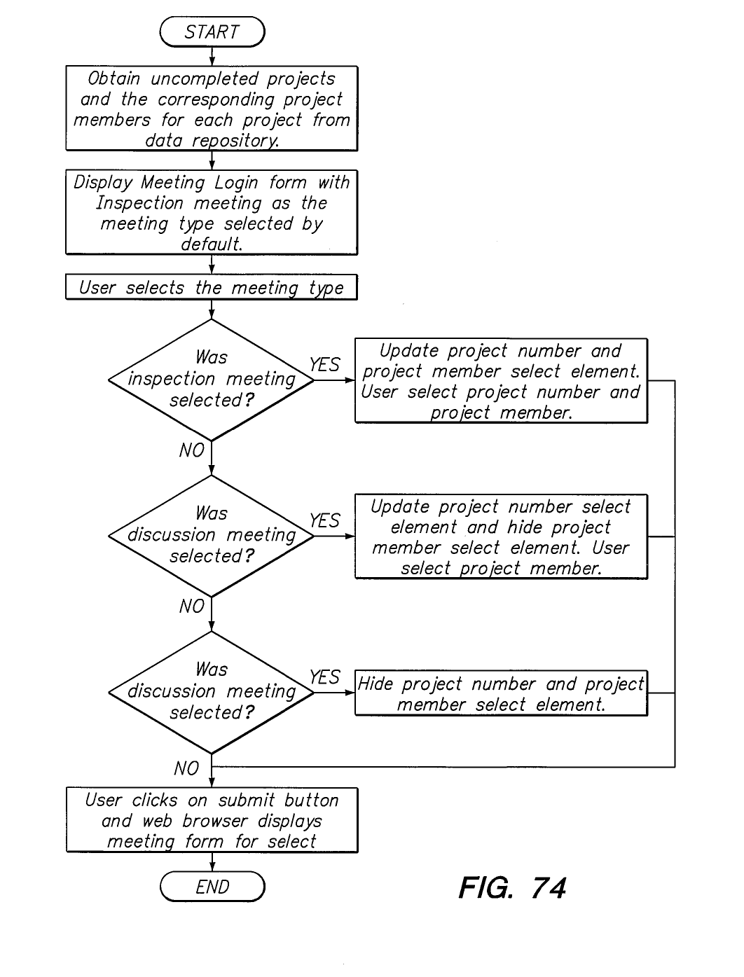

FIG. 74 is a flow diagram that depicts the process to log on to one of the meeting forms. When a user accesses the meeting login web page, the web server obtains all the uncompleted projects from the database and all the project members for each project and passes the information to the web browser. The meeting login web page is displayed in the web browser as depicted in FIGS. 18A to 18C. Initially the inspection meeting is the selected meeting type by default. The select elements are displayed for the project number and originator (project member). The user selects the meeting type. If the user selects the inspection meeting, the select elements are displayed for the project number and originator. When the user selects a project, the originator select element is updated with the corresponding project members. The user then selects the originator and click on the Submit button and the inspection meeting web page is displayed on the web browser. If the user selects the discussion meeting, the select element for the project number is displayed and the select element for the originator is hidden. The user then selects the project number and selects the Submit button and the discussion meeting web page is displayed on the web browser. If the user selects the general meeting, the select elements for the project number and originator are hidden. The user then selects the Submit button and the general meeting web page is displayed on the web browser. The information that the user must enter depends upon the meeting type. The form maintains information about what needs to be displayed for each meeting type.

### Extensions and Alternatives

Alternative embodiments are described throughout the foregoing description, and in locations that best facilitate understanding the context of the embodiments. Furthermore, the embodiments have been described with reference to specific embodiments thereof. It will, however, be evident that various modifications and changes may be made thereto without departing from any broader concepts. Therefore, the specification and drawings are, accordingly, to be regarded in an illustrative rather than a restrictive sense.

In addition, in this description certain process steps are set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps, and are not intended to specify or require a particular order of carrying out such steps.

Functional implementation of the various inventive embodiments described herein may be implemented equivalently in hardware, software, firmware, and/or other available functional components or building blocks. No specific limitation is intended to a particular device or programmatic sequence. Other variations and embodiments are possible in light of above teachings.

What is claimed is:

1. A computer-implemented method for managing project schedule data in a project management system, the computer-implemented method comprising:
in response to a user logging into a task assignment editor in the project management system, wherein the task assignment editor allows users to specify assignments of members to project tasks,
initiating a task assignment editor session that includes displaying, via the task assignment editor, project task data that indicates one or more project tasks for a project, and
receiving, via the task assignment editor, task assignment data that specifies assignments of one or more members to at least one of the one or more project tasks;
detecting, via the member schedule editor, a request from the user to conclude the task assignment editor session;
in response to detecting the request from the user to conclude the task assignment editor session,
determining one or more of the one or more project tasks are incomplete project tasks,
causing task assignment data for the one or more incomplete project tasks to be stored in one or more cache files in addition to a database that stores a plurality of other task assignment data, and
concluding the task assignment editor session;
in response to the user logging into a member schedule editor in the project management system, wherein the member schedule editor allows users to specify scheduling data for project tasks,
initiating a member schedule editor session that includes retrieving from the one or more cache files, instead of the database, the task assignment data for one or more incomplete tasks that correspond to one or more specified members, and
displaying the task assignment data in the member schedule editor.

2. The computer-implemented method as recited in claim 1, further comprising:
generating one or more Web pages that contain the member schedules for the one or more specified members,
storing the one or more Web pages in association with the one or more cache files, and
in response to the user logging into a member schedule editor that allows users to specify scheduling data for project tasks, retrieving the one or more Web pages that contain the member schedules for the one or more specified members.

3. The computer-implemented method as recited in claim 1, further comprising:
in response to detecting the request from the user to conclude the task assignment editor session,
determining one or more project tasks added for a particular member during the task assignment editor session,
generating and storing new project task data that indicates the one or more project tasks added for the particular member during the task assignment editor session,
and wherein during the member schedule editor session, the new project task data is retrieved and the one or more project tasks are identified to the user as “to do list” project tasks that need to be scheduled.

4. The computer-implemented method as recited in claim 3, wherein the member schedule editor is configured to prevent the deletion of “to do list” project tasks, and wherein the task assignment editor is configured to allow deletion of “to do list” project tasks.

5. The computer-implemented method as recited in claim 1, further comprising:
receiving, via an inspection meeting form, inspection information that identifies a plurality of inspection materials and one or more defects in the plurality of inspection materials;
maintaining the inspection information separate from a database that stores inspection information by emailing the inspection information to a specified address to allow restoration of the inspection information in the event of a failure of the database.

6. A computer-readable medium for managing project schedule data in a project management system, the computer-readable medium carrying instructions which, when processed by one or more processors, cause:
in response to a user logging into a task assignment editor in the project management system, wherein the task assignment editor allows users to specify assignments of members to project tasks,
initiating a task assignment editor session that includes displaying, via the task assignment editor, project task data that indicates one or more project tasks for a project, and
receiving, via the task assignment editor, task assignment data that specifies assignments of one or more members to at least one of the one or more project tasks;
detecting, via the member schedule editor, a request from the user to conclude the task assignment editor session;
in response to detecting the request from the user to conclude the task assignment editor session,
determining one or more of the one or more project tasks are incomplete project tasks,
causing task assignment data for the one or more incomplete project tasks to be stored in one or more cache files in addition to a database that stores a plurality of other task assignment data, and
concluding the task assignment editor session;
in response to the user logging into a member schedule editor in the project management system, wherein the member schedule editor allows users to specify scheduling data for project tasks,
initiating a member schedule editor session that includes retrieving from the one or more cache files, instead of the database, the task assignment data for one or more incomplete tasks that correspond to one or more specified members, and
displaying the task assignment data in the member schedule editor.

7. The computer-readable medium as recited in claim 6, further comprising additional instructions which, when processed by the one or more processors, cause:
generating one or more Web pages that contain the member schedules for the one or more specified members,
storing the one or more Web pages in association with the one or more cache files, and
in response to the user logging into a member schedule editor that allows users to specify scheduling data for project tasks, retrieving the one or more Web pages that contain the member schedules for the one or more specified members.

8. The computer-readable medium as recited in claim 6, further comprising additional instructions which, when processed by the one or more processors, cause:
in response to detecting the request from the user to conclude the task assignment editor session,
determining one or more project tasks added for a particular member during the task assignment editor session,
generating and storing new project task data that indicates the one or more project tasks added for the particular member during the task assignment editor session,
and wherein during the member schedule editor session, the new project task data is retrieved and the one or more project tasks are identified to the user as “to do list” project tasks that need to be scheduled.

9. The computer-readable medium as recited in claim 8, wherein the member schedule editor is configured to prevent the deletion of “to do list” project tasks, and wherein the task assignment editor is configured to allow deletion of “to do list” project tasks.

10. The computer-readable medium as recited in claim 6, further comprising additional instructions which, when processed by the one or more processors, cause:
receiving, via an inspection meeting form, inspection information that identifies a plurality of inspection materials and one or more defects in the plurality of inspection materials;
maintaining the inspection information separate from a database that stores inspection information by emailing the inspection information to a specified address to allow restoration of the inspection information in the event of a failure of the database.

11. An apparatus for managing project schedule data in a project management system, the apparatus comprising a memory storing instructions which, when processed by one or more processors, cause:
in response to a user logging into a task assignment editor in the project management system, wherein the task assignment editor allows users to specify assignments of members to project tasks,
initiating a task assignment editor session that includes displaying, via the task assignment editor, project task data that indicates one or more project tasks for a project, and
receiving, via the task assignment editor, task assignment data that specifies assignments of one or more members to at least one of the one or more project tasks;
detecting, via the member schedule editor, a request from the user to conclude the task assignment editor session;
in response to detecting the request from the user to conclude the task assignment editor session,
determining one or more of the one or more project tasks are incomplete project tasks,
causing task assignment data for the one or more incomplete project tasks to be stored in one or more cache files in addition to a database that stores a plurality of other task assignment data, and
concluding the task assignment editor session;
in response to the user logging into a member schedule editor in the project management system, wherein the member schedule editor allows users to specify scheduling data for project tasks,
initiating a member schedule editor session that includes retrieving from the one or more cache files, instead of the database, the task assignment data for one or more incomplete tasks that correspond to one or more specified members, and
displaying the task assignment data in the member schedule editor.

12. The apparatus as recited in claim 11, wherein the memory stores additional instructions which, when processed by the one or more processors, cause:
generating one or more Web pages that contain the member schedules for the one or more specified members,
storing the one or more Web pages in association with the one or more cache files, and
in response to the user logging into a member schedule editor that allows users to specify scheduling data for project tasks, retrieving the one or more Web pages that contain the member schedules for the one or more specified members.

13. The apparatus as recited in claim 11, wherein the memory stores additional instructions which, when processed by the one or more processors, cause:
in response to detecting the request from the user to conclude the task assignment editor session,
determining one or more project tasks added for a particular member during the task assignment editor session,
generating and storing new project task data that indicates the one or more project tasks added for the particular member during the task assignment editor session,
and wherein during the member schedule editor session, the new project task data is retrieved and the one or more project tasks are identified to the user as “to do list” project tasks that need to be scheduled.

14. The apparatus as recited in claim 13, wherein the member schedule editor is configured to prevent the deletion of “to do list” project tasks, and wherein the task assignment editor is configured to allow deletion of “to do list” project tasks.

15. The apparatus as recited in claim 11, wherein the memory stores additional instructions which, when processed by the one or more processors, cause:
receiving, via an inspection meeting form, inspection information that identifies a plurality of inspection materials and one or more defects in the plurality of inspection materials;
maintaining the inspection information separate from a database that stores inspection information by emailing the inspection information to a specified address to allow restoration of the inspection information in the event of a failure of the database.
